(19) United States
(12) Patent Application Publication
(10) Pub. No.: US 2026/0124708 A1
(43) Pub. Date: May 7, 2026

(54) A SYSTEM FOR TOOL EDGE MONITORING

(71) Applicant: S.P.M. Instrument AB, Strängnäs (SE)

(72) Inventor: Tim Sundström, Åkers Styckebruk (SE)

(21) Appl. No.: 19/117,912

(22) PCT Filed: Oct. 9, 2023
(86) PCT No.: PCT/SE2023/051006

§ 371 Date: Apr. 2, 2025

(30) Foreign Application Priority Data
Oct. 9, 2022 (SE) 2251178-6

(51) Int. Cl. B23Q 17/09; G01H 1/00; G05B 19/4065

(52) U.S. Cl. CPC B23Q 17/0957; G01H 1/003; G05B 19/4065; G05B 2219/37252; G05B 2219/37256; G05B 2219/37258; G05B 2219/37434

(57) ABSTRACT

The present disclosure relates to system for shearing material. The system can include a machine including a tool that rotates around an axis at a speed of rotation (f_{ROT}) for shearing a raw material workpiece; wherein said tool[has at least one tool edge can engage the raw material workpiece; a vibration sensor can generate an analogue measurement signal (S_{EA}) dependent on mechanical vibrations (V_{IMP}) emanating from rotation of said tool; a position sensor can generate a position signal indicative of a rotational position of said rotating tool; and status parameter extractor.

### TECHNICAL FIELD

The present invention relates to the field of a machine including a tool for shearing and/or shaping a raw material workpiece and to the monitoring of a machine including a tool for shearing and/or shaping a raw material workpiece. The present invention also relates to a method for generating information relating to a tool wear state of a machine including a tool for shearing and/or shaping a raw material workpiece, and to the field of control of a machine including a tool for shearing and/or shaping a raw material workpiece. The present invention also relates to a method of operating a shearing process in a machine including a tool for shearing and/or shaping a raw material workpiece, and to an apparatus for monitoring of a tool wear state of a machine including a tool for shearing and/or shaping a raw material workpiece. The present invention also relates to an apparatus for controlling a tool wear state of a machine including a tool for shearing and/or shaping a raw material workpiece. The present invention also relates to a computer program for monitoring of a tool wear state of a machine including a tool for shearing and/or shaping a raw material workpiece. The present invention also relates to a computer program for controlling a tool wear state of a machine including a tool for shearing and/or shaping a raw material workpiece.

### DESCRIPTION OF RELATED ART

In some industries, such as in the forestry industry, there is a need to shear material that comes in large pieces to reduce the size of individual pieces of the received material. A machine including a tool for shearing and/or shaping a raw material workpiece can achieve shearing of material.

A machine including a tool for shearing and/or shaping a raw material workpiece includes

### SUMMARY

In view of the state of the art, a problem to be addressed is how to generate improved information relating to a tool wear state of a machine including a tool for shearing and/or shaping a raw material workpiece and/or how to obtain an improved method of operating a shearing process in a machine including a tool for shearing and/or shaping a raw material workpiece.

This problem is addressed by examples presented herein.

### BRIEF DESCRIPTION OF THE DRAWINGS

For simple understanding of the present invention, it will be described by means of examples and with reference to the accompanying drawings, of which

FIG. 1A shows a somewhat diagrammatic and schematic side view of a system including a machine including a tool for shearing and/or shaping a raw material workpiece.

FIG. 1C is a block diagram illustrating a machine including a tool for shearing and/or shaping a raw material workpiece as a box receiving a number of inputs and generating a number of outputs.

FIG. 2, shows another example of a cross-sectional view taken along line A-A of FIG. 1A

FIG. 3 is a schematic block diagram of an example of the analysis apparatus shown in FIG. 1.

FIG. 4 is a simplified illustration of the program memory and its contents.

FIG. 5 is a block diagram illustrating an example of the analysis apparatus.

FIG. 6A is an illustration of a signal pair S(i) and P(i) as delivered by an A/D converter.

FIG. 6B is an illustration of a sequence of the signal pair S(i) and P(i) as delivered by the A/D converter.

FIG. 7 is a block diagram that illustrates an example of a part of a status parameter extractor.

FIG. 8 is a simplified illustration of an example of a memory and its contents.

FIG. 9 is a flow chart illustrating an example of a method of operating the status parameter extractor of FIG. 7.

FIG. 10 is a flow chart illustrating an example of a method for performing step S#40 of FIG. 9.

FIG. 11 is a flow chart illustrating another example of a method.

FIG. 12 is a flow chart illustrating another example of a method for performing step S#40 of FIG. 9.

FIG. 13 is a graph illustrating a series of temporally consecutive position signals P1, P2, P3, . . . , each position signal P being indicative of a full revolution of the monitored tool.

FIGS. 15A and 15B are a block diagrams illustrating examples of a status parameter extractors.

FIGS. 16A and 16B illustrative examples of visual indications of analysis results relating to the time domain.

FIGS. 17A and 17B illustrative examples of visual indications of analysis results relating to the frequency domain.

FIG. 18 illustrative an example interaction between tool edge and raw material.

FIGS. 19A, 19B and 19C illustrative examples of different types of machines for shearing and/or shaping a raw material workpiece.

FIG. 20 is a block diagram of an example of compensatory decimator.

FIG. 21 is a flow chart illustrating an embodiment of a method of operating the compensatory decimator of FIG. 20.

FIGS. 22A, 22B and 22C illustrate a flow chart of an embodiment of a method of operating the compensatory decimator of FIG. 20.

FIG. 26 shows a somewhat diagrammatic and schematic top view of yet another embodiment of a system including a machine including a tool for shearing and/or shaping a raw material workpiece.

FIG. 27 shows a somewhat diagrammatic and schematic top view of yet another embodiment of a system including a machine including a tool for shearing and/or shaping a raw material workpiece.

FIG. 28 shows a somewhat diagrammatic and schematic top view of yet another embodiment of a system including a machine including a tool for shearing and/or shaping a raw material workpiece.

FIG. 29 shows a somewhat diagrammatic and schematic top view of yet another embodiment of a system including a machine including a tool for shearing and/or shaping a raw material workpiece.

FIG. 31 is a block diagram that illustrates another example of a status parameter extractor.

FIG. 32 is a block diagram of an example system.

FIG. 33 is a block diagram of an example system.

FIG. 34 shows a diagrammatic view of an example system comprising a machine.

FIG. 35 is a schematic general overview of information that may be conveyed by an example input/output interface.

FIG. 39 is a block diagram of a system for monitoring of a tool wear state X of a tool of a machine and for enabling improved control of a shearing and/or shaping process that occurs in a machine.

FIG. 40 is a block diagram of a system for monitoring of a tool wear state X of a tool of a machine and for enabling improved control of a shearing and/or shaping process that occurs in a machine.

### DETAILED DESCRIPTION

In the following text similar features in different examples will be indicated by the same reference numerals.

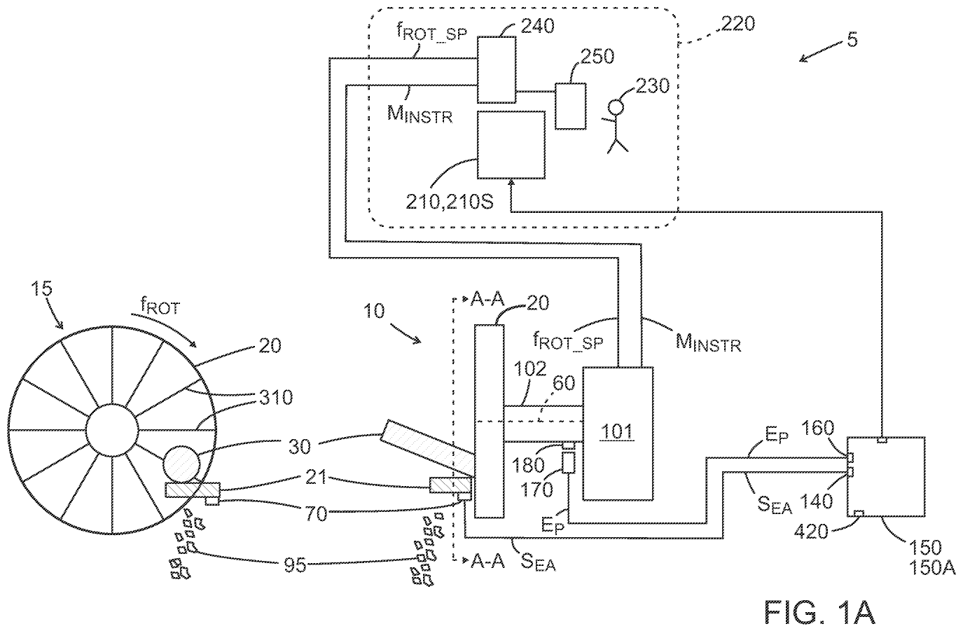

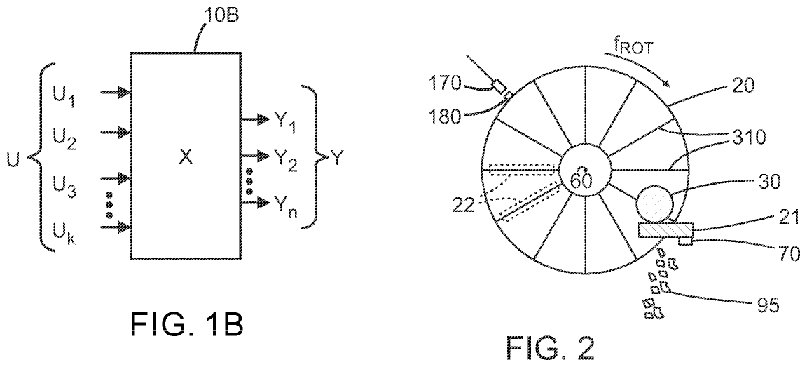

FIG. 1A shows a somewhat diagrammatic and schematic side view of a system 5 including a machine 10. The machine 10 may be a wood chipper, for example. Alternatively, the machine 10 may be a cutter with a circular saw, for example. Another example the machine 10 is a lathe, or any other machine shearing and/or shaping a raw material 30 by a tool 20 interacting with said raw material 30 in a rotating or cyclically repeating fashion. The term “cyclically repeating” may relate to one cycle being the shearing and/or shaping one raw material workpiece 30, such that each cycle is one raw material workpiece 30 being processed by said tool 20 in a lathe.

FIG. 1A also shows a sectional view, section A-A. Section view A-A is also is also identified by the reference 15. The machine 10 includes a tool 20 for shearing a raw material 30, the tool 20 comprising tool edges 310 arranged to shear and/or shape said raw material 30. In the section view identified by the reference 15 in FIG. 1A, the tool 20 is illustrated as revolving at a rotational speed f_{ROT} in a clockwise direction from the viewing perspective, as indicated by the curved arrow f_{ROT}.

It s to be understood that the terms “raw material workpiece” and “raw material” relate to the same material. Typically a workpiece is a raw material that is currently being processed by the machine. The term “raw material” relates to both raw material being processed, raw material to be processed, and more generally to raw materials suitable as raw material workpieces in said machine. It is further to be understood that the term “raw material workpiece” also includes raw materials that are intended to be cut into small pieces, such as a tree trunk turned to chips by a wood chipper.

It is to be understood that shearing and/or shaping a raw material 30 by bringing a raw material workpiece 30 into contact with a rotating tool 20 is equivalent to bringing a correspondingly moving raw material workpiece 30 into contact with a tool 20, or a corresponding combination of movements.

The machine including a tool 20 for shearing and/or shaping a raw material workpiece 30, a support 21 for raw material 30 during operation. Said support 21 is in contact with a vibration sensor 70. Said support 21 and vibration sensor 70 are arranged such that variations in force exerted on the raw material 30 by the tool edges 310 of the rotating tool 20 cause vibrations via said support 21 that are detected as vibration magnitudes by the vibration sensor 70. Typically the tool edges 310 have a fixed position in relation to the tool 20.

According to some embodiments, the tool 20 is connected to a motor 101 via an axle 102 rotating around an axis of rotation 60. The tool 20 is rotatable around the axis of rotation 60 and the motor 101 is arranged to rotate the tool 20. In this connection it is noted that an axis is an imaginary line around which an object spins (rotating axel). The rotation of the tool 20 brings the tool edges 310 into contact with the raw material 30. Typically, the raw material 30 is forced towards the rotating tool, as indicated by the force arrow F in FIG. 1A, such as forces from gravity, raw material feeding means (not shown), or a combination thereof.

The vibration sensor 70 may produce a measuring signal S_{EA}. The measuring signal S_{EA} may be dependent on mechanical vibrations or shock pulses generated when the tool 20 rotates. In some examples, the machine 10 comprises two or more vibration sensors 70 arranged at different positions. In some of these examples the system 5 is configured to perform signal analysis on each vibration signals S_{EA} from each vibration sensor 70 in combination with corresponding position signals E_{P}.

An example of the system 5 is operative when a vibration sensor 70 is firmly mounted on or at a measuring point on the machine 10. The measuring point can comprise a connection coupling to which the sensor 70 is firmly attached, or removably attachable. In the example illustrated by FIG. 1A, the sensor 70 is mounted on the axle 102. Alternatively, the sensor 70 may be mounted elsewhere on the machine including a tool for shearing and/or shaping a raw material workpiece 30 where the sensor 70 is capable of generating the measuring signal S_{EA} dependent on mechanical vibrations or shock pulses generated when the tool 20 rotates. Raw material 30 may comprise plant matter, biological matter, polymers, metals, and/or rocks. Typically a raw material 30 is selected for which a tool 20 exists that can readily shear and/or shape said raw material 30 by cutting.

The machine 10 has an output region (not shown) for delivery of output material 95 that has passed through the machine 10.

Typically raw material 30 is transported to the tool 20 by a raw material feed arrangement. In some examples the machine 10 comprises a raw material feed arrangement. In some of these examples, the machine 10 obtains raw material state data indicative of properties of the raw material 30 being feed into the machine 10.

According to some embodiments, the machine 10 operates to perform shearing. According to an embodiment the machine 10 is a machine operating to perform shearing. The machine 10 includes a number of tool edges 310 for shearing of the raw material 30 into output material 95, such as a part of a tree being sheared into wood chips.

The output region 90 of said machine 10 may include a separator for delivery of output material 95 and for retaining pieces of output material 95 whose properties exceeds a limit value. The separator may include a screen configured to sift out pieces of output material 95 that have a larger size than a certain limit value for delivery as output material 95. One measure of a production quality of the machine 10 may be the variability in properties of output material, or the amount per hour of output material produced with acceptable properties, within certain limit value(s).

Output material limit values and tool wear state limit values relate to threshold values or a range of values compatible with the process. For example, a tool wear state limit value may relate to a maximum threshold for a level of tool wear, and a higher level of tool wear being expected to no longer generate a desirable output material.

Moreover, it is desirable to obtain a high degree of efficiency of the shearing process. One aspect of shearing process efficiency is the amount of raw material 30 processed per unit time.

Another aspect of shearing process efficiency is the amount of raw material per energy unit spent, in order to minimize shearing process energy consumption. Hence, it is desirable to improve or optimize the throughput in terms of kg/kilowatt-hour of output material 95. In this context it is noted that a machine including a tool for shearing and/or shaping a raw material workpiece typically may have a high power consumption. Thus, when that machine including a tool 20 for shearing and/or shaping a raw material workpiece 30 is in operation 24 hours a day for a year, then even a small improvement of shearing process energy efficiency, such as low as a one percent (1%) improvement would render significant energy cost savings. Such improvements in energy efficiency may come from correctly adapting the operation parameters of a machine 10, and/or replacing worn out tools 20 at the correct time.

The efficiency of the shearing process in a machine 10 depends on a number of variables, one of the most significant is the tool wear state X of the tool 20 of the machine 10, such as the amount of wear on the tool edges 310 of the tool 20. Hence, it is desirable to monitor the tool wear state X of the tool 20 of the machine 10 to avoid operating the machine 5 with significantly worn out tool edges 310.

It is to be understood that the term “tool wear state X” relates to the actual state of the tool. The values X1, X2, X3 indicative of the tool wear state X represent values estimating or providing information relating the tool wear state X.

Another variable that has an impact on the efficiency of the shearing process in a machine 10 is the properties of the raw material 30. Moreover, the properties of the raw material 30 are not constant over time. Hence, the efficiency of the shearing process may be variable over time due to the variation of the properties of the raw material 30. The distribution of the properties of the raw material 30 to be processed may govern if a tool wear state X of a tool 20 is acceptable or not, and thus if the tool 20 needs to be replaced completely or in part.

The tool 20 is typically a body comprising plurality of evenly spaced tool edges 310. The tool 20 is typically arranged inside the machine 10 and is not accessible from directly outside to reduce the risk of accidents. During operation of the machine 10 it may not be practical to inspect the tool 20 or the tool edges 310 visually or utilizing traditional measuring means.

It is an object of this document to describe methods and systems for an improved monitoring of a tool wear state X of a tool 20 in a machine 10 for shearing and/or shaping a raw material workpiece during operation. It is also an object of this document to describe methods and systems for an improved Human Computer Interface (HCI) relating to tool wear state in a machine including a tool 20 for shearing and/or shaping a raw material workpiece during operation. It is also an object of this document to describe methods and systems for an improved Graphical User Interface relating to the shearing process in a machine 10 comprising a tool 20.

The inventor realized that there may exist a mechanical vibration V_{IMP} indicative of an impact between a tool edge 310 of the rotating tool 20 and a raw material workpiece 30 during operation of the machine 10. The inventor also contemplated that such a mechanical vibration V_{IMP} may be indicative of a current tool wear state of the machine 10 and/or a current state of the shearing process. A mechanical vibration V_{IMP} may be generated when a tool edge 310 impacts the raw material 30 with a force F_{IMP}. The impact causing the mechanical impact vibration V_{IMP}. In fact, the mechanical impact vibration V_{IMP} is indicative of a current tool wear state of the machine 10 and/or indicative of a current state of the shearing process. The sensor 70 placed at the support 21 may detect vibrations through the raw material 30 during operation of the machine 10. Hence, with reference to FIG. 1A, the sensor 70 is capable of generating the measuring signal S_{EA} dependent on mechanical vibrations or shock pulses generated when the tool 20 rotates and contacts the raw material workpiece 30. Thus, the measuring signal S_{EA} may be dependent on, and indicative of, the impact force F_{IMP} between a tool edge and the raw material 30 during operation of the machine 10.

The sensor 70 may, for example, be an accelerometer 70 configured to generate the measuring signal S_{EA} having an amplitude that depends on the impact force F_{IMP}. The inventor concluded that there may exist a mechanical vibration V_{IMP} indicative of a current tool wear state of the machine 10 and/or of a current state of the shearing process, but that conventional methods for measuring vibrations and/or for analysing and/or for visualising such vibrations may hitherto have been inadequate.

An analysis apparatus 150 is provided for monitoring of the shearing process. The analysis apparatus 150 may also be referred to as monitoring module 150A.

The analysis apparatus 150 may generate information indicative of the tool wear state of the shearing process dependent on the measuring signal S_{EA}. The sensor 70, generating the measuring signal S_{EA}, is coupled to an input 140 of the analysis apparatus 150 so as to deliver the measuring signal S_{EA} to the analysis apparatus 150. The analysis apparatus 150 also has a second input 160 for receiving a position signal E_{P} dependent on the rotational position of the tool 20. More generally, for a repeating cycle the term P relates to a tool position along the path of the cycle, for a rotating tool 20 the cycle position P is typically an angle between 0 to 360°.

A position sensor 170 is provided to generate the position signal E_{P} dependent on the rotational position of the tool 20. In FIG. 1A the position signal E_{P} is measured at the axle 102 of the machine 10, in some embodiments the position signal E_{P} is measured directly at the tool 20. As mentioned above, the tool 20 is rotatable around the axis of rotation 60, and thus the position sensor 170 may generate a position signal E_{P} having a sequence of tool position signal values P_{S}(not shown) for indicating momentary rotational positions of the tool 20. A position marker 180 may be provided on an outer surface of the tool 20 such that, when the tool 20 rotates around the axis of rotation 60, the position marker 180 passes by the position sensor 170 once per revolution of the tool, thereby causing the position sensor 170 to generate a revolution marker signal P₅. Such a revolution marker signal P_{S} may be in the form of an electric pulse having an edge that can be accurately detected and indicative of a certain rotational position of the monitored tool 20. The analysis apparatus 150 may generate information indicative of a rotational speed f_{ROT} of the tool 20 dependent on the position signal Ep, e.g. by detecting a temporal duration between revolution marker signals P₅. The position marker 180 may be e.g. an optical device 180, such as a reflex 180, when the position sensor 170 is an optical device, such as e.g. a laser transceiver configured to generate a revolution marker signal P_{S} when the intensity of laser reflection changes due to a laser beam impinging the reflex 180. Alternatively, the position marker 180 may be e.g. a magnetic device 180, such as strong magnet 180, when the position sensor 170 is a device 170 configured to detect a changed magnetic field. An example of a device configured to detect a changed magnetic field is a device including an inductive coil which will generate an electric current in response to a changed magnetic field. Thus, the device 170 configured to detect a changed magnetic field is configured to generate a revolution marker signal P_{S} when passing by the magnetic device 180. Alternatively, the position sensor 170 may be embodied by an encoder 170 which is mechanically coupled to the rotating tool 20 such that the encoder generates e.g. one marker signal P_{S} per revolution the rotating tool 20.

The system 5 may include a control room 220 allowing a machine operator 230 to operate the machine 10. The analysis apparatus 150 may be configured to generate information indicative of a tool wear state of the tool 20 of the machine 10. The analysis apparatus 150 also includes an apparatus Human Computer Interface (HCI) 210 for enabling user input and user output. The HCI 210 may include a display, or screen, 210S for providing a visual indication of an analysis result. The analysis result displayed may include information indicative of a tool wear state of the shearing process for enabling the operator 230 to control the machine including a tool for shearing and/or shaping a raw material workpiece.

A machine controller 240 is configured to deliver a rotational speed set point f_{ROT_SP}, and/or a machine instruction M_{INSTR} for said machine 10. The machine controller 240 may be connected to the Human Computer Interface (HCI) 210 and/or the analysis apparatus 150. According to some embodiments, the rotational speed set point f_{ROT_SP} is set by the operator 230. According to some embodiments, the machine instruction M_{INSTR} for said machine is selected by the operator 230. Thus, the machine controller 240 may include a machine user input/output interface 250 enabling to operator to deliver a rotational speed set point f_{ROT_SP}, and/or a machine instruction M_{INSTR} for said machine.

In some embodiments, the machine instruction M_{INSTR} for said machine 10 comprises instructions to perform at least one of
halt the process,
initialize replacement of the tool 20, or parts thereof,
execute an automatic process to replace the tool 20, or parts thereof,
adapt the operation mode of the machine 10, and/or
generate a visual signal and/or a sound signal at the machine 10 for operators based on tool wear state of the tool 20.

The machine controller 240 may be arranged to, upon receiving information indicative of successful replacement of the tool 20, restart the machine 10.

The machine may be arranged to, upon receiving a rotational speed set point f_{ROT_SP}, attempt to achieve a corresponding rotational speed f_{ROT} of the tool 20.

The machine 10 may be configured to adapt the tool 20, such as angling the tool edges 310, based on received a machine instruction M_{INSTR}.

According to some embodiments, the machine controller 240 may also generate a set point value f_{ROT_SP} for the rotational speed f_{ROT} of the tool. The rotational speed set point value f_{ROT}_SP may also be referred to as U1_{SP}. The rotational speed set point value f_{ROT_SP}, also referred to as U1_{SP}, may be generated in response to user input, from machine operator 230, via user input/output interface 250.

The machine controller 240 may also generate a set of set point values each corresponding to an operating parameter of the machine 10, such as set point values U1_{SP}. U2_{SP}, and U3_{SP}. In some embodiments, the set point values relate to a force F the raw material workpiece 30 is pressed against the tool 20, and/or the type or size of raw material 30 to be processed. In some embodiments, the machine 10 comprises means for feeding raw material to the tool 20. In some of these embodiments, the machine comprises means for feeding raw material and means selecting different types and/or size of raw materials 30. The expression “size of raw material” may relate to the cross sectional area of a raw material workpiece 30 during the process.

The machine user input/output interface 250, in the example illustrated in FIG. 1A, is coupled to the regulator 240 and the HCI 210 is coupled to the analysis apparatus 150, or monitoring module 150A, configured to generate information indicative of a tool wear state of the tool 20 of the machine 10. Thus, when coupled only to monitoring module 150A as shown in FIG. 1A, the HCI 210 is advantageously possible to add, in a control room 220, without any need to modify any previously existing input/output interface 250 and regulator 240 used by a machine operator 230 to operate the machine 10.

An object to be addressed by solutions and examples disclosed in this document is to describe methods and systems for an improved monitoring of a tool wear state X of a tool 20 in a machine 10 during operation. Moreover, an object to be addressed by solutions and examples disclosed in this document is to describe methods and systems for an improved Human Computer Interface (HCI) relating to conveying useful information about the tool wear state X in a machine including a tool for shearing and/or shaping a raw material workpiece during operation. Another object to be addressed by this document is to describe methods and systems for an improved Graphical User Interface (GUI) relating to the shearing process in a machine 10.

Another object to be addressed by solutions and examples disclosed in this document is to describe methods and systems for an improved control of an output Y from a machine 10 during operation. Yet another object to be addressed by solutions and examples disclosed in this document is to describe methods and systems for an improved Human Computer Interface (HCI) relating to conveying useful information about an output state Y indicative of output material 95 from a machine 10 during operation and/or also conveying useful information about a corresponding tool wear state X of a tool 20 in a machine 10 including a tool for shearing and/or shaping a raw material workpiece 30 during operation.

In some embodiments, the machine user input/output interface 250 instead of being coupled to the regulator 240 with the HCI 210 as a separate input/output interface coupled to the analysis apparatus 150, or monitoring module 150A, instead provides an integrated HCI 210, 250, 210S. Thus, the input/output interface 210 in said embodiment may be configured to enable all the input and/or output described above in conjunction with interfaces 210 and 250.

FIG. 1C is a block diagram illustrating a machine including a tool for shearing and/or shaping a raw material workpiece as a box 10B receiving a number of inputs U1, . . . . Uk, and generating a number of outputs Y1, . . . . Yn. With reference to FIG. 1C it is noted that, for the purpose of analysis, a machine 10 may be regarded as a black box 10B having a number of input variables, referred to as input parameters U1, U2, U3, . . . . Uk, where the index k is a positive integer. During operation of the black box machine 10B, the black box machine 10B has a tool wear state X, and it produces a number of output variables, also referred to as output parameters Y1, Y2, Y3, . . . . Yn, where the index n is a positive integer.

The tool wear state X of the machine 10 may be described, or indicated, by a number of tool wear state parameters X1, X2, X3, . . . , Xm, where the index m is a positive integer.

Using the terminology of linear algebra, the input variables U1, U2, U3, . . . . Uk may be collectively referred to as an input vector U; the tool wear state parameters X1, X2, X3, . . . , Xm may be collectively referred to as a tool wear state vector X; and the output parameters Y1, Y2, Y3, . . . . Yn may be collectively referred to as an output vector Y.

The tool wear state X of the machine 10, at a time termed r, can be referred to as X(r). That tool wear state X(r) can be described, or indicated, by a number of parameter values, the parameter values defining different aspects of the tool wear state X(r) of the machine 10 at time r.

The tool wear state X(r) of the black box machine 10B depends on the input vector U(r), and the output vector Y(r) depends on the tool wear state vector X(r). An aspect of the tool wear state X is tool edges 310 of the tool 20 processing raw material 30, and that the tool wear state vector X(r) does not change instantly. Thus, during operation of the machine 10, the tool wear state X(r) can be regarded as a function of an earlier tool wear state X(r−1) and of the input U(r):

X(r)=f₁(X(r−1), U(r)), wherein X(r−1) denotes the tool wear state X of the tool 20 at a point in time preceding the point in time termed r.

Likewise, the output Y of the black box 10B can be regarded as a function of the tool wear state X:

$$Y ( r ) = {f}_{2} ( X ( r ) )$$

FIG. 2, being another example of a cross-sectional view taken along line A-A of a machine resembling the depiction in FIG. 1A, that shows a more detailed example of the tool 20. The tool 20 may have tool edge attachment devices 22 for releasably attaching a number of tool edges 310. According to an example, a tool edge attachment device 22 is configured to releasably attach at least one tool edge 310. FIG. 2 depicts two tool edge attachment devices 22, each attaching one tool edge 310. In some embodiments all, tool edges 310 are attached by tool edge attachment devices 22. In some embodiment, a plurality of tool edges 310 are attached by the same tool edge attachment device 22. In some embodiment, all tool edges 310 are attached by the same tool edge attachment device 22.

According to some embodiments, there are provided at least two tool edges 310 on a tool 20. The example tool 20, shown in FIG. 2, includes twelve tool edges 310 that are placed at equal distances from each other in a radial configuration on the tool 20. The tool edges 310 may be configured to engage and deform the raw material 30 as the tool 20 rotates about the axis of rotation 60. The raw material 30 has a material surface, i.e. a boundary between the environment and the raw material 30. The term “deform” relates to any changing of shape of an object and/or removal of parts from an object, such as stripping the bark from a log.

In FIG. 2, the tool 20 is shown during rotation in a clockwise direction at a speed of rotation f_{ROT}. Tool edges 310 comprise structures such as cutting blades or saw blade teeth which project from tool edge attachment device 22. A tool edge 310 has a leading edge (not shown) that engages and shears the raw material 30 as the tool is rotated about the axis 60 of rotation such that the raw material workpiece 30 is deformed.

In one example, tool edges 310 are integrally formed as part of a single unitary body with tool edge attachment device 22 and tool 20. According to some embodiments, the tool edges 310 are equally spaces around the tool 20, such that for a rotating tool 20 the tool edges 310, and more specifically the leading edges of the tool edges 310, will pass a stationary position at the surface of the tool 20 at a constant frequency. Thus, referring to the example tool 20 shown in FIG. 2, including twelve tool edges 310, the angular distance between any two adjacent tool edges 310 is 30 degrees. In this context of rotating tools it is noted that, when there are L tool edges 310 on a tool, the L tool edges 310 being positioned such that the leading edges of the tool edges 310 are evenly spaced, then the angular distance between any two adjacent leading edges is 360/L degrees. Thus, when there are L tool edges 310 at angular positions on the tool 20, the L tool edges 310 being positioned in an equally spaced manner, then the angular distance between any two adjacent tool edges 310 is 360/L degrees.

The term “leading edges of the tool edges” relates to the part or parts of a tool edge that is expected to engage the raw material upon operation. For example for a sawblade tool edge the leading edge would be the teeth of the sawblade, or the outmost part of the teeth of the sawblade. Unless otherwise stated evenly spaced tool edges also implies evenly spaced leading edges of said tool edges.

In the example shown in FIG. 2, the tool position measurement is performed at the tool 20. The position sensor 170 is mounted in a stationary manner so that it generates a position signal Ep having a sequence of position signal values P₅ for indicating momentary rotational positions of the tool 20. The position marker device 180 may be provided on an outer wall surface of the tool 20 such that, when the tool 20 rotates around the axis of rotation 60, the position marker 180 passes by the position sensor 170 once per revolution of the tool, thereby causing the position sensor 170 to generate a revolution marker signal value PS. The position sensor 170 may comprise a tachometer 170 that delivers e.g. one position signal pulse E_{P} per revolution.

The position marker device 180 may comprise a metal object. The metal object may be a bolt or a metal bracket, for example. The machine 10 and/or tool 20 may comprise a plurality of position sensors 170 and/or a plurality of marker device 180, thereby allowing a plurality of interactions between position sensor 170 and position marker device 180 per revolution.

An important aspect of the shearing process is the flow rate of output material 95 out of the machine 10. The transport of output material 95 out of the machine 10 may also be referred to as the output material discharge rate.

The raw material 30 may be measured as it is being fed into machine 10. A feed material analyser 325 may be provided for generating a measurement value indicative of at least one raw material property U4. The at least one feed material property U4 may include a raw material size distribution. Thus a raw material size distribution may be estimated, e.g. by measurement. Alternatively, a raw material size distribution U4 may be predetermined. In some examples, the raw material size distribution U4 is known because of treatment and/or sorting before arrival of the raw material 30 to the machine 10.

Once raw material 30 is entered into the machine 10 the raw material 30 may be collectively referred to as raw material workpieces 30. While being brought into contact with the rotating tool 20 the raw material workpieces 30 are subjected to deformation typically resulting breakage into smaller pieces that are discharged from machine 10 via the output region. The deformation causes a change of the size distribution of the raw material, thereby producing output material 95.

During operation, output material 95 flows out of the machine 10 at a output material discharge rate R_{SDis}. The output material discharge rate R_{SDis} may be measured, and it may be regarded as an output parameter Y1.

The output material size distribution may be measured, and values indicative of the output material size distribution may be provided, e.g. as output parameter values Y2, Y3 etc. Output material surface roughness may be measured, and values indicative of the output material surface roughness may be provided, as output parameter value Y4.

It is believed that the output material properties Y depend on
the raw material properties U, and
the tool wear state(s) X of the machine 10.

With reference to FIG. 1A, during steady state operating conditions, the mass flow of material into, and out of the machine 10 will be constant, or substantially constant. Thus, the flow of output material 95 exiting the machine 10 may be discussed in terms of mass per time unit, e.g as measured in kilograms per minute or in metric tons per hour.

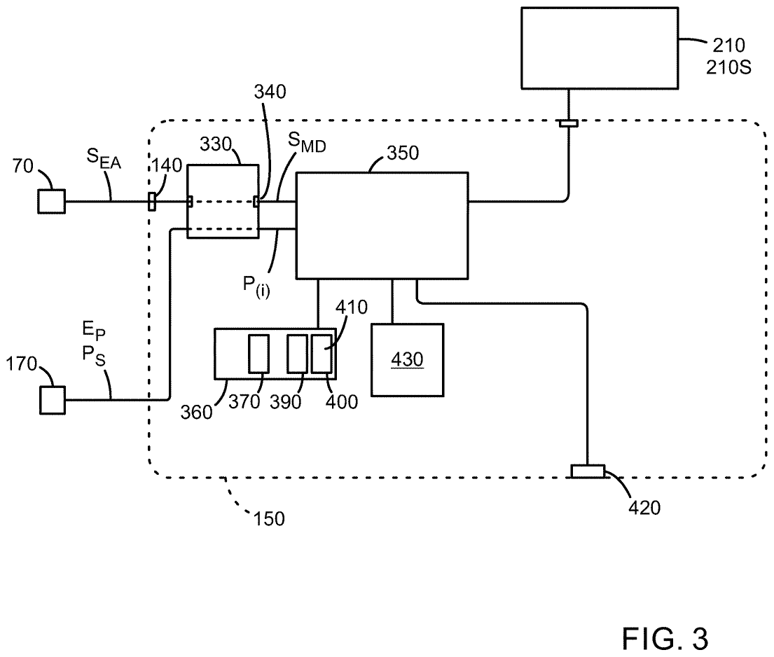

FIG. 3 is a schematic block diagram of an example of the analysis apparatus 150 shown in FIG. 1. The analysis apparatus 150 has an input 140 for receiving the analogue vibration signal S_{EA}, from the vibration sensor 70. The input 140 is connected to an analogue-to-digital (A/D) converter 330. The A/D converter 330 samples the received analogue vibration signal S_{EA} with a certain sampling frequency f_{S} so as to deliver a digital measurement data signal S_{MD} having said certain sampling frequency f_{S} and wherein the amplitude of each sample depends on the amplitude of the received analogue signal at the moment of sampling. The digital measurement data signal S_{MD} is delivered on a digital output 340 which is coupled to a data processing device 350.

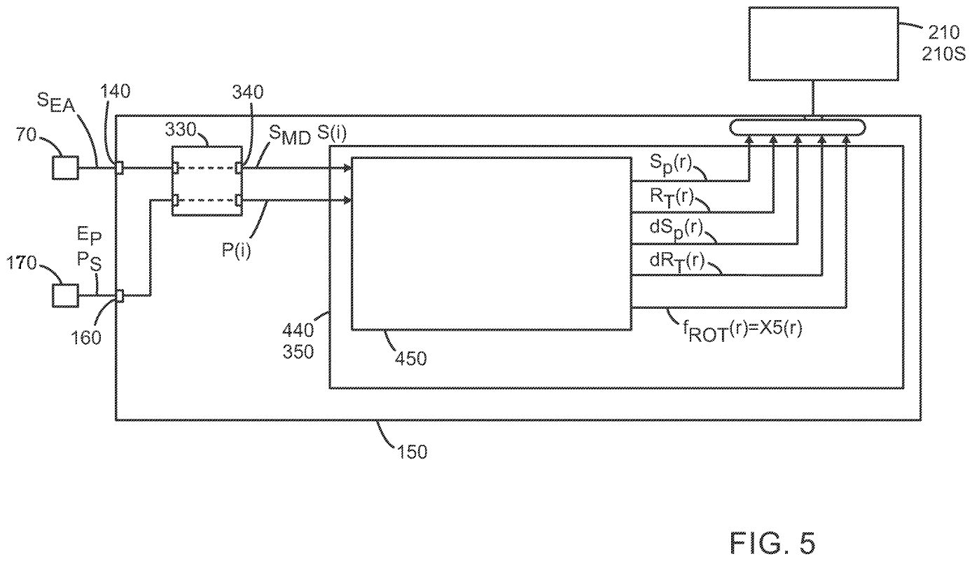

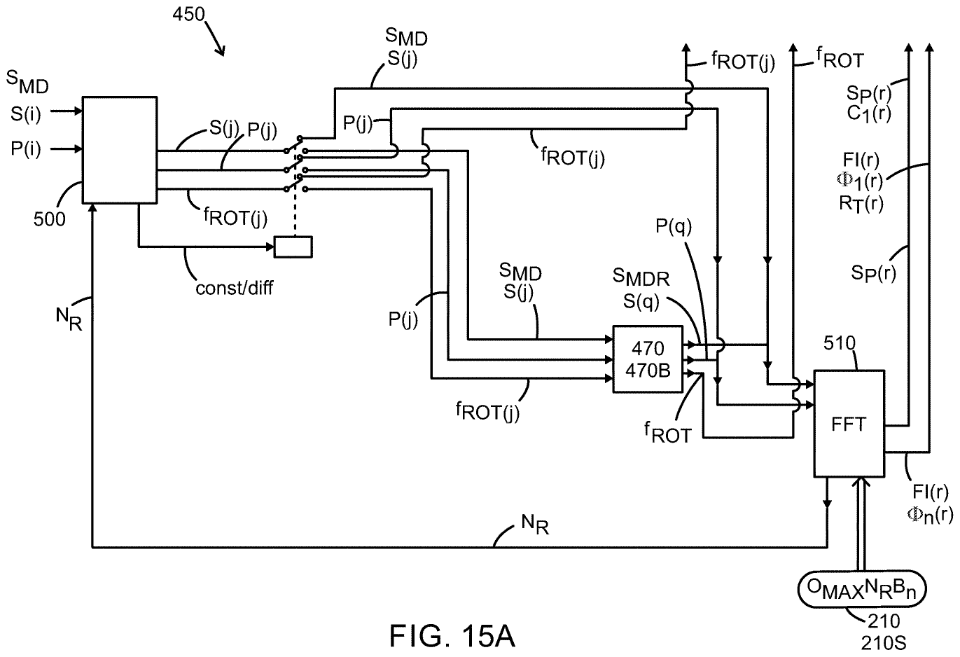

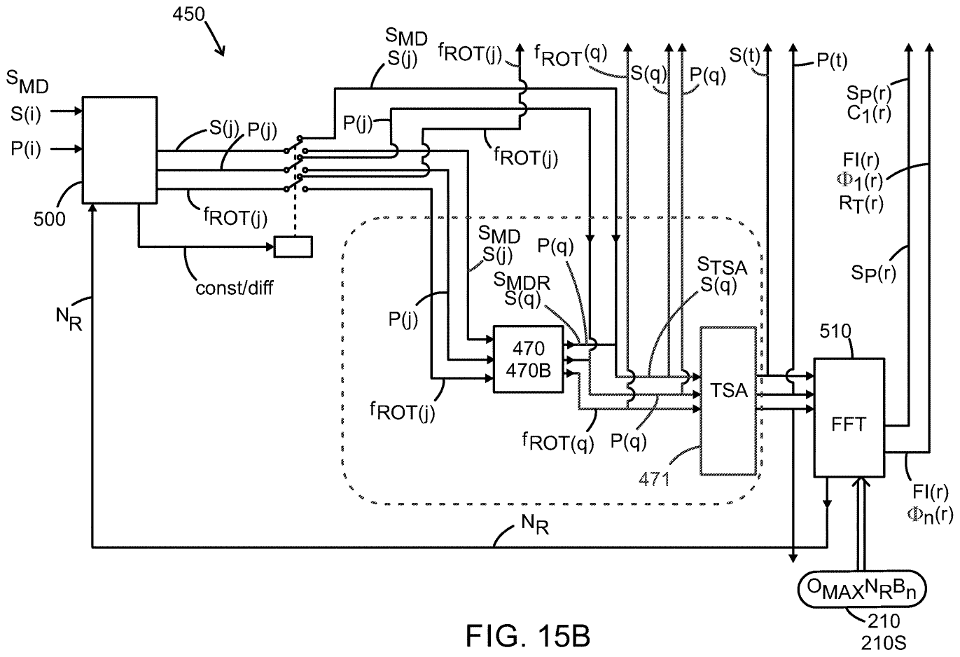

With reference to FIG. 3, the data processing device 350 is coupled to a computer readable medium 360 for storing program code. A computer readable medium 360 may also be referred to as a memory 360. The program memory 360 is preferably a non-volatile memory. The memory 360 may be a read/write memory, i.e. enabling both reading data from the memory and writing new data onto the memory 360. According to an example, the program memory 360 is embodied by a FLASH memory. The program memory 360 may comprise a first memory segment 370 for storing a first set of program code 380 which is executable so as to control the analysis apparatus 150 to perform basic operations. The program memory 360 may also comprise a second memory segment 390 for storing a second set of program code 394. The second set of program code in the second memory segment 390 may include program code for causing the analysis apparatus 150 to process a detected signal. The signal processing may include processing for generating information indicative of a tool wear state of a machine including a tool for shearing and/or shaping a raw material workpiece, as discussed elsewhere in this document. Moreover, the signal processing may include control of a machine including a tool for shearing and/or shaping a raw material workpiece, as discussed elsewhere in this document. Thus, the signal processing may include generating data indicative of a tool wear state X of a machine including a tool for shearing and/or shaping a raw material workpiece, as disclosed in connection with embodiments of status parameter extractor 450 of e.g. FIGS. 5, 15 and/or 24.

The memory 360 may also include a third memory segment 400 for storing a third set of program code 410. The set of program code 410 in the third memory segment 400 may include program code for causing the analysis apparatus to perform a selected analysis function. When an analysis function is executed, it may cause the analysis apparatus to present a corresponding analysis result on user interface 210, 210S or to deliver the analysis result on a port 420.

The data processing device 350 is also coupled to a read/write memory 430 for data storage. Hence, the analysis apparatus 150 comprises the data processor 350 and program code for causing the data processor 350 to perform certain functions, including digital signal processing functions. When it is stated, in this document, that the apparatus 150 performs a certain function or a certain method, that statement may mean that the computer program runs in the data processing device 350 to cause the apparatus 150 to carry out a method or function of the kind described in this document.

The processor 350 may be a Digital Signal Processor. The Digital Signal Processor 350 may also be referred to as a DSP. Alternatively the processor 350 may be a Field Programmable Gate Array circuit (FPGA). Hence, the computer program may be executed by a Field Programmable Gate Array circuit (FPGA). Alternatively, the processor 350 may comprise a combination of a processor and an FPGA. Thus, the processor may be configured to control the operation of the FPGA.

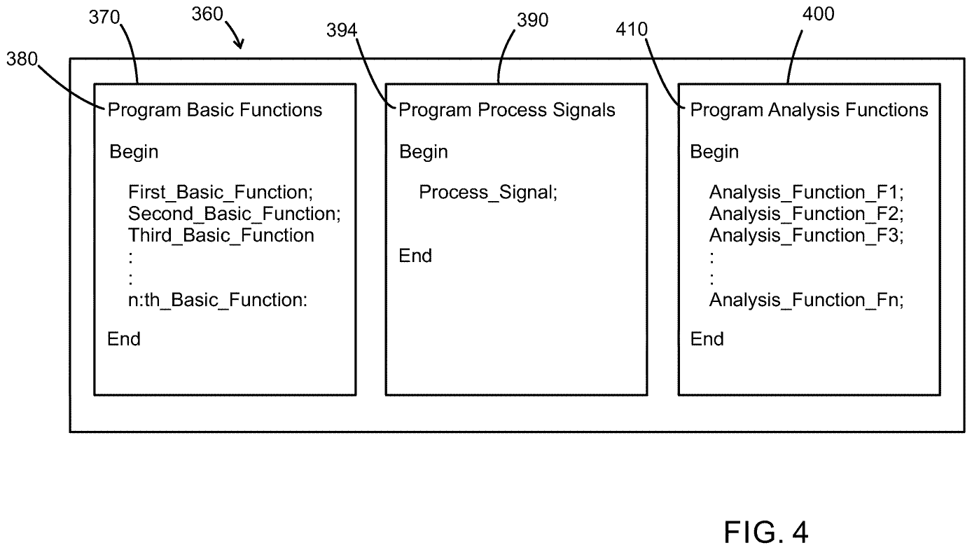

FIG. 4 is a simplified illustration of the program memory 360 and its contents. The simplified illustration is intended to convey understanding of the general idea of storing different program functions in memory 360, and it is not necessarily a correct technical teaching of the way in which a program would be stored in a real memory circuit. The first memory segment 370 stores program code for controlling the analysis apparatus 150 to perform basic operations. Although the simplified illustration of FIG. 4 shows pseudo code, it is to be understood that the program code may be constituted by machine code, or any level program code that can be executed or interpreted by the data processing device 350 (FIG. 3).

The second memory segment 390, illustrated in FIG. 4, stores a second set of program code 394. The program code 394 in segment 390, when run on the data processing device 350, will cause the analysis apparatus 150 to perform a function, such as a digital signal processing function. The function may comprise an advanced mathematical processing of the digital measurement data signal S_{MD}.

A computer program for controlling the function of the analysis apparatus 150 may be downloaded from a server computer. This means that the program-to-be-downloaded is transmitted to over a communications network. This can be done by modulating a carrier wave to carry the program over the communications network. Accordingly the downloaded program may be loaded into a digital memory, such as memory 360 (See FIGS. 3 and 4). Hence, a program 380 and/or a signal processing program 394 and/or an analysis function program 410 may be received via a communications port, such as port 420 (FIG. 1A & FIG. 3), so as to load it into program memory 360.

Accordingly, this document also relates to a computer program product, such as program code 380 and/or program code 394 and/or program code 410 loadable into a digital memory of an apparatus. The computer program product comprises software code portions for performing signal processing methods and/or analysis functions when said product is run on a data processing unit 350 of an apparatus 150. The term “run on a data processing unit” means that the computer program plus the data processing device 350 carries out a method of the kind described in this document.

The wording “a computer program product, loadable into a digital memory of a analysis apparatus” means that a computer program can be introduced into a digital memory of an analysis apparatus 150 so as achieve an analysis apparatus 150 programmed to be capable of, or adapted to, carrying out a method of a kind described in this document. The term “loaded into a digital memory of an apparatus” means that the apparatus programmed in this way is capable of, or adapted to, carrying out a function described in this document, and/or a method described in this document. The above mentioned computer program product may also be a program 380, 394, 410 loadable onto a computer readable medium, such as a compact disc or DVD. Such a computer readable medium may be used for delivery of the program 380, 394, 410 to a client. As indicated above, the computer program product may, alternatively, comprise a carrier wave which is modulated to carry the computer program 380, 394, 410 over a communications network. Thus, the computer program 380, 394, 410 may be delivered from a supplier server to a client having an analysis apparatus 150 by downloading over the Internet.

FIG. 5 is a block diagram illustrating an example of the analysis apparatus 150. In the FIG. 5 example, some of the functional blocks represent hardware and some of the functional blocks either may represent hardware, or may represent functions that are achieved by running program code on the data processing device 350, as discussed in connection with FIGS. 3 and 4.

The apparatus 150 in FIG. 5 shows an example of the analysis apparatus 150 shown in FIG. 1A and/or FIG. 3. For the purpose of simplifying understanding, FIG. 5 also shows some peripheral devices coupled to the apparatus 150. The vibration sensor 70 is coupled to the input 140 of the analysis apparatus 150 to deliver an analogue measuring signal S_{EA}, also referred to as vibration signal S_{EA}, to the analysis apparatus 150.

Moreover, the position sensor 170 is coupled to the second input 160. Thus, the position sensor 170 delivers the position signal Ep, dependent on the rotational position of the tool 20 and tool edges 310, to the second input 160 of the analysis apparatus 150. The input 140 is connected to an analogue-to-digital (A/D) converter 330. The A/D converter 330 samples the received analogue vibration signal S_{EA} with a certain sampling frequency f_{S} so as to deliver a digital measurement data signal S_{MD} having said certain sampling frequency f_{S} and wherein the amplitude of each sample depends on the amplitude of the received analogue signal at the moment of sampling. The digital measurement data signal S_{MD} is delivered on a digital output 340, which is coupled to a data processing unit 440. The data processing unit 440 comprises functional blocks illustrating functions that are performed. In terms of hardware, the data processing unit 440 may comprise the data processing unit 350, the program memory 360, and the read/write memory 430 as described in connection with FIGS. 3 and 4 above. Hence, the analysis apparatus 150 of FIG. 5 may comprise the data processing unit 440 and program code for causing the analysis apparatus 150 to perform certain functions.

The digital measurement data signal S_{MD} is processed in parallel with the position signal E_{P}. Hence, the A/D converter 330 may be configured to sample the position signal Ep simultaneously with the sampling of the analogue vibration signal S_{EA}. The sampling of the position signal E_{P} may be performed using that same sampling frequency f_{S} so as to generate a digital position signal E_{PD} wherein the amplitude of each sample P(i) depends on the amplitude of the received analogue position signal E_{P} at the moment of sampling. As mentioned above, the analogue position signal E_{P} may have a marker signal value P_{S}, e.g. in the form of an electric pulse having an amplitude edge that can be accurately detected and indicative of a certain rotational position of the monitored tool 20. Thus, whereas the analogue position marker signal P_{S} has an amplitude edge that can be accurately detected, the digital position signal Epp will switch from a first value, e.g. “0” (zero), to a second value, e.g. “1” (one), at a distinct time.

Hence, the A/D converter 330 may be configured to deliver a sequence of pairs of measurement values S(i) associated with corresponding position signal values P(i). The letter “i” in S(i) and P(i) denotes a point in time, i.e. a sample number. Hence, the time of occurrence of a rotational reference position of said rotating tool can be detected by analysing a time sequence of the position signal values P(i) and identifying the sample P(i) indicating that the digital position signal EpD has switched from the first value, e.g. “0” (zero), to the second value, e.g. “1” (one).

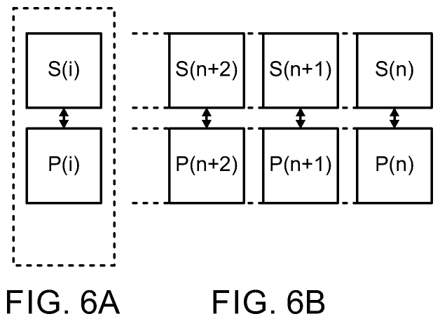

FIG. 6A is an illustration of a signal pair S(i) and P(i) as delivered by the A/D converter 330.

FIG. 6B is an illustration of a sequence of the signal pair S(i) and P(i) as delivered by the A/D converter 330. A first signal pair comprises a first vibration signal amplitude value S(n), associated with the sample moment “n”, being delivered simultaneously with a first position signal value P(n), associated with the sample moment “n”. It is followed by a second signal pair comprising a second vibration signal amplitude value S(n+1), associated with the sample moment “n+1”, which is delivered simultaneously with a second position signal value P(n+1), associated with the sample moment “n+1”, and so on.

With reference to FIG. 5, the signal pair S(i) and P(i) is delivered to a status parameter extractor 450. The status parameter extractor 450 is configured to generate and output values indicative of the tool wear state X. Said values indicative of the tool wear state X are based on a measured impact force F_{IMP} generated when a tool edge 310 of the rotating tool interacts with the raw material workpiece 30 (See FIG. 1A, FIG. 2). As mentioned above, the time of occurrence of a rotational reference position of said rotating tool can be detected by analysing a time sequence of the position signal values P(i) and identifying a sample P(i) indicating that the digital position signal E_{PD} has switched from the first value, e.g. “0” (zero), to the second value, e.g. “1” (one).

In FIG. 5, five output values are shown: S_{P}(r) indicative of a magnitude of said impact force F_{IMP}, RT(r) indicative of a position and/or rotation of said tool 20 at impact, the corresponding derivatives, and f_{ROT}(r) a determined speed of rotation of the tool 20. It is to be understood that a number of different types of output values may be generated by the status parameter extractor 450, such as values representing the signal pair S(i) P(i) in the frequency domain, or values from averaging/interpolating said signal pair S(i) P(i) data over multiple revolutions.

The status parameter extractor 450 may also be configured to generate a set of averaged cycle position values P_{TSA} and a corresponding set of averaged vibration signal values S_{TSA} based on cycle position values P(i) and vibration signal values S(i) from a plurality of revolutions. In some examples, a set of averaged cycle position values P_{TSA} and a corresponding set of averaged vibration signal values S_{TSA} comprise an averaged vibration amplitude value S_{TSA}(i) and an averaged position value P_{TSA}(i) for equidistant positions along the revolution or along the path of the cycle, such as containing 360 pairs of values for one revolution with one pair of values spaced out by 1°.

The status parameter extractor 450 may also be configured to generate an frequency magnitude and/or a frequency phase based on a Fourier transform of cycle position values P(i) and vibration signal values S(i). The relationship between frequency magnitudes for different frequencies, or frequency bins, may be indicative of the tool wear state X. The phase for different frequencies, or frequency bins, may be indicative of the tool wear state X and/or the position on the tool 20 where the raw material workpiece 30 interacts with the tool edges 310.

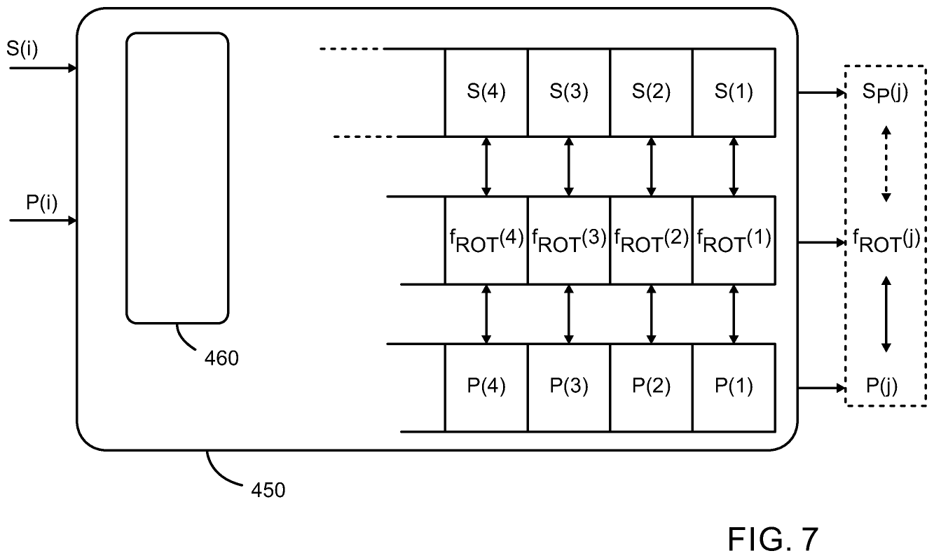

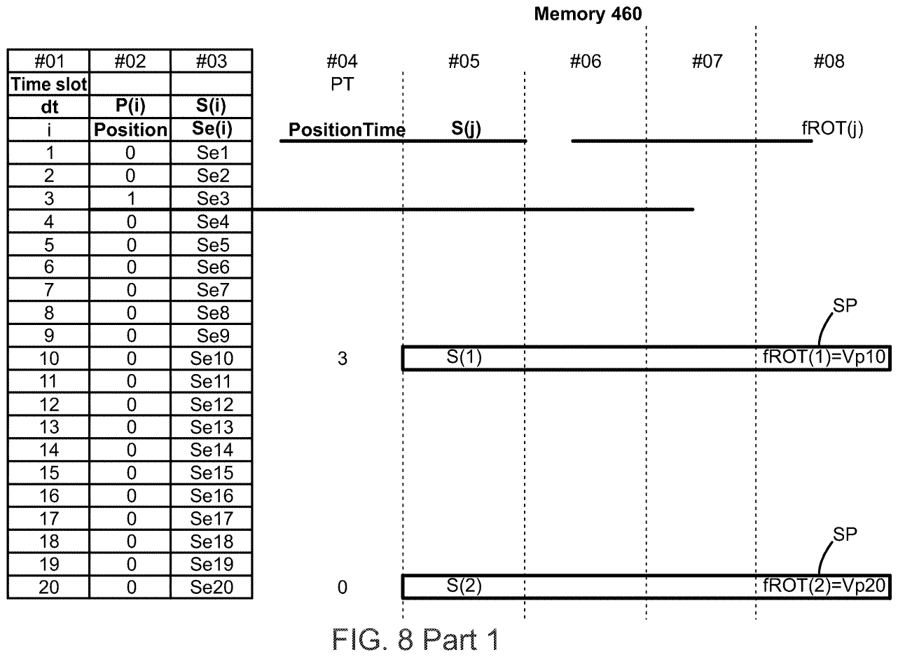

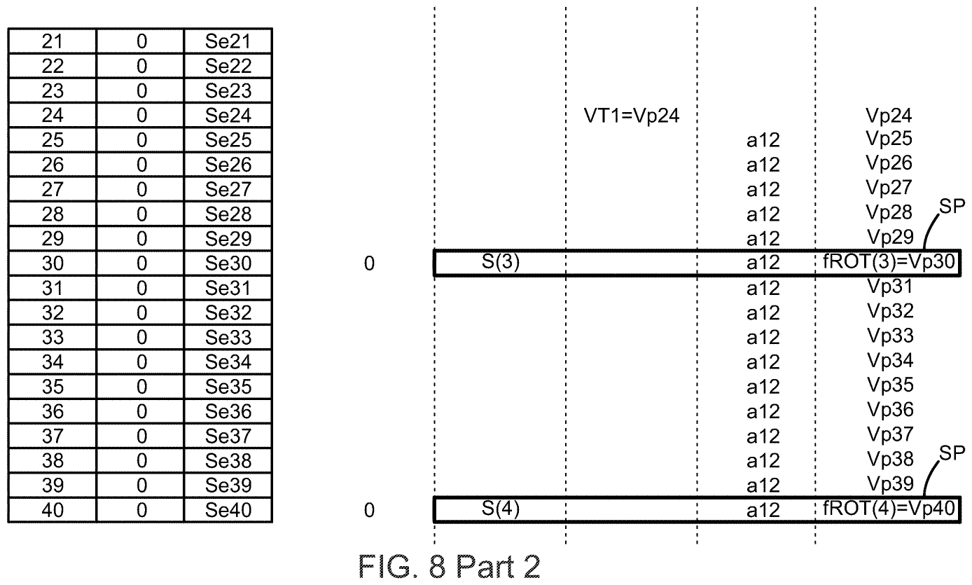

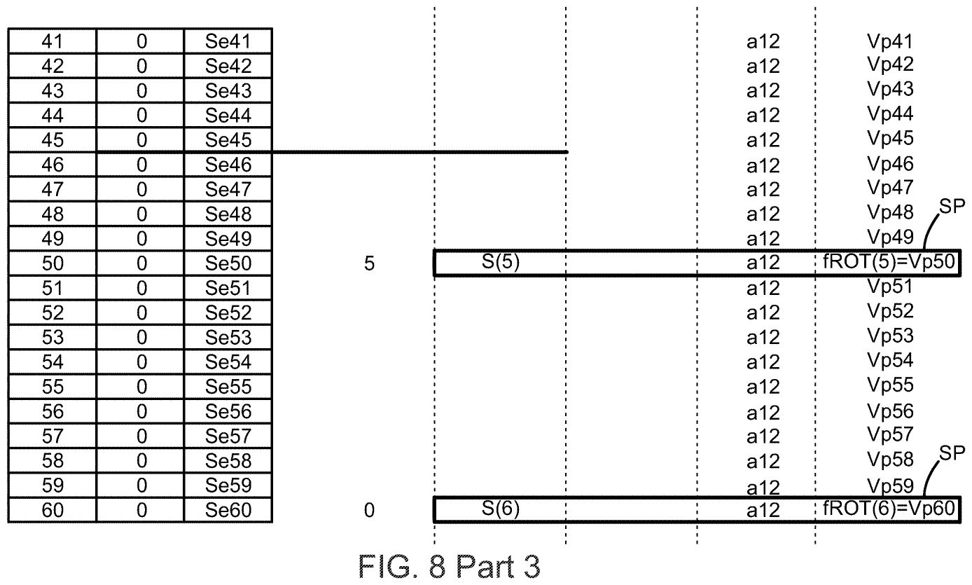

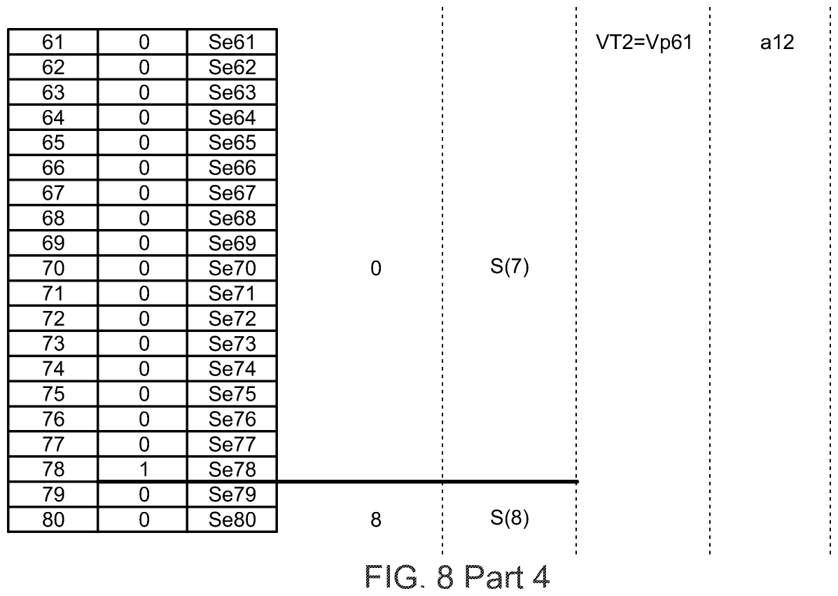

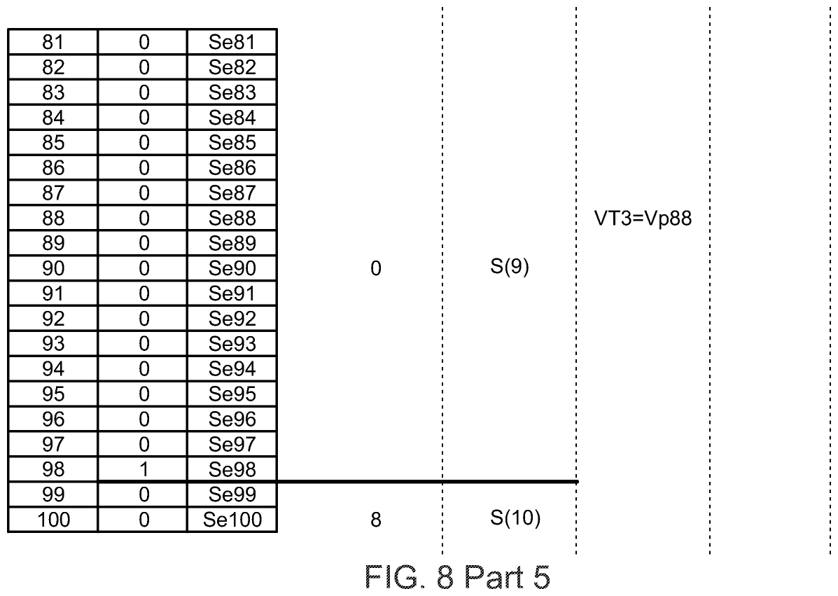

FIG. 7 is a block diagram that illustrates an example of a part of a status parameter extractor 450. According to an example the status parameter extractor 450 comprises a memory 460. The status parameter extractor 450 is adapted to receive a sequence of measurement values S(i) and a sequence of positional signals P(i), together with temporal relations there-between, and the status parameter extractor 450 is adapted to provide a sequence of temporally coupled values S(i), f_{ROT}(i), and P(i). Thus, an individual measurement value S(i) is associated with a corresponding speed value f_{ROT}(i), the speed value f_{ROT}(i) being indicative of the rotational speed of the tool 20 at the time of detection of the associated individual measurement value S(i). This is described in detail below with reference to FIGS. 8-13.

FIG. 8 is a simplified illustration of an example of the memory 460 and its contents, and columns #01, #02, #03, #04 and #05, on the left hand side of the memory 460 illustration, provide an explanatory image intended to illustrate the temporal relation between the time of detection of the encoder pulse signals P(i) (See column #02) and the corresponding vibration measurement values S(i) (See column #03).

As mentioned above, the analogue-to-digital converter 330 samples the analogue electric measurement signal S_{EA} at an initial sampling frequency f_{S} so as to generate a digital measurement data signal S_{MD}. The encoder signal P may also be detected with substantially the same initial temporal resolution f_{S}, as illustrated in the column #02 of FIG. 8.

Column #01 illustrates the progression of time as a series of time slots, each time slot having a duration dt=1/f_{Sample}; wherein f_{Sample} is a sample frequency having an integer relation to the initial sample frequency f_{S} with which the analogue electric measurement signal S_{EA} is sampled. According to a preferred example, the sample frequency f_{Sample} is the initial sample frequency f_{S}. According to another example the sample frequency f_{Sample} is a first reduced sampling frequency f_{SR1}, which is reduced by an integer factor M as compared to the initial sampling frequency f_{S}.

In column #02 of FIG. 8 each positive edge of the encoder signal P is indicated by a “1”. In this example a positive edge of the encoder signal P is detected in the 3:rd, the 45:th, the 78:th time slot and in the 98:th time slot, as indicated in column #02. According to another example, the negative edges of the positional signal are detected, which provides an equivalent result to detecting the positive edges. According to yet another example both the positive and the negative edges of the positional signal are detected, so as to obtain redundancy by enabling the later selection of whether to use the positive or the negative edge.

Column #03 illustrates a sequence of vibration sample values S(i). Column #05 illustrates the corresponding sequence of vibration sample values S(j), when an integer decimation is performed. Hence, when integer decimation is performed by this stage, it may e.g. be set up to provide an integer decimation factor M=10, and as illustrated in FIG. 8, there will be provided one vibration sample value S(j) (See column #05 in FIG. 8) for every ten samples S(i) (See column #03 in FIG. 8). According to an example, a very accurate position and time information PT, relating to the decimated vibration sample value S(j), is maintained by setting the Position Time signal in column #04 to value PT=3, so as to indicate that the positive edge (see col #02) was detected in time slot #03. Hence, the value of the PositionTime signal, after the integer decimation is indicative of the time of detection of the position signal edge P in relation to sample value S(1).

In the example of FIG. 8, the amplitude value of the PositionTime signal at sample i=3 is PT=3, and since decimation factor M=10 so that the sample S(1) is delivered in time slot 10, this means that the edge was detected M-PT=10−3=7 slots before the slot of sample S(1). Accordingly, the apparatus 150 may operate to process the information about the positive edges of encoder signal P(i) in parallel with the vibration samples S(i) in a manner so as to maintain the time relation between positive edges of the encoder signal P(i) and corresponding vibration sample values S(i), and/or integer decimated vibration sample values S(j), through the above mentioned signal processing from detection of the analogue signals to the establishing of the speed values f_{ROT}.

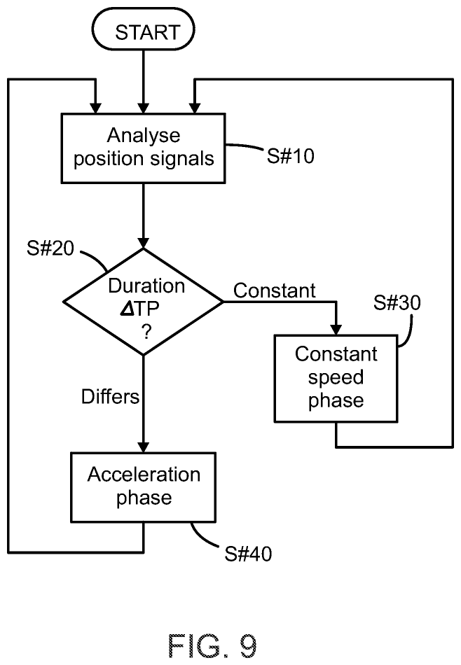

FIG. 9 is a flow chart illustrating an example of a method of operating the status parameter extractor 450 of FIG. 7.

According to an example, the status parameter extractor 450 analyses (Step S#10) the temporal relation between three successively received position signals, in order to establish whether the monitored rotational tool 20 is in a constant speed phase or in an acceleration phase. This analysis may be performed on the basis of information in memory 460, as described above (See FIG. 8).

If the analysis reveals that there is an identical number of time slots between the position signals, status parameter extractor 450 concludes (in step #20) that the speed is constant, in which case step S#30 is performed.

In step S#30, the status parameter extractor 450 may calculate the duration between two successive position signals, by multiplication of the duration of a time slot dt=1/f_{S} with the number of time slots between the two successive position signals. When the position signal is provided once per full revolution of the monitored tool 20, the speed of revolution may be calculated as

$$V = 1 / ( {n}_{diff} * dt ) ,$$

wherein n_{diff}=the number of time slots between the two successive position signals. During constant speed phase, all of the sample values S(j) (see column #05 in FIG. 8) associated with the three analyzed position signals may be assigned the same speed value f_{ROT}=V=1/(n_{diff}*dt), as defined above. Thereafter, step S#10 may be performed again on the next three successively received position signals. Alternatively, when step S#10 is repeated, the previously third position signal P3 will be used as the first position signal P1 (i.e. P1: =P3), so that it is ascertained whether any change of speed is at hand.

If the analysis (Step S#10) reveals that the number of time slots between the 1: st and the 2:nd position signals differs from the number of time slots between the 2:nd and 3: rd position signals, the status parameter extractor 450 concludes, in step S#20) that the monitored rotational tool 20 is in an acceleration phase. The acceleration may be positive, i.e. an increase in rotational speed, or the acceleration may be negative, i.e. a decrease in rotational speed also referred to as retardation.

In a next step S#40, the status parameter extractor 450 operates to establish momentary speed values during acceleration phase, and to associate each one of the measurement data values S(j) with a momentary speed value Vp which is indicative of the speed of rotation of the monitored tool 20 at the time of detection of the sensor signal (SEA) value corresponding to that data value S(j).

According to an example the status parameter extractor 450 operates to establish momentary speed values by linear interpolation. According to another example the status parameter extractor 450 operates to establish momentary speed values by non-linear interpolation.

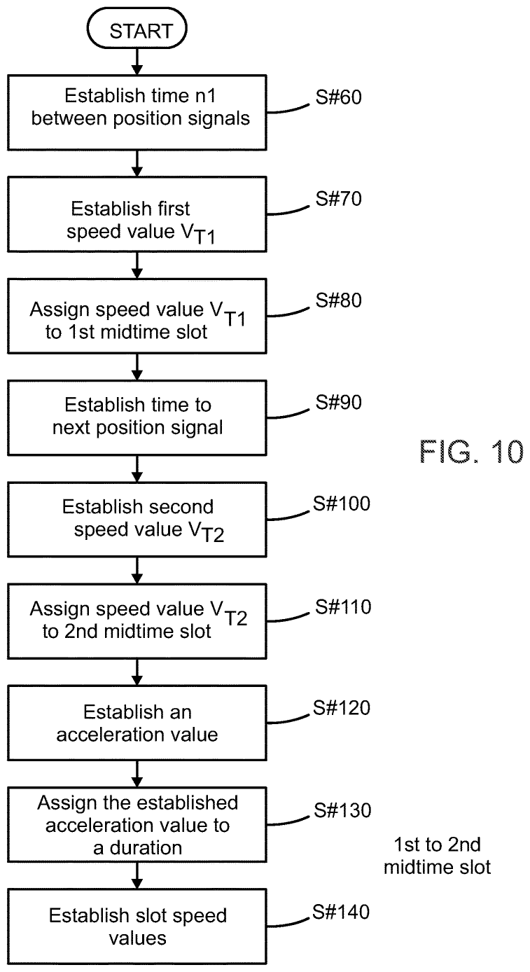

FIG. 10 is a flow chart illustrating an example of a method for performing step S#40 of FIG. 9. According to an example, the acceleration is assumed to have a constant value for the duration between two mutually adjacent position indicators P(See column #02 in FIG. 8). Hence, when
the position indicator P is delivered once per revolution, and
the gear ratio is 1/1: then
the angular distance travelled by the rotating tool 20 between two mutually adjacent position indicators P is one (1) revolution, which may also be expressed as 360 degrees, and
the duration is T=n_{diff}*dt,
   where n_{diff} is the number of slots of duration dt between the two mutually adjacent position indicators P.

With reference to FIG. 8, a first position indicator P was detected in slot i1=#03 and the next position indicator P was detected in slot i2=#45. Hence, the duration was n_{diff}1=12−11=45−3=42 time slots.

Hence, in step S#60 (See FIG. 10 in conjunction with FIG. 8), the status parameter extractor 450 operates to establish a first number of slots n_{diff1} between the first two successive position signals P1 and P2, i.e. between position signal P(i=3) and position signal P(i=45).

In step S#70, the status parameter extractor 450 operates to calculate a first speed of revolution value VT1. The first speed of revolution value VT1 may be calculated as

$$VT 1 = 1 / ( {n}_{diff 1} * dt ) ,$$

wherein VT1 is the speed expressed as revolutions per second,
n_{diff1}=the number of time slots between the two successive position signals; and
dt is the duration of a time slot, expressed in seconds.

Since the acceleration is assumed to have a constant value for the duration between two mutually adjacent position indicators P, the calculated first speed value VT1 is assigned to the time slot in the middle between the two successive position signals (step S#80).

Hence, in this example wherein first position indicator P1 was detected in slot ip1=#03 and the next position indicator P2 was detected in slot ip2=#45; the first mid time slot is slot i_{P1-2}=i_{P1}+(i_{P2}−i_{P1})/2=3+(45−3)/2=3+21)=24.

Hence, in step S#80 the first speed of revolution value VT1 may be assigned to a time slot (e.g. time slot i=24) representing a time point which is earlier than the time point of detection of the second position signal edge P(i=45), see FIG. 8.

The retro-active assigning of a speed value to a time slot representing a point in time between two successive position signals advantageously enables a significant reduction of the inaccuracy of the speed value. Whereas state of the art methods of attaining a momentary rotational speed value of a tool 20 may have been satisfactory for establishing constant speed values at several mutually different constant speeds of rotation, the state of the art solutions appear to be unsatisfactory when used for establishing speed values for a rotational tool 20 during an acceleration phase.

By contrast, the methods according to examples disclosed in this document enable the establishment of speed values with an advantageously small level of inaccuracy even during an acceleration phase.

In a subsequent step S#90, the status parameter extractor 450 operates to establish a second number of slots naiff2 between the next two successive position signals. In the example of FIG. 8, that is the number of slots naiff2 between slot 45 and slot 78, i.e. n_{diff2}=78−45=33.

In step S#100, the status parameter extractor 450 operates to calculate a second speed of revolution value VT2. The second speed of revolution value VT2 may be calculated as

$$VT 2 = Vp 61 = 1 / ( {n}_{diff 2} * dt ) ,$$

wherein n_{diff2}=the number of time slots between the next two successive position signals P2 and P3. Hence, in the example of FIG. 8, n_{diff2}=33 i.e. the number of time slots between slot 45 and slot 78.

Since the acceleration may be assumed to have a constant value for the duration between two mutually adjacent position indicators P, the calculated second speed value VT2 is assigned (Step S#110) to the time slot in the middle between the two successive position signals. Hence, in the example of FIG. 8, the calculated second speed value VT2 is assigned to slot 61, since 45+(78−45)/2=61,5. Hence the speed at slot 61 is set to

$$V ( 61 ) := VT 2.$$

Hence, in this example wherein one position indicator P was detected in slot i2=#45 and the next position indicator P was detected in slot i3=#78; the second mid time slot is the integer part of:

$${i}_{P 2 - 3} = {i}_{P 2} + ( {i}_{P 3} - {i}_{P 2} ) / 2 = 45 + ( 78 - 45 ) / 2 = 45 + 33 / 2 = 61 , 5$$

Hence, slot 61 is the second mid time slot iₚ₂₋₃.

Hence, in step S#110 the second speed value VT2 may advantageously be assigned to a time slot (e.g. time slot i=61) representing a time point which is earlier than the time point of detection of the third position signal edge P(i=78), see FIG. 8. This feature enables a somewhat delayed real-time monitoring of the rotational speed while achieving an improved accuracy of the detected speed.

In the next step S#120, a first acceleration value is calculated for the relevant time period. The first acceleration value may be calculated as:

$$a 12 = ( VT 2 - VT 1 ) / ( ( {i}_{V T 2} - {i}_{V T 1} ) * dt )$$

In the example of FIG. 8, the second speed value VT2 was assigned to slot 61, so ivr2=61 and first speed value VT1 was assigned to slot 24, so ivTI=24.

Hence, since dt=1/f_{S}, the acceleration value may be set to

$$a 12 = fs * ( VT 2 - VT 1 ) / ( {i}_{V T 2} - {i}_{V T 1} )$$

for the time period between slot 24 and slot 60, in the example of FIG. 8.

In the next step S#130, the status parameter extractor 450 operates to associate the established first acceleration value a12 with the time slots for which the established acceleration value a12 is valid. This may be all the time slots between the slot of the first speed value VT1 and the slot of the second speed value VT2. Hence, the established first acceleration value a12 may be associated with each time slot of the duration between the slot of the first speed value VT1 and the slot of the second speed value VT2. In the example of FIG. 8 it is slots 25 to 60. This is illustrated in column #07 of FIG. 8.

In the next step S#140, the status parameter extractor 450 operates to establish speed values for measurement values s (j) associated with the duration for which the established acceleration value is valid. Hence speed values are established for each time slot which is
associated with a measurement value s (j), and
associated with the established first acceleration value a12.

During linear acceleration, i.e. when the acceleration a is constant, the speed at any given point in time is given by the equation:

$$V ( i ) = V ( i - 1 ) + a * dt ,$$

wherein
V(i) is the momentary speed at the point of time of slot i
V(i−1) is the momentary speed at the point of time of the slot immediately preceding slot i
a is the acceleration
dt is the duration of a time slot

According to an example, the speed for each slot from slot 25 to slot 60 may be calculated successively in this manner, as illustrated in column #08 in FIG. 8. Hence, momentary speed values Vp to be associated with the detected measurement values Se(25), Se(26), Se(27) . . . . Se(59), and Se(60) associated with the acceleration value a12 may be established in this manner (See time slots 25 to 60 in column #08 in conjunction with column #03 and in conjunction with column #07 in FIG. 8).

Hence, momentary speed values S(j) [See column #05] to be associated with the detected measurement values S(3), S(4), S(5), and S(6) associated with the acceleration value a12 may be established in this manner.

According to another example, the momentary speed for the slot 30 relating to the first measurement value s (j)=S(3) may be calculated as:

$$V ( i = 30 ) = Vp 30 = VT 1 + a * ( 30 - 24 ) * dt = Vp 24 + a * 6 * dt$$

The momentary speed for the slot 40 relating to the first measurement value s (j)=S(4) may be calculated as:

$$\begin{matrix}V ( i = 40 ) = Vp 40 = VT 1 + a * ( 40 - 24 ) * dt = Vp 40 + a * 16 * dt \\ or as : \\ V ( i = 40 ) = Vp 40 = V ( 30 ) + ( 40 - 30 ) * dt = Vp 30 + a * 10 * dt\end{matrix}$$

The momentary speed for the slot 50 relating to the first measurement value s (j)=S(5) may then subsequently be calculated as:

$$V ( i = 50 ) = Vp 50 = V ( 40 ) + ( 50 - 40 ) * dt = Vp 40 + a * 10 * dt$$

and the momentary speed for the slot 60 relating to the first measurement value s (j)=S(6) may then subsequently be calculated as:

$$V ( i = 60 ) = Vp 50 + a * 10 * dt$$

When measurement sample values S(i) [See column #03 in FIG. 8] associated with the established acceleration value have been associated with a momentary speed value, as described above, an array of data including a time sequence of measurement sample values S(i), each value being associated with a speed value V(i), f_{ROT}(i), may be delivered on an output of said status parameter extractor 450.

Alternatively, if a decimation of sample rate is desired, it is possible to do as follows: When measurement sample values S(j) [See column #05 in FIG. 8] associated with the established acceleration value have been associated with a momentary speed value, as described above, an array of data including a time sequence of measurement sample values S(j), each value being associated with a speed value V(j), f_{ROT}(j), may be delivered on an output of said status parameter extractor 450.

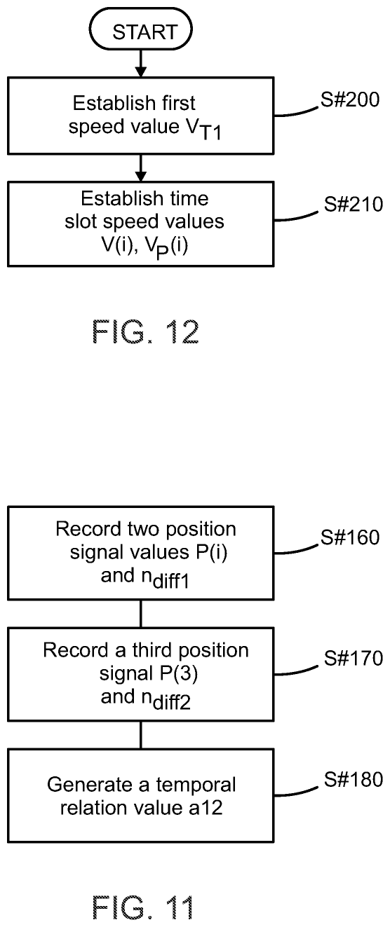

With reference to FIG. 11, another example of a method is described. According to this example, the status parameter extractor 450 operates to record (see step S#160 in FIG. 11) a time sequence of position signal values P(i) of said position signal (Ep) such that there is a value n_{diffi} between at least some of the recorded position signal values (P(i)), such as e.g. between a first position signal value P1(i) and a second position signal value P2(i). According to an example, the second position signal value P2(i) is received and recorded in a time slot (i) which arrives n_{diff1} slots after the reception of the first position signal value P1(i) (see step S#160 in FIG. 11). Then the third position signal value P3(i) is received and recorded (see step S#170 in FIG. 11) in a time slot (i) which arrives n_{diff2}slots after the reception of the second position signal value P2(i).

As illustrated by step S#180 in FIG. 11, the status parameter extractor 450 may operate to calculate a relation value

$$a 12 = ndiff 1 / ndiff 2$$

If the relation value a12 equals unity, or substantially unity, then the status parameter extractor 450 operates to establish that the speed is constant, and it may proceed with calculation of speed according to a constant speed phase method.

If the relation value a12 is higher than unity, the relation value is indicative of a percentual speed increase.

If the relation value a12 is lower than unity, the relation value is indicative of a percentual speed decrease.

The relation value a12 may be used for calculating a speed V2 at the end of the time sequence based on a speed V1 at the start of the time sequence, e.g. as

$$V 2 = a 12 * V 1$$

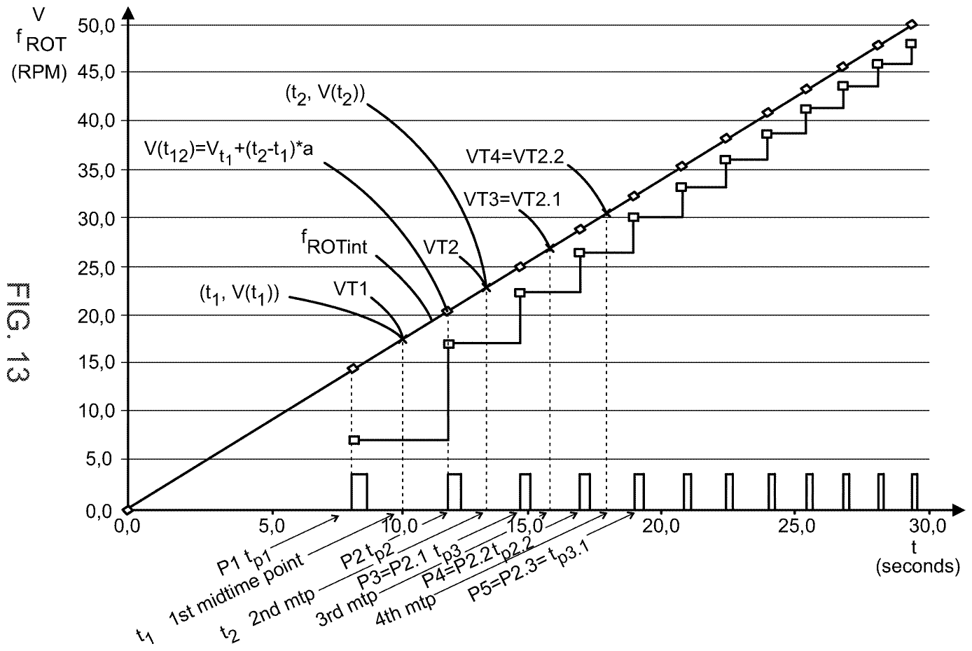

FIG. 12 is a flow chart illustrating an example of a method for performing step S#40 of FIG. 9. According to an example, the acceleration is assumed to have a constant value for the duration between two mutually adjacent position indicators P(See column #02 in FIG. 8). Hence, when
the position indicator P is delivered once per revolution, and
the gear ratio is 1/1: then
the angular distance travelled between two mutually adjacent position indicators P is 1 revolution, which may also be expressed as 360 degrees, and
the duration is T=n*dt,
where n is the number of slots of duration dt between the first two mutually adjacent position indicators P1 and P2.

In a step S#200, the first speed of revolution value VT1 may be calculated as

$$VT 1 = 1 / ( {n}_{diff 1} * dt ) ,$$

wherein VT1 is the speed expressed as revolutions per second,
n_{diff}1=the number of time slots between the two successive position signals; and
dt is the duration of a time slot, expressed in seconds. The value of dt may e.g be the inverse of the initial sample frequency f_{S}.

Since the acceleration is assumed to have a constant value for the duration between two mutually adjacent position indicators P, the calculated first speed value VT1 is assigned to the first mid time slot in the middle between the two successive position signals P(i) and P(i+n_{diff1}).

In a step S#210, a second speed value VT2 may be calculated as

$$VT 2 = 1 / ( ndiff 2 * dt ) ,$$

wherein VT2 is the speed expressed as revolutions per second,
n_{diff2}=the number of time slots between the two successive position signals; and
dt is the duration of a time slot, expressed in seconds. The value of dt may e.g. be the inverse of the initial sample frequency f_{S}.

Since the acceleration is assumed to have a constant value for the duration between two mutually adjacent position indicators P, the calculated second speed value VT2 is assigned to the second mid time slot in the middle between the two successive position signals P(i+ndiff1) and P(i+ndiff1+ndiff2).

Thereafter, the speed difference V_{Delta} may calculated as

$${V}_{Delta} = VT 2 - VT 1$$

This differential speed V_{Delta} value may be divided by the number of time slots between the second mid time slot and the first mid time slot. The resulting value is indicative of a speed difference dV between adjacent slots. This, of course, assumes a constant acceleration, as mentioned above.

The momentary speed value to be associated with selected time slots may then be calculated in dependence on said first speed of revolution value VT1, and the value indicative of the speed difference between adjacent slots.

When the measurement sample values S(i), associated with time slots between the first mid time slot and the second mid time slot, have been associated with a momentary speed value, as described above, an array of data including a time sequence of measurement sample values S(i), each value being associated with a speed value V(i) is delivered on an output of said status parameter extractor 450. The momentary speed value V(i) may also be referred to as f_{ROT}(i).

In summary, according to some examples, a first momentary speed value VT1 may be established in dependence of
the angular distance delta-FIp₁₋ₚ₂ between a first positional signal P1 and a second positional signal P2, and in dependence of
the corresponding duration delta-Tₚ₁₋ₚ₂=tₚ₂₋ₜₚ₁.

Thereafter, a second momentary speed value VT2 may be established in dependence of the angular distance delta-FIₚ₂₋ₚ₃ between the second positional signal P2 and a third positional signal P3, and in dependence of the corresponding duration delta-Tₚ₂₋ₚ₃=tₚ₂₋ₜₚ₁.

Thereafter, momentary speed values for the rotational tool 20 may be established by interpolation between the first momentary speed value VT1 and the second momentary speed value VT2.

In other words, according to examples, two momentary speed values VT1 and VT2 may be established based on the angular distances delta-FIₚ₁₋ₚ₂, delta-FIₚ₂₋ₚ₃ and the corresponding durations between three consecutive position signals, and thereafter momentary speed values for the rotational tool 20 may be established by interpolation between the first momentary speed value VT1 and the second momentary speed value VT2.

FIG. 13 is a graph illustrating a series of temporally consecutive position signals P1, P2, P3, . . . , each position signal P being indicative of a full revolution of the monitored tool 20. Hence, the time value, counted in seconds, increases along the horizontal axis towards the right.

The vertical axis is indicative of speed of rotation, graded in revolutions per minute (RPM). With reference to FIG. 13, effects of the method according to an example are illustrated. A first momentary speed value V(t₁)=VT1 may be established in dependence of the angular distance delta-FIₚ₁₋ₚ₂between the first positional signal P1 and the second positional signal P2, and in dependence of the corresponding duration delta-T1-2=tₚ₂₋ₜₚ₁. The speed value attained by dividing the angular distance delta-FIₚ₁₋ₚ₂ by the corresponding duration (tₚ₂₋ₜₚ₁) represents the speed V(t₁) of the rotational tool 20 at the first mid time point t₁, also referred to as mtp (mid time point), as illustrated in FIG. 13.

Thereafter, a second momentary speed value V(t₂)=VT2 may be established in dependence of
the angular distance delta-FI between the second positional signal P2 and a third positional signal P3, and in dependence of
the corresponding duration delta-T2-3=tp3-tp2.

The speed value attained by dividing the angular distance delta-FI by the corresponding duration (tₚ₃₋ₜₚ₂) represents the speed V(t₂) of the rotational tool 20 at the 2:nd mid time point t₂(2:nd mtp), as illustrated in FIG. 13.

Thereafter, momentary speed values for time values between the first first mid time point and the 2:nd mid time point may be established by interpolation between the first momentary speed value VT1 and the second momentary speed value VT2, as illustrated by the curve f_{ROTint}.

Mathematically, this may be expressed by the following equation:

$$V ( t 12 ) = V ( t 1 ) + a * ( t 12 - t 1 )$$

Hence, if the speed of the tool 20 can be detected at two points of time (t₁ and t₂), and the acceleration a is constant, then the momentary speed at any point of time can be calculated. In particular, the speed V(t12) of the tool at time t12, being a point in time after t₁ and before t₂, can be calculated by

$$V ( t 12 ) = V ( {t}_{1} ) + a * ( t 12 - {t}_{1} )$$

wherein
a is the acceleration, and
t₁ is the first mid time point t₁(See FIG. 13).

The establishing of a speed value as described above, as well as the compensatory decimation as described with reference to FIGS. 20, 21, and 22, may be attained by performing the corresponding method steps, and this may be achieved by means of a computer program 94 stored in memory 60, as described above. The computer program may be executed by a DSP 50. Alternatively the computer program may be executed by a Field Programmable Gate Array circuit (FPGA).

The establishing of a speed value f_{ROT}(i) as described above may be performed by the analysis apparatus 150 when a processor 350 executes the corresponding program code 380, 394, 410 as discussed in conjunction with FIG. 4 above. The data processor 350 may include a central processing unit 350 for controlling the operation of the analysis apparatus 14. Alternatively, the processor 50 may include a Digital Signal Processor (DSP) 350. According to another example the processor 350 includes a Field programmable Gate Array circuit (FPGA). The operation of the Field programmable Gate Array circuit (FPGA), may be controlled by a central processing unit 350 which may include a Digital Signal Processor (DSP) 350.

Identification of Data Relating to Tool Edge State in a Machine 10 Including a Tool 20 for Shearing and/or Shaping a Raw Material Workpiece 30.

The tool 20 has an tool edge attachment device 22, the tool edge attachment device 22 including a number of tool edges 310, that may be configured to engage the raw material workpiece 30 as the tool rotates about the axis 60 (See e.g. FIG. 2). The number of tool edges 310 provided on the tool edge attachment device 22 is herein termed with the variable L. Whereas FIG. 2 illustrates a case when there are twelve tool edges 310, i.e. L=12, the number L of tool edges 310 may be higher or lower. According to some embodiments the number L of tool edges 310 may be at least one, i.e. the number L of tool edges 310 may be L=1. According to some embodiments the number L of tool edges 310 may be any number higher than L=1. According to some embodiments the number L of tool edges 310 may be anywhere in the range from L=2 to L=60. According to some embodiments the number L of tool edges 310 may be anywhere in the range from L=2 to L=35.

The number L of tool edges 310 is an important factor in relation to analysis of the vibrations resulting from rotation of the tool 20. The inventor realized that the interaction of a tool edge 310 with the raw material workpiece 30 causes a mechanical vibration V_{IMP}. The inventor also realized that this mechanical vibration V_{IMP}, caused by the interaction of tool edges 310 with the raw material workpiece 30, will be repetitive, i.e. there will be a repetition frequency f_{R}.

Hence, the measurement signal S_{MD}(See e.g. FIG. 5) may include at least one vibration signal signature S_{FIMP} dependent on a vibration movement of the rotationally moving tool 20; wherein said vibration signal signature S_{FIMP} has a repetition frequency f_{R} which depends on the speed of rotation f_{ROT} of the rotationally moving tool 20.

Moreover, the magnitude of the peak amplitude of the vibration signal signature S_{FIMP} appears to depend on the magnitude of the impact force F_{IMP}.

Accordingly, the inventor concluded that a measure of the energy, or of the amplitude, of the vibration signal signature S_{FIMP} appears to be indicative of the magnitude of the impact force F_{IMP}.

The existence of a vibration signal signature S_{FIMP} which is dependent on the vibration movement of the rotationally moving tool 20 may therefore provide, in a tool 20 including several tool edges, information about the identity of an individual tool edge. For example, the position of an individual tool edge, on the tool 20, may be indicated in relation to a reference position value.

The inventor concluded that the repetition frequency f_{R} of the mechanical vibration V_{IMP}, caused by the interaction of tool edges 310 with the raw material 30, depends on the number L of tool edges 310 provided on the tool and on the speed of rotation f_{ROT} of the tool 20. When the monitored tool 20 rotates at a constant rotational speed such a repetition frequency f_{R} may be discussed either in terms of repetition per time unit or in terms of repetition per revolution of the tool being monitored, without distinguishing between the two. However, if the tool 20 rotates at a variable rotational speed it typically causes complications, handling variable rotational speeds is discussed elsewhere in this disclosure, e.g. in connection with FIGS. 20, 21, 22A, 22B, and 22C. In fact, it appears as though even very small variations in rotational speed of the tool may have a large adverse effect on detected signal quality in terms of smearing of detected vibration signals unless compensated for. Hence, a very accurate detection of the rotational speed f_{ROT} of the tool 20 appears to be of high importance.

Moreover, the inventor realized that, not only the amplitude of the mechanical vibration V_{IMP} but also the time of occurrence of the mechanical vibration V_{IMP} may be indicative of data relating to the state of a tool 20 for shearing and/or shaping a raw material workpiece 30. Thus, the measurement signal S_{MD}(See e.g. FIG. 5) may include at least one vibration signal amplitude component S_{FIMP} dependent on a vibration movement of the rotationally moving tool 20;
wherein said vibration signal amplitude component S_{FIMP} has a repetition frequency f_{R} which
depends on the speed of rotation f_{ROT} of the rotationally moving tool 20 and that also depends on the number L of tool edges 310 provided on the tool 20; and
wherein there is a temporal relation between
the occurrence of the repetitive vibration signal amplitude component S_{FIMP} and
the occurrence of a position signal P(i) which has a second repetition frequency f_{P} dependent on the speed of rotation f_{ROT} of the rotationally moving tool 20.

As regards constant rotational speed, the inventor concluded that if the speed of rotation f_{ROT} is constant, the digital measurement signal S_{MD}, comprising a temporal sequence of vibration sample values S(i), has a repetition frequency f_{R}, that depends on the number L of tool edges 310 provided on the tool.

It is to be understood that even though the example in FIG. 2 depicts a tool 20 rotating and repeatedly impacting the raw material workpiece 30 with the tool edges 310 the invention is more generally applicable to any repeating or cyclical interaction between tool edge(s) 310 and a raw material workpiece 30. In some embodiments at least one tool edge 310 is arranged on the tool 20, and the tool 20 is moved in a predetermined path relative to a raw material workpiece 30, whereby said at least one tool edge 310 engages the raw material workpiece 30. In these embodiments each traversal along the predetermined path is a cycle corresponding to one rotation of the tool 20 in FIG. 2, and the corresponding vibrational signals from a plurality of complete movements along said paths may be treated correspondingly to the vibrational signals from a plurality of rotations of the tool 20 in FIG. 2. In some embodiments the tool 20 and tool edge(s) 310 are comprised in a lathe arranged to repeatedly and cyclically perform a predetermined material removal from geometrically similar raw material workpieces 30, in these embodiments the equivalent to one revolution of the tool 20 in FIG. 2 is performing said predetermined material removal from one raw material workpiece 30, and a plurality of tool 20 rotations in FIG. 2 corresponds to cyclically removing material from a plurality of raw material workpieces 30.

It is to be understood that the vibrational analysis of multiple cycles typically is dependent on the engagement between tool edge(s) 310 and raw material workpiece 30 occurring at substantially the same point in the repeating cycles in order to compare/identify impacts between each tool edge 310 and the raw material workpiece 30 during a cycle, or to allow utilizing vibrational data from a plurality of cycles/rotations to evaluate the tool wear state of the tool 20. Typically, performing shearing and/or shaping raw material workpieces 30 in a cyclic manner is desirable and common in industry, thus vibrational analysis of multiple cycles may be compatible with several existing industry processes.

Throughout the description use of the terms “rotation”, “rotational speed” and “rotationally moving tool” for the tool 20 also relate to the above mentioned cyclically repeating interactions between tool edge(s) 310 and raw material workpiece 30. It is to be understood that the expression “rotational position of the tool” and any depictions of values for rotational positions 0°-360° also relate to the general cycle, such as depictions of values for positions along the cycle expressed in 0%-100% distance along the total cycle path, or in 0°-360° mapped to distance along the total cycle path. It is to be understood that for cycles comprising complex tool 20 movements and/or rotations the expression “distance along the total cycle path” may, instead of one euclidean distance, relate to the time to reach a point along the path divided by the total time to finish the cycle for a normal cycle. For example, a cycle starting with a tool 20 engages a raw material workpiece 30 at a first region slowly removing material, then

The status parameter extractor 450 may optionally include a Fast Fourier Transformer (FFT) analyser 510 coupled to receive the digital measurement signal S_{MD}, or a signal dependent on the digital measurement signal S_{MD}(See FIG. 15A). In connection with the analysis of a machine 10 including a tool 20 for shearing and/or shaping a raw material workpiece 30, having a rotating tool 20, it may be interesting to analyse signal frequencies that are higher than the rotation frequency f_{ROT} of the rotating tool 20, such as signal frequencies relating to the impact of each tool edge 310 with the raw material workpiece 30. In this context, the rotation frequency f_{ROT} of the tool 20 may be referred to as “order 1”. If a signal of interest occurs at, say ten times per revolution of the tool, that frequency may be referred to as Order 10, i.e. a repetition frequency f_{R} (measured in Hz) divided by rotational speed f_{ROT}(measured in revolutions per second, rps) equals 10 Hz/rps, i.e. order Oi=f_{R}/f_{ROT}=10 Referring to a maximum order as OMAX, and the total number of frequency bins in the FFT to be used as Bn, the inventor concluded that the following applies according to an example:

$$Oi * {B}_{n} = {N}_{R} * {O}_{MAX} .$$

Conversely, N_{R}=Oi*Bₙ/O_{MAX}, wherein
O_{MAX} is a maximum order; and
Bₙ is the number of bins in the frequency spectrum produced by the FFT, and
Oi is the number L of tool edges 310 in the monitored tool 20.

The above variables O_{MAX}, Bₙ, and Oi, should preferably be set so as to render the variable NR a positive integer. In connection with the above example it is noted that the FFT analyser 510 is configured to receive a reference signal, i.e. a position marker signal value PS, or E_{P}, once per revolution of the rotating tool 20. As mentioned in connection with FIG. 2, a position marker device 180 may be provided such that, when the tool 20 rotates around the axis of rotation 60, the position marker 180 passes by the position sensor 170 once per revolution of the tool 20, thereby causing the position sensor 170 to generate a revolution marker signal value PS, E_{P}.

Incidentally, referring to the above example of FFT analyser settings, the resulting integer number NR may indicate the number of revolutions of the monitored tool 20 during which the digital signal S_{MD} is analysed. According to an example, the above variables O_{MAX}, Bₙ, and Oi, may be set by means of the Human Computer Interface, HCI, 210, 210S(See e.g. FIG. 1 and/or FIG. 5 and/or FIG. 15A).

Consider a case when the digital measurement signal S_{MD} is delivered to an FFT analyser: In such a case, when the FFT analyser 510 is set for ten tool edges, i.e. L=10, and Bₙ=160 frequency bins, and the user is interested in analysing frequencies up to order O_{MAX}=100, then the value for NR becomes NR=Oi*Bₙ/O_{MAX}=10*160/100=16.

Hence, it is desirable to measure during sixteen tool revolutions (NR=16) when Bₙ=160 frequency bins is desired, the number of tool edges is L=10; and the user is interested in analysing frequencies up to order O_{MAX}=100. In connection with settings for an FFT analyser 510, the order value O_{MAX} may indicate a highest frequency to be analyzed in the digital measurement signal S_{MD}.

According to some embodiments, the setting of the FFT analyser should fulfill the following criteria when the FFT analyser is configured to receive a reference signal, i.e. a position marker signal value PS, once per revolution of the rotating tool 20: The integer value Oi is set to equal L, i.e. the number of tool edges 310 in the tool 20, and the settable variables O_{MAX}, and Bₙ are selected such that the mathematical expression Oi*Bₙ/O_{MAX} becomes a positive integer. Differently expressed: When integer value Oi is set to equal L, then settable variables O_{MAX} and Bₙ should be set to integer values so as to render the variable N_{R} a positive integer,
wherein N_{R}=Oi*Bₙ/O_{MAX}

According to an example, the number of bins Bₙ is settable by selecting one value Bₙ from a group of values. The group of selectable values for bin size Bₙ, relating to the frequency resolution of the FFT, may include

$${B}_{n} = 200$$

$${B}_{n} = 400$$

$${B}_{n} = 800$$

$${B}_{n} = 1600$$

$${B}_{n} = 3200$$

### An Example of Constant Speed Phase

As mentioned in connection with step S#30 in FIG. 9, the status parameter extractor 450 may identify a constant speed phase, i.e. a status of constant rotational speed f_{ROT} of the tool 20.

In an example, the tool 20 has six tool edges 310 configured to engage the raw material 30 as the tool rotates about the axis 60, i.e. the number L=6.

The inner diameter of the tool 20 may be e.g. 600 cm, and the speed of rotation may be constant, at e.g. 13,6 revolutions per minute. For the purpose of this example, the sample frequency is such that there are n=7680 samples per revolution at that, rotational speed f_{ROT} of the tool 20.

As mentioned above, the tool 20 is rotatable around the axis of rotation 60, and thus the position sensor 170 may generate a position signal E_{P} for indicating momentary rotational positions of the tool 20. A position marker 180 may be provided on an outer surface of the tool 20 such that, when the tool 20 rotates around the axis of rotation 60, the position marker 180 passes by the position sensor 170 once per revolution of the tool, thereby causing the position signal E_{P} to exhibit a position marker signal value P_{S}. Each such position marker signal value P_{S} is indicative of a stationary position, i.e. a position of the immobile stator.

FIG. 2 illustrates a rotational position of the rotating tool 20 wherein the position marker 180 is located at the same rotational position as the static position sensor 170, and a tool edge 310 has passed through the raw material workpiece 30. The tool edge 310 is followed by an adjacent tool edge 310.

The impact between said adjacent tool edge 310 and the raw material workpiece 30 causes a vibration V_{IMP} which leads to a signal signature event in the vibration signal. Thus, a rotational position may be determined based on the signal signature event indicative of an impact and the number of such signal signature events since the position marker 180 was located at the same rotational position as the static position sensor 170.

When there is one position marker signal value P_{S} per revolution and the rotational speed f_{ROT} is constant, or substantially constant, there will be a constant, or substantially constant, number of vibration sample values S(i) for every revolution of the tool 20. For the purpose of this example, the position signal P(0) is indicative of the vibration sample i=0, as shown in table 2(See below). For the purpose of an example, the position of the position signal P(0) in relation to the tool 20 may not be important, as long as the repetition frequency f_{P} is dependent on the speed of rotation f_{ROT} of the rotationally moving tool 20. Hence, if the position signal E_{P} has one pulse P₅ per revolution of the tool 20, the digital position signal will also have one Position signal value P(i)=1 per revolution, the remaining Position signal values being zero.

TABLE 2

| #01 | | | |
|---|---|---|---|
| Time slot | | | |
| dt | #02 | #03 | #04 |
| i, j | Position P(i) | S(i) | f_{ROT}(i) |
| 0 | 1 | S(0) | const |
| 427 | 0 | S(427) | const |
| 853 | 0 | S(853) | const |
| 1280 | 0 | S(1280) | const |
| 1707 | 0 | S(1707) | const |
| 2133 | 0 | S(2133) | const |
| 2560 | 0 | S(2560) | const |
| 2987 | 0 | S(2987) | const |
| 3413 | 0 | S(3413) | const |
| 3840 | 0 | S(3840) | const |
| 4267 | 0 | S(4267) | const |
| 4693 | 0 | S(4693) | const |
| 5120 | 0 | S(5120) | const |
| 5547 | 0 | S(5547) | const |
| 5973 | 0 | S(5973) | const |
| 6400 | 0 | S(6400) | const |
| 6827 | 0 | S(6827) | const |
| 7253 | 0 | S(7253) | const |
| 7680 | 1 | S(7680) | const |

Thus, at a certain constant speed f_{ROT} there may be n time slots per revolution, as indicated by table 2, and n may be a positive integer. In the example of table 2, n=7680.

Having one position signal P_{S} per revolution, we know that the position signal will be repetitive every n slots since the rotational speed f_{ROT} is constant. Thus, a number of virtual position signals P_{C} may be generated by calculation. In an example, consider that virtual position signals P_{C} are generated. The provision of one virtual position signal P_{C} per tool edge 310 may be used for establishing a temporal relation between
the occurrence of the repetitive vibration signal amplitude component S_{FIMP} and
the occurrence of a position signal P(i) which has a second repetition frequency f_{P} dependent on the speed of rotation f_{ROT} of the rotationally moving tool 20.

Having L equidistant tool edges 310 in the tool 20 and one position signal P_{S} per revolution and a constant speed of rotation f_{ROT} it is possible to generate one virtual position signal P_{C} per tool edge 310, so that the total number of position signals P_{S}, P_{C} are evenly distributed. Each such position marker signal value P_{S} and P_{C} is indicative of a stationary position.

Thus, a position signal P_{S} or P_{C} will occur at every n/L sample value position, as indicated in Table 3, when there are provided n time slots per revolution. In table 3, n=7680, and L=6, and thus there is provided a position signal P_{C} at every 1280 sample, the calculated position signals being indicated as 1C.

Table 3 illustrates the principle of a temporal progression of position signal values P(i) with calculated Positions signal values P(i) being indicated as “1C”.

TABLE 3

| | #01 | | | |
|---|---|---|---|---|
| | Time slot | | | |
| | dt | #02 | #03 | #04 |
| #00 | i (*1000) | Position P(i) | S(i) | f_{ROT}(i) |
| | 0 | 1 | S(0) | const |
| Block I | 427 | 0 | S(427) | const |
| Block I | 853 | 0 | S(853) | const |
| Block I | 1280 | 1C | S(1280) | const |
| Block II | 1707 | 0 | S(1707) | const |
| Block II | 2133 | 0 | S(2133) | const |
| Block II | 2560 | 1C | S(2560) | const |
| Block III | 2987 | 0 | S(2987) | const |
| Block III | 3413 | 0 | S(3413) | const |
| Block III | 3840 | 1C | S(3840) | const |
| Block IV | 4267 | 0 | S(4267) | const |
| Block IV | 4693 | 0 | S(4693) | const |
| Block IV | 5120 | 1C | S(5120) | const |
| Block V | 5547 | 0 | S(5547) | const |
| Block V | 5973 | 0 | S(5973) | const |
| Block V | 6400 | 1C | S(6400) | const |
| Block VI | 6827 | 0 | S(6827) | const |
| Block VI | 7253 | 0 | S(7253) | const |
| Block VI | 7680 | 1 | S(7680) | const |

TABLE 4

| | #01 | | | |
|---|---|---|---|---|
| | Time slot | | | |
| | dt | #02 | #03 | #04 |
| #00 | i, j | Position P(i) | S(i) | f_{ROT}(i) |
| | 0 | 1 | S(0) | const |
| Block I | 40 | 0 | S(40) | const |
| Block I | 80 | 0 | S(80) | const |
| Block I | 120 | 0 | S(120) | const |
| Block I | 160 | 0 | S(160) | const |
| Block I | 200 | 0 | S(200) | const |
| Block I | 240 | 0 | S(240) | const |
| Block I | 280 | 0 | S(280) | const |
| Block I | 320 | 0 | S(320) | const |
| Block I | 360 | 0 | S(360) | const |
| Block I | 400 | 0 | S(400) | const |
| Block I | 440 | 0 | S(440) | const |
| Block I | 480 | 0 | S(480) | const |
| Block I | 520 | 0 | S(520) | const |
| Block I | 560 | 0 | S(560) | const |
| Block I | 600 | 0 | S(600) | const |
| Block I | 640 | 0 | S(640) | const |
| Block I | 680 | 0 | S(680) | const |
| Block I | 720 | 0 | S(720) | const |
| Block I | 760 | 0 | S(760) | const |
| Block I | 800 | 0 | S(800) | const |
| Block I | 840 | 0 | S(840) | const |
| Block I | 880 | 0 | S(880) | const |
| Block I | 920 | 0 | S(920) | const |
| Block I | 960 | 0 | S(960) | const |
| Block I | 1000 | 0 | S(1000) | const |
| Block I | 1040 | 0 | S(1040) | const |
| Block I | 1080 | 0 | S(1080) | const |
| Block I | 1120 | 0 | S(1120) | const |
| Block I | 1160 | 0 | S(1160) | const |
| Block I | 1200 | 0 | S(1200) | const |
| Block I | 1240 | 0 | S(1240) | const |
| Block I | 1280 | 1C | S(1280) | const |

TABLE 5

| | #01 | | | |
|---|---|---|---|---|
| | Time slot | #02 | | |
| | dt | Position | #03 | #04 |
| #00 | i, j | % | S(i) | f_{ROT}(i) |
| | 0 = N₀ | 0% | | const |
| Block I | 40 | 3% | | const |
| Block I | 80 | 6% | | const |
| Block I | 120 | 9% | | const |
| Block I | 160 | 13% | | const |
| Block I | 200 | 16% | | const |
| Block I | 240 | 19% | | const |
| Block I | 280 | 22% | | const |
| Block I | 320 | 25% | | const |
| Block I | 360 | 28% | | const |
| Block I | 400 | 31% | | const |
| Block I | 440 | 34% | | const |
| Block I | 480 | 38% | | const |
| Block I | 520 | 41% | | const |
| Block I | 560 | 44% | | const |
| Block I | 600 | 47% | | const |
| Block I | 640 | 50% | | const |
| Block I | 680 | 53% | | const |
| Block I | 720 | 56% | | const |
| Block I | 760 = N_{P} | 59% | S(760) = Sp | const |
| Block I | 800 | 63% | | const |
| Block I | 840 | 66% | | const |
| Block I | 880 | 69% | | const |
| Block I | 920 | 72% | | const |
| Block I | 960 | 75% | | const |
| Block I | 1000 | 78% | | const |
| Block I | 1040 | 81% | | const |
| Block I | 1080 | 84% | | const |
| Block I | 1120 | 88% | | const |
| Block I | 1160 | 91% | | const |
| Block I | 1200 | 94% | | const |
| Block I | 1240 | 97% | | const |
| Block I | 1280 = N_{B} | 100% | | const |

As mentioned above, the tool 20 is rotatable around the axis of rotation 60, and thus the position sensor 170, if mounted in an immobile manner, may generate a position signal Ep having a sequence of tool position signal values P_{S} for indicating momentary rotational positions of the tool 20. As shown in FIG. 2 a position marker 180 may be provided on an outer surface of the tool 20 such that, when the tool 20 rotates around the axis of rotation 60, the position marker 180 passes by the position sensor 170 during one revolution of the tool 20, thereby causing the position sensor 170 to generate a revolution marker signal value P_{S}. As mentioned above, the position sensor 170 may generate a position signal E_{P} having a sequence of tool position signal values P_{S} for indicating momentary rotational positions of the tool 20 when the tool 20 rotates. With reference to tables 2-4 in this document, such a marker signal value P_{S} is illustrated as “1” in column #2 in tables 2-4.

When the rotating tool is provided with one position marker device 180, the marker signal value P_{S} will be provided once per revolution. The marker signal value P_{S} is illustrated as “1” in column #2 in tables 2-4. Having L equidistant tool edges 310 in the tool and one position signal P per revolution and a constant speed of rotation f_{ROT} it is possible to generate one virtual position signal P_{C} per tool edge 310, so that the total number of position signals P, P_{C} are evenly distributed, as discussed above. Thus, a position signal P or P_{C} will occur at every n/L sample value position, as indicated in Table 3, when there are provided n time slots per revolution. In table 3, n=7680, and L=6, and thus there is provided a position signal P_{C} at every 1280 sample, the calculated position signals being indicated as 1C.

It is believed that the mutually equidistant positions of the tool edges 310 may be of importance when the marker signal value P_{S}, illustrated as “1” in column #2 in tables 2-4, is provided once per revolution and virtual position signal values P_{C} are generated in an evenly distributed manner such that a position signal P or P_{C} will occur at every n/L sample value position, as indicated in Table 3, when there are provided n time slots per revolution in a sequence of tool position signal values for indicating momentary rotational positions of the tool 20. In table 3 an actually detected revolution marker signal value P_{S} is reflected as “1” (see column #2, time slot “0” and time slot “7680” in table 3), and virtual position signal values P_{C} are reflected as “1C” (see column #2, time slot “0” and time slot “7680” in table 3).

This is believed to be of importance for some embodiments of this disclosure since the position markers 180 cause the generation of position reference signal values, and the tool edges 310, when engaging the raw material 30, cause the generation of a signal event, such as e.g. an amplitude peak value, in the vibration signal (See references SEA, SMD, Se(i), S(j), S(q) e.g. in FIGS. 1 and 15A). Moreover, the temporal duration between the occurrence of a position reference signal value and the occurrence of a signal event in the vibration signal, caused by a tool edge 310 engaging the raw material 30 may be indicative of identity of an individual tool edge 310 in a tool 20. It is to be understood that the term “signal event” may relate to a value derived from said the vibration signal and/or a corresponding position value, such as a peak amplitude value divide by an average amplitude value, or a value from a fourier transform, or other established operation, of the vibration signal.

Table 4 is an illustration of the first block, i.e. Block I, having n/L=7680/6=1280 consecutive time slots. It is to be understood that if there is a constant speed phase (See FIG. 9) for the duration of a complete revolution of the tool 20, then each of the blocks I to VI (See table 3) will have the same appearance as Block I being illustrated in table 4.

According to embodiments of this disclosure, with reference to column #03 in table 4, the vibration sample values S(i) are analyzed for detection of a vibration signal signature S_{FIMP}. The vibration signal signature S_{FIMP} may be manifested as a peak amplitude sample value S_{P}. According to an example, with reference to column #03 in table 4, the vibration sample values S(i) are analyzed by a peak value detector for detection of a peak sample value S_{P}. With reference to table 5, the peak value analysis leads to the detection of a highest vibration sample amplitude value S(i). In the illustrated example, the vibration sample amplitude value S(i=760) is detected to hold a highest peak value S_{P}.

Having detected the peak value Sp to be located in time slot 760, a temporal relation between the occurrence of the repetitive vibration signal amplitude component Sp and the occurrence of a position signal P(i) can be established. In table 5 the time slots carrying position signals P(i) are indicated as 0% and 100%, respectively, and all the slots in between may be labelled with their respective locations, as illustrated in column #02 in table 5. As illustrated in the example in col. #02 of table 5, the temporal location of slot number i=760 is at a position 59% of the temporal distance between slot i=0 and slot i=1280. Differently expressed, 760/1280=0,59=59%

Consequently, the inventor concluded that the relation between
the repetitive vibration signal amplitude component S_{FIMP} and
the position signal P(i)

may be used as an indication of the impact force F_{IMP} between a raw material workpiece 30 and corresponding tool edge 310_{I}, 310_{II}, 310_{III}, 310IV, . . . , 310_{L} in the rotating tool 20.

In some examples, a first part of a vibration signal signature S_{FIMP} is detected as being the first occurring part of the signature above a threshold value, and said first part of the signature is detected to be located in a time slot 760, thereby a temporal relation between the occurrence of the repetitive vibration signal amplitude component Sp and the occurrence of a position signal P(i) can be established.

Accordingly, an angular position of an individual tool edge part 310 in the tool 20, expressed as a percentage of the distance between two adjacent position signals (see table 5), can be obtained by:
Counting a total number of samples (N_{B}−N₀=N_{B}−0=N_{B}=1280) from the first reference signal occurrence in sample number N₀=0 to the second reference signal occurrence in sample number N_{B}=1280, and
Counting another number of samples (N_{P}−N₀=N_{P}−0=N_{P}) from the first reference signal occurrence at N₀=0 to the occurrence of the peak amplitude value Sp at sample number N_{P}, and
generating information indicative of a tool wear state of the tool 20 based on said another number N_{P} and said total number N_{B}. The information indicative of a tool wear state relating to the an impact between a tool edge 310 of the rotating tool 20 and a raw material workpieces.

This can be summarized as:

$${R}_{T} ( r ) = {R}_{T} ( 760 ) = ( {N}_{P} - {N}_{0} ) / ( {N}_{B} - {N}_{0} ) = ( 760 - 0 ) / ( 1280 - 0 ) = 0.59 = 59 \%$$

Thus, finding the signature output from the analysis apparatus 150 that corresponds to a tool edge 310 impacting the raw material 30 may be obtained by:
Counting a total number of samples (N_{B}) from the first reference signal occurrence to the second reference signal occurrence, and
Counting another number of samples (N_{P}) from the first reference signal occurrence to the occurrence of the peak amplitude value Sp at sample number N_{P}, and
generating said information indicative of a tool wear state of the tool 20 based on a relation between said sample number N_{P} and said total number of samples i.e. N_{B}.

Since the example tool 20 rotates in a clockwise direction, the most recent peak sample value Sp was generated by the impact of tool edge 310 with the raw material workpiece 30. Thus, the vibration sample amplitude value S(i=760), detected to hold a highest peak value SP,poccurred at a time T_{SP}=dt*(1280−760) before the occurrence of the position signal P(i=1280). Since S=v*t, wherein S=distance, v=a constant speed, and t is time, the temporal relation can be directly translated into a distance.

According to another example, with reference to table 6, the temporal relation between the occurrence of the repetitive vibration signal amplitude component Sp and the occurrence of a position signal P(i) can be regarded as a phase deviation, expressed in degrees.

TABLE 6

| | #01 | | | |
|---|---|---|---|---|
| | Time slot | #02 | | |
| | dt | phase FI | #03 | #04 |
| #00 | i | degrees | S(i) | f_{ROT}(i) |
| | 0 | 0 | | const |
| Block I | 40 | 11.25 | | const |
| Block I | 80 | 22.5 | | const |
| Block I | 120 | 33.75 | | const |
| Block I | 160 | 45 | | const |
| Block I | 200 | 56.25 | | const |
| Block I | 240 | 67.5 | | const |
| Block I | 280 | 78.75 | | const |
| Block I | 320 | 90 | | const |
| Block I | 360 | 101.25 | | const |
| Block I | 400 | 112.5 | | const |
| Block I | 440 | 123.75 | | const |
| Block I | 480 | 135 | | const |
| Block I | 520 | 146.25 | | const |
| Block I | 560 | 157.5 | | const |
| Block I | 600 | 168.75 | | const |
| Block I | 640 | 180 | | const |
| Block I | 680 | 191.25 | | const |
| Block I | 720 | 202.5 | | const |
| Block I | 760 | 213.75 | S(760) = Sp | const |
| Block I | 800 | 225 | | const |
| Block I | 840 | 236.25 | | const |
| Block I | 880 | 247.5 | | const |
| Block I | 920 | 258.75 | | const |
| Block I | 960 | 270 | | const |
| Block I | 1000 | 281.25 | | const |
| Block I | 1040 | 292.5 | | const |
| Block I | 1080 | 303.75 | | const |
| Block I | 1120 | 315 | | const |
| Block I | 1160 | 326.25 | | const |
| Block I | 1200 | 337.5 | | const |
| Block I | 1240 | 348.75 | | const |
| Block I | 1280 | 360 | | const |

In fact, by using the position signal as a reference signal for the digital measurement signal S_{MD}, S(i), S(j), and adjusting the settings of a Fast Fourier Transformer 510 in a certain manner, the Fast Fourier Transformer 510 may be used for extracting the amplitude top value as well as the phase value, as discussed below. Consequently, col. #02 of table 6, can be regarded as indicating the physical location of the raw material workpiece 30 at a position 213.75 degrees of the distance between a first tool edge 310 and a second tool edge 310 when the total distance between the firs tool edge 310 and the second tool edge 310 is regarded as 360 degrees (see FIG. 2 in conjunction with col. #02 of table 6). The physical location of the raw material workpiece 30, when expressed as a part of the distance between two adjacent tool edges 310, may be referred to as a position of the raw material workpiece 30. In other words, this disclosure provides a manner of identifying individual tool edges 310 in a tool 20 for shearing and/or shaping a raw material workpiece. Hence, this disclosure provides a manner of generating information indicative of each tool edge 310, expressed as a part of the angular distance between position signal P(i) occurrences of a rotating tool 20. With reference to FIG. 2 the angular position of the engagement between tool edges 310 and the raw material workpiece 30 may be described by a phase angle FI(r), as discussed below. Moreover, according to embodiments of a signature for each tool edge 310 impacting the raw material workpiece 30 may be presented as a temporal duration. As discussed above, in connection with table 5, since S=v*t, wherein S=distance, v=the speed of a tool edge 310, and t is time, the temporal relation may be directly translated into a distance. In this context it is noted that the speed v of a tool edge 310 depends on the angular velocity f_{ROT} of the tool 20 and of the radial position of the tool edge 310 (See FIG. 2). Furthermore the engagement between tool edges 310 and the raw material workpiece 30 may be described by a magnitude of the vibration for each rotational position of the tool 20, wherein one revolution of the tool 20 is one cycle and wherein values for said magnitude of the vibration for rotational positions may be determined based on a plurality of cycles.

FIG. 15A is a block diagram illustrating an example of a status parameter extractor 450. The example status parameter extractor 450 in FIG. 15A comprises a tool speed detector 500, a speed variation compensatory decimator 470 and a Fast Fourier Transformer 510, FFT. In summary the tool speed detector 500 is configured to determine a rotation frequency f_{ROT} of the tool 20 and output S(j),P(j),f_{ROT}(j); the speed variation compensatory decimator 470 is configured to generate one signal S(q),P(q), f_{ROT} for each predetermined fraction of tool revolution, thereby generating signals at the same orientation of the tool 20 for each revolution irrespective of rotational speed f_{ROT}; and the Fast Fourier Transformer 510 is configured to calculate the amplitudes for at least two orders of the fundamental frequency. Typically, the vibrational amplitude S(q) together with rotational position P(q) that is output from the speed variation compensatory decimator 470 is indicative of the tool wear state X and may be provided as an output from the status parameter extractor 450.

It is to be understood that the status parameter extractor 450 may extract parameters from vibration signals from any repeating cyclical engagement between tool edges 310 and raw material workpiece(s) 30 as long as the position along the cycle can be determined.

In some examples, the output S(q) P(q) of the speed variation compensatory decimator 470 is provided to the FFT 510.

In some examples, the output S(q) P(q) of the speed variation compensatory decimator 470 is provided to the HCI 210.

In some examples, the HCI 210 is arranged to set the number singal sets output per revolution or cycle for the speed variation compensatory decimator 470.

The status parameter extractor 450 of FIG. 15A includes a tool speed detector 500 that receives the digital vibration signal S_{MD}, S(i) and the digital position signal (Pi). The tool speed detector 500 may also be referred to as a tool speed value generator 500. The tool speed detector 500 may generate the three signals S(j), P(j) and f_{ROT}(j) on the basis of the received digital vibration signal S_{MD}, S(i) and the digital position signal (Pi). This may be achieved e.g. in the manner described above in relation to FIGS. 7 to 13. In this connection it is noted that the three signals S(j), P(j) and f_{ROT}(j) may be delivered simultaneously, i.e. they all relate to the same time slot j. In other words, the three signals S(j), P(j) and f_{ROT}(j) may be provided in a synchronized manner. The provision of signals, such as S(j), P(j) and f_{ROT}(j), in a synchronized manner advantageously provides accurate information about temporal relations between signal values of the individual signals. Thus, for example, a speed value f_{ROT}(j) delivered by the tool speed value generator 500 is indicative of a momentary rotational speed of the tool 20 at the time of detection of the amplitude value S(j).

It is noted that the signals S(j) and P(j), delivered by the tool speed value generator 500, are delayed in relation to the signals S(i) and (Pi) received by the tool speed value generator 500. It is also noted that the signals S(j) and P(j) are equally delayed in relation to the signals S(i) and (Pi), thus the temporal relation between the two has been maintained. In other words, the signals S(j) and P(j) are synchronously delayed.

The tool speed detector 500 may deliver a signal indicative of whether the speed of rotation has been constant for a sufficiently long time, in which case the signals S(j) and P(j) may be delivered to a Fast Fourier Transformer 510.

The variables O_{MAX}, Bₙ, and Oi, should preferably be set so as to render the variable N_{R} a positive integer, as discussed above. According to an example, the above variables O_{MAX}, N_{R}, and BN, may be set by means of the Human Computer Interface, HCI, 210, 210S(See e.g. FIG. 1 and/or FIG. 5 and/or FIG. 15A). As mentioned above the resulting integer number N_{R} may indicate the number of revolutions of the monitored tool 20 during which the digital signals S(j) and P(j) are analysed by the FFT 510. Thus, based on the settings of the variables O_{MAX}, N_{R}, and BN, the FFT 510 obtains a measurement data corresponding to a duration of approximately N_{R}/f_{ROT}, and thereafter the FFT 510 may deliver a set of frequency amplitude values, X1(r),X2(r),X3(r) etc for a corresponding set of frequency bins, indicative of the tool wear state X.

The notion “r”, in tool wear state values X1(r),X2(r),X3(r), indicates a point in time. In some examples, X1(r) relates to a tool wear state value corresponding to revolution or cycle number r, or a tool wear state value corresponding to the most recently calculated value at time point r. It is to be noted that there may be a delay in time from the reception of a first pair of input signals S(j), P(j) at the inputs of the FFT 510 until the delivery of a pair of tool wear state values X1(r),X2(r),X3(r) from the FFT 510. A pair of set tool wear state values X1(r),X2(r),X3(r) may be based on a temporal sequence of pairs of input signals S(j), P(j). The duration of the temporal sequence of pairs of input signals S(j), P(j) may include at least two successive position signal values P(j)=1 and the corresponding input signal pairs.

The tool wear state values S_{P}(r) and FI(r) may also be referred to as |C_{L}| and Φ_{L}, respectively, as explained below. As noted above in relation to FIG. 2, the vibration signal S_{EA}, S_{MD}, S(j), S(r) will exhibit a signal signature S_{FIMP} indicative of the impact of a tool edge 310 with the raw material workpiece 30, and when there are L tool edges 310 in the tool 20 (See FIG. 1 in conjunction with FIG. 15 and FIG. 14) then that signal signature S_{FIMP} will be repeated L times per revolution of the tool 20.

For the purpose of conveying an intuitive understanding of some examples of the signal processing it may be helpful to consider the superposition principle and repetitive signals such as sinus signals. A sinus signal may exhibit an amplitude value and a phase value. In very brief summary, the superposition principle, also known as superposition property, states that, for all linear systems, the net response at a given place and time caused by two or more stimuli is the sum of the responses which would have been caused by each stimulus individually. Acoustic waves are a species of such stimuli. Also a vibration signal, such as the vibration signal S_{EA}, S_{MD}, S(j), S(r) including the signal signature S_{FIMP} indicative of the impact of a tool edge with the raw material workpiece 30 is a species of such stimuli. In fact, the vibration signal S_{EA}, S_{MD}, S(j), S(r) including the signal signature S_{FIMP} may be regarded as a sum of sinus signals, each sinus signal exhibiting an amplitude value and a phase value. In this connection, reference is made to the Fourier series (See Equation 1 below):

$$n = ∞ \qquad ( Eq . 1 )$$

$$F ( t ) = \sum {C}_{n} sin ( n ω t + {Φ}_{n} )$$

$$n = 0$$

wherein
n=0 the average value of the signal during a period of time (it may be zero, but need not be zero),
n=1 corresponds to the fundamental frequency of the signal F(t),
n=2 corresponds to the first harmonic partial of the signal F(t)
ω=the angular frequency i.e. (2*1*f_{ROT}),
f_{ROT}=the tool speed of rotation expressed as periods per second,
t=time,
Φₙ=phase angle for the n: th partial, and
   |Cₙ|=magnitude for the n: th partial

It follows from the above Fourier series that a time signal may be regarded as composed of a superposition of a number of sinus signals.

An overtone is any frequency greater than the fundamental frequency of a signal. In the above example, it is noted that the fundamental frequency will be f_{ROT}, i.e. the tool speed of rotation, since the FFT 510 receives a marker signal value P(j)−1 only one time per revolution of the tool 20 (See e.g. FIG. 2).

Using the model of Fourier analysis, the fundamental and the overtones together are called partials. Harmonics, or more precisely, harmonic partials, are partials whose frequencies are numerical integer multiples of the fundamental (including the fundamental, which is 1 times itself).

With reference to FIG. 15A and equation 1 above, the FFT 510 may deliver the amplitude value |Cₙ(r)| for n=L, i.e. |C_{L}(r)|=S_{P}(r). The FFT 510 may also deliver phase angle for the partial (n=L), i.e. ΦL(r)=FI(r).

Now consider an example when a tool rotates at a speed of 10 revolutions per minute (rpm), the tool having ten (10) tool edges 310. A speed of 10 rpm renders one revolution every 6 seconds, i.e. f_{ROT}=0,1667 rev/sec. The tool having ten tool edges (i.e. L=10) and running at a speed of f_{ROT}=0,1667 rev/see renders a repetition frequency f_{R} of 1,667 Hz for the signal relating to the tool edges 310, since the repetition frequency f_{R} is the frequency of order 10. The position signal P(j), P(q) (see FIG. 15A) may be used as a reference signal for the digital measurement signal S(j),S(r). According to some embodiments, when the FFT analyser 510 is configured to receive a reference signal, i.e. the position signal P(j), P(q), once per revolution of the rotating tool 20, then the setting of the FFT analyser should fulfill the following criteria:

The integer value Oi is set to equal L, i.e. the number of tool edges 310 in the tool 20, and
the settable variables O_{MAX}, and Bₙ are selected such that the mathematical expression Oi*Bₙ/O_{MAX} becomes a positive integer. Differently expressed: When integer value Oi is set to equal L, then settable variables O_{MAX} and Bₙ should be set to integer values so as to render the variable N_{R} a positive integer,
wherein N_{R}=Oi*Bₙ/O_{MAX}
   O_{MAX} is a maximum order; and
   Bₙ is the number of bins in the frequency spectrum produced by the FFT, and
   Oi multipled with the fundamental frequency, typically f_{ROT}, is a frequency of interest as it typically represents the frequency of equidistant tool edges 310 impacting raw material 30. Said frequency is expressed as an integer in orders, and wherein f_{ROT} is the frequency of order 1, i.e. the fundamental frequency.

In other words, the speed of rotation f_{ROT} of the tool 20 is the fundamental frequency and L is the number of tool edges 310 in the tool 20.

Using the above setting, i.e. integer value Oi is set to equal L, and with reference to FIG. 15A and equation 1 above, the FFT 510 may deliver the magnitude value |Cₙ| for n=L, i.e. |C_{L}|=S_{P}(r). The FFT 510 for a full rotation or cycle may also deliver phase angle for the partial (n=L), i.e. ΦL=FI(r).

Thus, according to embodiments of this disclosure, when the FFT 510 receives a position reference signal P(j), P(q) once per revolution of the rotating tool 20, then the FFT analyser can be configured to generate a peak magnitude value |C_{L}| for a signal whose repetition frequency f_{R} is the frequency of order L, wherein L is the number of equidistantly positioned tool edges 310 in the rotating tool 20. In some of these embodiments, the FFT analyser can be configured to generate a peak magnitude value for frequency bins corresponding to orders of multiples of L up until O_{MAX}. In some of these embodiments, the FFT analyser can be configured to generate a peak magnitude value for frequency bins corresponding to each integer order value up until O_{MAX}.

With reference to the discussion about equation 1 above in this disclosure, the magnitude of the signal whose repetition frequency f_{R} is the frequency of order L may be termed |Cₙ| for n=L, i.e. C_{L}. Referring to equation 1 and FIG. 15A, the magnitude value |C_{L}| may be delivered as a peak magnitude value indicated as S_{P}(r) in FIG. 15A.

Again with reference to equation 1, above in this disclosure, the phase angle value PL for the signal whose repetition frequency f_{R} is the frequency of order L may be delivered as a temporal indicator value, the temporal indicator value being indicative of a temporal duration T_{D1} between occurrence of an impact force F_{IMP} and occurrence of a rotational reference position of said rotating tool.

Hence, according to embodiments of this disclosure, when the FFT 510 receives a position reference signal P(j), P(q) once per revolution of the rotating tool 20, then the FFT analyser can be configured to generate a phase angle value ΦL for a signal whose repetition frequency fr is the frequency of order L, wherein L is the number of equidistantly positioned tool edges 310 in the rotating tool 20. Assuming the raw material workpiece 30 is brought into contact with the tool 20 in the same way each cycle the phase angle value ΦL is typically expected to remain substantially constant. Furthermore, the relationship between magnitude values for frequency bins corresponding to the fundamental frequency f_{ROT}, the frequency of order L, and the frequencies of orders above L may be indicative of the wear tool state X of the tool 20. Typically, the most relevant orders above L are of L multiplied by an integer, such as order 2L, 3L.

Hence, using the above setting, i.e. integer value Oi being set to equal L, and with reference to FIG. 15A and equation 1 above, the FFT 510 output may be used to determine a magnitude and a phase for each frequency bin.

With reference to FIG. 15A in conjunction with FIG. 1A, the tool wear state values S_{P}(r)=C_{L}| and FI(r)=ΦL may be delivered to the Human Computer Interface (HCI) 210 for providing a visual indication of the analysis result. As mentioned above, the analysis result displayed may include information indicative of a tool wear state X of the shearing process for enabling the operator 230 to control the machine 10 including a tool 20 for shearing and/or shaping a raw material workpiece 30.

It is to be understood that the term “tool wear state value” during a process is not limited to values indicative of the intrinsic properties of the tool 20 and its tool edges 310. For example, the phase angle FI(r)=PL value indicative of a point of impact between the tool 20 and the raw material workpiece 30 during operation may also be used as a tool wear state value to describe the tool wear state X.

FIG. 15B is a block diagram illustrating an example of a status parameter extractor 450. The example status parameter extractor 450 in FIG. 15B comprises a tool speed detector 500, a speed variation compensatory decimator 470, a time synchronous Averager 471 TSA, and a Fast Fourier Transformer 510, FFT. The example status parameter extractor 450 may be the status parameter extractor 450 described in FIG. 15A with the addition of the time synchronous averager, TSA, 471. The TSA 471 is configured to accept the sets of vibration signal S(q) and position signal P(q) output from the speed variation compensatory decimator 470, gather data corresponding to a plurality of revolutions or cycles, and output averaged values corresponding to the same position of the revolution or cycle.

For example, if a speed variation compensatory decimator 470 outputs one hundred sets of signals each revolution and the TSA 471 is configured to average for three revolutions then e.g. the sets of signals numbered 5, 105, 205 all represent the fifth position and would be averaged by the TSA 471 to an output comprising averaged signal sets, P_{TSA} and S_{TSA}. The averaged signal sets, P_{TSA} and S_{TSA} typically are arrays of values with the same number of elements as the number of outputs per revolution provided by the speed variation compensatory decimator 470. For example, if a speed variation compensatory decimator 470 outputs one hundred sets of signals each revolution, then P_{TSA} and S_{TSA} may each comprise 100 elements wherein each elements corresponds to a plurality of vibration signals S(q) and position signals P(q) output from the speed variation compensatory decimator 470 indicative of the same rotational position or position along the path of the cycle.

The combination of tool speed detector 500, speed variation compensatory decimator 470, and time synchronous averager 471 allows for an output from the TSA 471 with vibration values averaged over several revolutions which reduces noise, and the averaged vibration values represent the same position of the tool 20 even when a limited number of position signals occur per revolution. In some examples, the output averaged signal sets, P_{TSA} and S_{TSA} may provide sufficient information for a user to estimate the tool wear state X. In some examples, the FFT 510 may be omitted from the status parameter extractor 450.

In some examples, the output P_{TSA} S_{TSA} of the TSA 471 is provided to the FFT 510.

In some examples, the output P_{TSA} S_{TSA} of the TSA 471 is provided to the HCI 210.

In some examples, the HCI 210 is arranged to set the number of revolutions or cycles the TSA 471 is configured to average.

The current tool wear state X of the machine 10 including a tool 20 for shearing and/or shaping a raw material workpiece 30 may be represented and visualized by one or a combination of tool wear state values such that an operator 230 of the machine system 5 observing said representation may intuitively makes sense of the state of the process and determine if an instruction from the operator 230 is required.

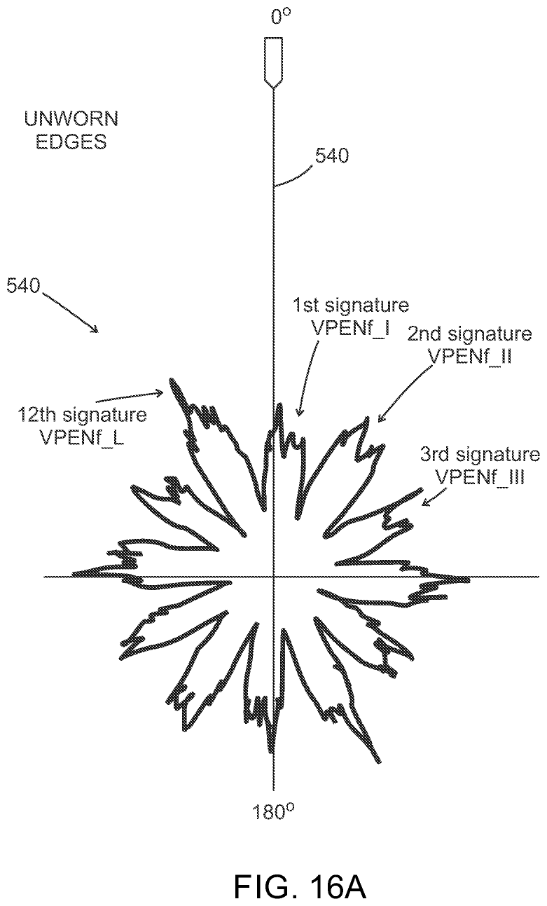

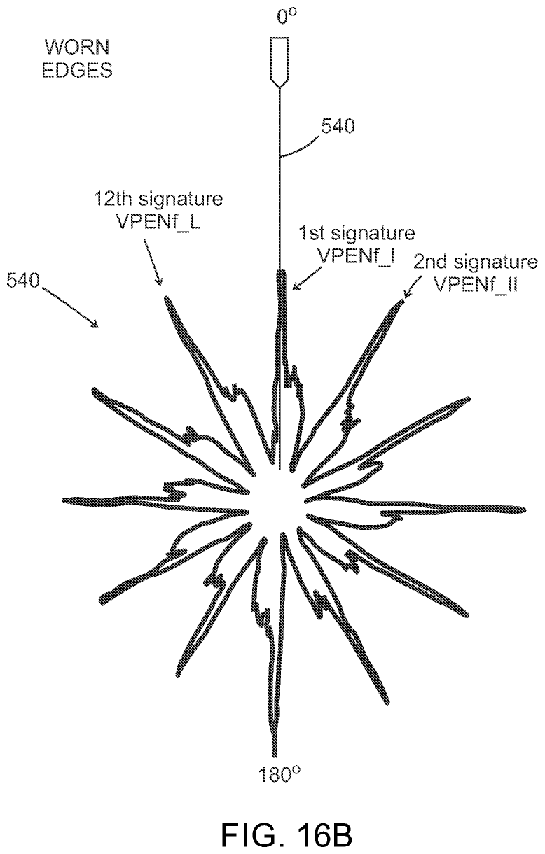

FIGS. 16A and 16B are illustrations of examples of a visual indication of an analysis result from the status parameter extractor 450 representing the vibration signal in the time domain when measuring on a tool 20 having twelve tool edges, i.e. the number of tool edges L=12. According to an example, the visual indication of the analysis result from the TSA 471 may include the provision of a polar coordinate system 520. A polar coordinate system is a two-dimensional coordinate system in which each point on a plane is determined by a distance from a reference point and an angle from a reference direction 540. The reference point (analogous to the origin of a Cartesian coordinate system) is called the pole, and the ray from the pole in the reference direction is the polar axis. The distance from the pole is called the radial coordinate, radial distance or simply radius, and the angle is called the angular coordinate, polar angle, or azimuth.

According to an example utilizing the output from the TSA 471, the averaged vibration amplitude values S_{TSA} are used as the radius, and the averaged cycle position values P_{TSA} are used as the angular coordinates. In some examples, the variation compensatory decimator 470 output values S(q) P(q) may be utilized instead of the averaged values S_{TSA} P_{TSA}. The cycle position value P may be the angular difference between the tool 20 rotational position and the rotational position of the tool 20 when the position marker 180 is aligned with the position sensor 170, as shown in FIG. 2. The cycle position value P for repeating cycles may more generally be expressed as 360 multiplied by a ratio between the distance along the cycle path divided by the total cycle path distance. In FIG. 16A, performing one revolution of the tool 20 corresponds to mapping magnitudes of the vibrational signal starting from 0°, reference direction 540, and rotating clockwise 360° back to the reference direction 540. In this manner the tool wear state X of the monitored machine including a tool 20 for shearing and/or shaping a raw material workpiece 30 may be illustrated as a magnitude pattern with each impact of a tool edge 310 with the raw material workpiece 30 being represented by a magnitude signature in a circular sector corresponding to a set of cycle position values P for the tool 20.

In FIGS. 16A and 16B the number L of tool edges are twelve and the magnitude signatures do not overlap significantly.

FIG. 16A is based on measurement data from a fresh tool 20 having L=twelve relatively sharp tool edges.

FIG. 16B is based on measurement data from a corresponding worn tool 20. In FIG. 16A, the magnitude signatures appear relatively even during each tool edge interaction with the raw material workpiece. In FIG. 16B, the magnitude signatures appear to reveal a significantly higher force during the first part of the magnitude signatures relative to the rest of the interaction, representing when the tool edges first interact with the raw material workpiece. A ratio between the peak magnitude and the average magnitude of a magnitude signature may be used as a tool state value to present to a user and/or to automatically determine if a tool edge 310 or a tool 20 should be replaced.

Hence, an example relates to an tool edge monitoring system 150, 210S for generating and displaying information relating to a shearing process in a machine 10 having a tool 20 that rotates around an axis 60 at a speed of rotation f_{ROT} for shearing raw material 30. The example monitoring system 150 includes:
a computer implemented method of representing a tool wear state of said shearing process in said machine including a tool for shearing and/or shaping a raw material workpiece 30 on a screen display 210S, the method comprising:
displaying on said screen display 210S
   a polar coordinate system 520, said polar coordinate system 520 having
      a reference point (O, 530), and
      a reference direction (0°, 360°, 540); and
   a vibration magnitude indicator object at a radius (S_{TSA}, S(q)) and at a polar angle (P_{TSA}, P(q)) in relation to said reference direction (0°,360°, 540),
said radius (S_{TSA}, S(q)) being indicative of an vibration signal (S(i)) magnitude generated when a tool edge (310) of the rotating tool (20) interacts with raw material (30), and said polar angle(r) being indicative of rotational positions of the tool 20, such as a rotational position or more generally as a position along a path of a cycle.

In some examples, the tool edge monitoring system 150, 210S for generating and displaying information relating to a shearing process in a machine 10 having a tool 20 that rotates around an axis 60 at a speed of rotation f_{ROT} for shearing raw material 30, is arranged to obtain output from a FFT 510 and present on a screen display 210S:
a set of magnitude values, X1(r),X2(r),X3(r) in a corresponding set of frequency bins. In some of these examples, further displaying a numerical relationship between at least two of said magnitude values, wherein said numerical relationship is indicative of the tool wear state X. For example, the relationships between the magnitude value for the frequency bins corresponding to the fundamental frequency f_{ROT}, L*f_{ROT}, and 2*L*f_{ROT}.

As mentioned above, the status parameter extractor 450 may be configured to generate successive pairs of the tool wear state values S_{TSA}, S(q) and P_{TSA}, P(q). The status parameter extractor 450 may also generate time derivative values of the tool wear state values S_{TSA}, S(q) and P_{TSA}, P(q), respectively. This may be done e.g. by subtracting a most recent previous tool wear state value or value thereof derived S(q−1) from the most recent value S(q) divided by the temporal duration between the two values. Thus, derivative values dSp(r) and dFI(r) may be generated. The derivative values, such as dS(q), may be used for indicating changes in tool wear state of the tool 20.

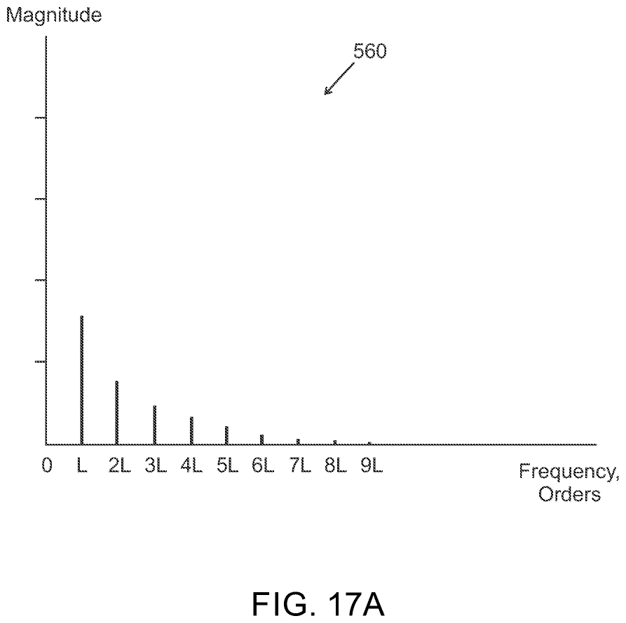

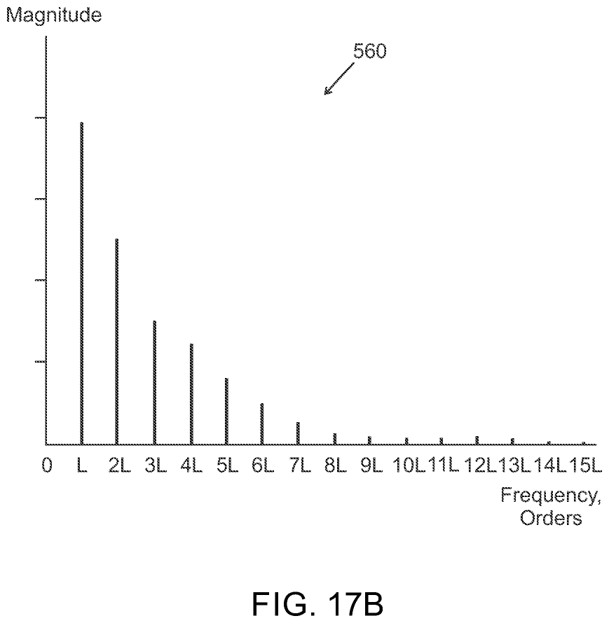

FIGS. 17A and 17B are illustrations of examples of a visual indication of an analysis result from the status parameter extractor 450 relating the vibration signal in the frequency domain.

According to an example, the visual indication of the analysis result from the FFT 510 may include the provision of a vibration frequency magnitude against frequency plot 560. The x-axis of said plots 560 are in frequency and the unit Hz, however, the frequencies are written as orders of the rotational frequency f_{ROT}. L is equal to the number of equidistant tool edges 310 of the tool 20, for this example measurement data L=16. The magnitudes are only shown for orders that are multiples of L, however, by utilizing the technical features of the status parameter extractor 450 the amplitudes for other adjacent orders may be kept significantly smaller than the multiple of L orders.

FIG. 17A represents the FFT output for a measurement using a new and sharp tool 20. FIG. 17B represents the FFT output for a measurement using a worn tool 20. The amplitude for the frequency of order L is more than twice the value for the worn tool 20 compared to the new tool 20. Additional information may be obtained by comparing the subsequent frequencies of orders being multiples of L.

Examples of the status parameter extractor 450 utilizing the output from the TSA 471, the averaged vibration amplitude values S_{TSA} and the averaged cycle position values P_{TSA}, as input for the FFT 510 may allow for more reliable FFT outputs. Said FFT outputs may be compared against more sophisticated criteria, and/or may be more reliably used in further calculations, in order to obtain improved and/or new types of tool wear state values.

An example of variable speed status parameter extractor

As mentioned above, the analysis of the measurements data is further complicated if the tool 20 rotates at a variable rotational speed f_{ROT}. In fact, it appears as though even very small variations in rotational speed of the tool may have a large adverse effect on detected signal quality in terms of smearing. Hence, a very accurate detection of the rotational speed f_{ROT} of the tool 20 appears to be of essence, and an accurate compensation for any speed variations appears to also be of essence.

With reference to FIG. 15A, the tool speed detector 500 may deliver a signal f_{ROT}(j) indicating when the speed of rotation varies, as discussed in connection with FIG. 9. Referring again to FIG. 15A, the signals S(j) and P(j) as well as the speed value f_{ROT}(j) may be delivered to a speed variation compensatory decimator 470. The speed variation compensatory decimator 470 may also be referred to as a fractional decimator. The decimator 470 is configured to decimate the digital measurement signal S_{MD} based on the received speed value f_{ROT}(j). According to an example, the decimator 470 is configured to decimate the digital measurement signal S_{MD} by a variable decimation factor D, the variable decimation factor D being adjusted during a measuring session based on the variable speed value f_{ROT}(j). Hence, the compensatory decimator 470 is configured to generate a decimated digital vibration signal SMDR such that the number of sample values per revolution of said rotating tool is kept at a constant value, or at a substantially constant value, when said rotational speed varies.

According to some embodiments, the number of sample values per revolution of said rotating tool is considered to be a substantially constant value when the number of sample values per revolution varies less than 5%. According to a preferred embodiment, the number of sample values per revolution of said rotating tool is considered to be a substantially constant value when the number of sample values per revolution varies less than 1%. According to a most preferred embodiment, the number of sample values per revolution of said rotating tool is considered to be a substantially constant value when the number of sample values per revolution varies by less than 0.2%.

Thus, the FIG. 15A embodiment includes the fractional decimator 470 for decimating the sampling rate by a decimation factor D=N/UD, wherein both UD and N are positive integers. Hence, the fractional decimator 470 advantageously enables the decimation of the sampling rate by a fractional number. Hence, the speed variation compensatory decimator 470 may operate to decimate the signals S(j) and P(j) and f_{ROT}(j) by a fractional number D=N/U_{D}. According to an embodiment the values for Up and N may be selected to be in the range from 2 to 2000. According to an embodiment the values for Up and N may be selected to be in the range from 500 to 1500. According to yet another embodiment the values for UD and N may be selected to be in the range from 900 to 1100. In this context it is noted that the background of the term “fraction” is as follows: A fraction (from Latin fractus, “broken”) represents a part of a whole or, more generally, any number of equal parts. In positive common fractions, the numerator and denominator are natural numbers. The numerator represents a number of equal parts, and the denominator indicates how many of those parts make up a unit or a whole. A common fraction is a numeral which represents a rational number. That same number can also be represented as a decimal, a percent, or with a negative exponent. For example, 0.01, 1%, and 10-2 are all equal to the fraction 1/100. Hence, the fractional number D=N/UD may be regarded as an inverted fraction.

Thus, the resulting signal SMDR, which is delivered by fractional decimator 470, has a sample rate of

$${f}_{SR} = {f}_{S} / D = {f}_{S} * {U}_{D} / N$$

where f_{S} is the sample rate of the signal S_{RED} received by fractional decimator 470.

The fractional value UD/N is dependent on a rate control signal received on an input port 490. The rate control signal may be a signal indicative of the speed of rotation f_{ROT} of the rotating tool 20.

The variable decimator value D for the decimator may be set to D=f_{S}/f_{SR}, wherein f_{S} is the initial sample rate of the A/D converter, and f_{SR} is a set point value indicating a number of samples per revolution in the decimated digital vibration signal S_{MDR}. For example, when there are twelve (12) tool edges in the tool to be monitored, the set point value f_{SR} may be set to 768 samples per revolution, i.e. the number of samples per revolution is set to f_{SR} in the decimated digital vibration signal S_{MDR}. The compensatory decimator 470 is configured to generate a position signal P(q) at a regular interval of the decimated digital vibration signal S_{MDR}, the regular interval being dependent on the set point value f_{SR}. For example, when f_{SR} is set to 768 samples per revolution, a position signal P(q) may be delivered once with every 768 sample of the decimated vibration signal S(q).

Hence, the sampling frequency f_{SR}, also referred to as f_{SR2}, for the output data values R (q) is lower than input sampling frequency f_{S} by a factor D. The factor D can be set to an arbitrary number larger than 1, and it may be a fractional number, as discussed elsewhere in this disclosure. According to preferred embodiments the factor D is settable to values between 1,0 to 20,0. In a preferred embodiment the factor D is a fractional number settable to a value between about 1,3 and about 3,0. The factor D may be obtained by setting the integers Up and N to suitable values. The factor D equals N divided by UD:

$$D = N / {U}_{D}$$

According to an embodiment, the integers Up and N are settable to large integers in order to enable the factor D=N/U_{D} to follow speed variations with a minimum of inaccuracy. Selection of variables U_{D} and N to be integers larger than 1000 renders an advantageously high accuracy in adapting the output sample frequency to tracking changes in the rotational speed of the tool 20. So, for example, setting N to 500 and Up to 1001 renders D=2,002.

The variable D is set to a suitable value at the beginning of a measurement and that value is associated with a certain speed of rotation of a rotating part to be monitored. Thereafter, during measuring session, the fractional value D is automatically adjusted in response to the speed of rotation of the rotating part to be monitored so that the output signal S_{MDR} provides a substantially constant number of sample values per revolution of the rotating tool.

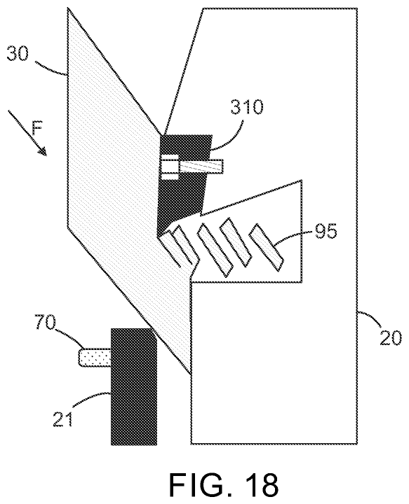

FIG. 18 illustrative an example interaction between tool edge and raw material.

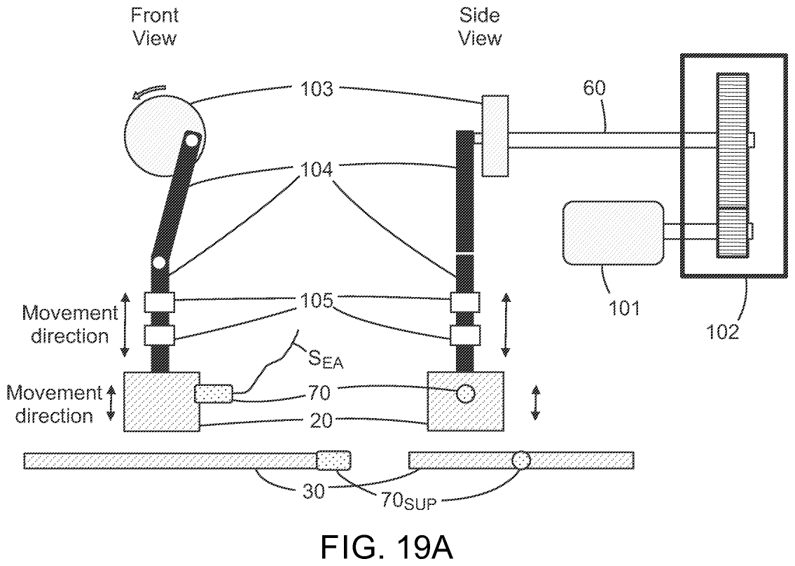

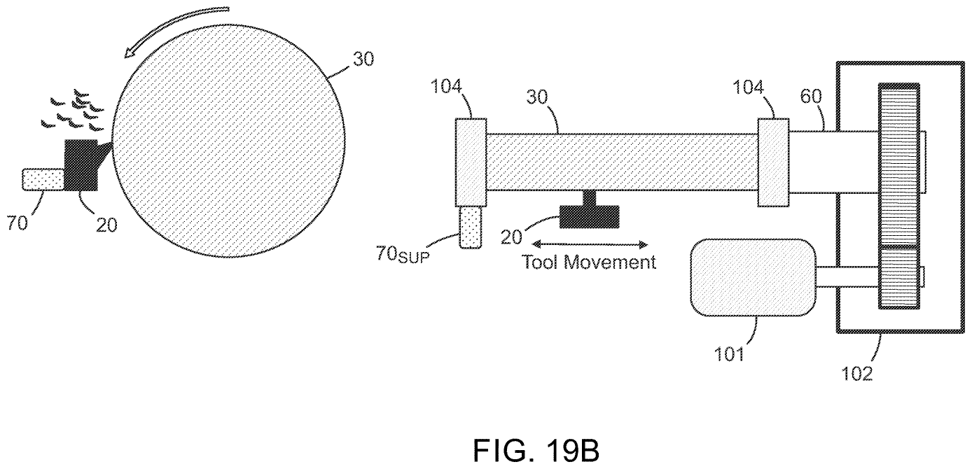

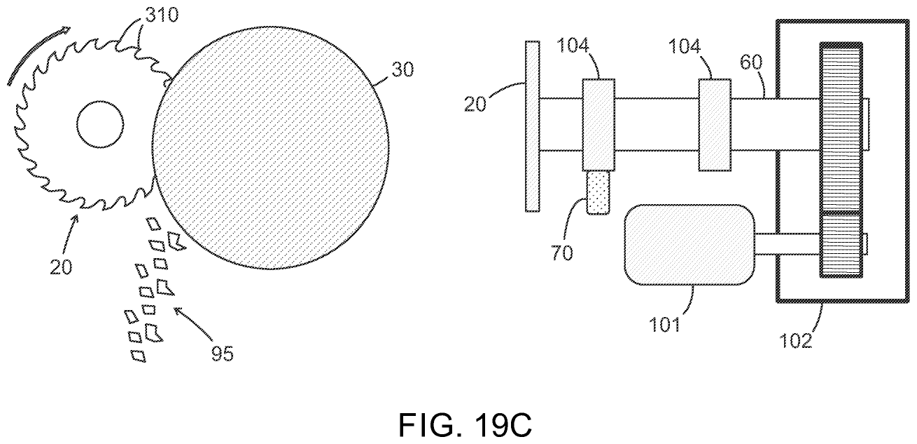

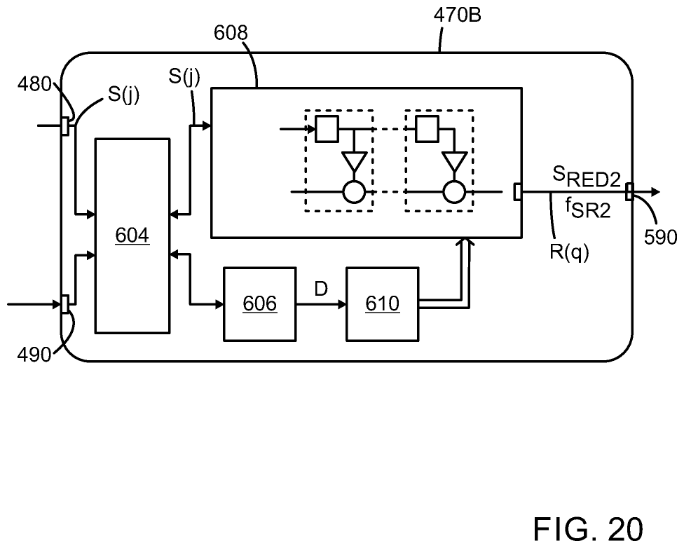

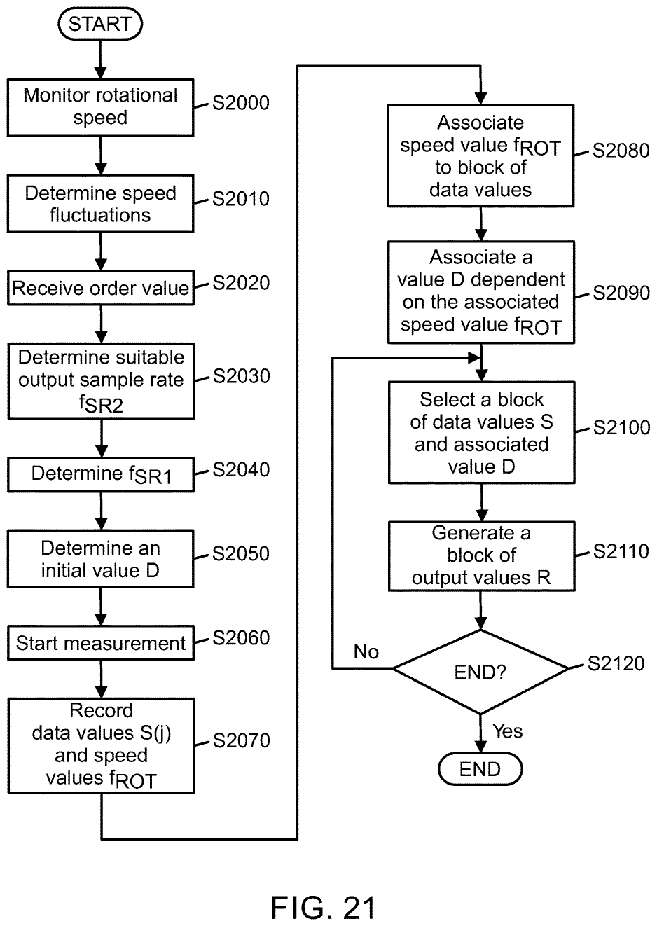

FIGS. 19A, 19B and 19C illustrative examples of different types of machines for shearing and/or shaping a raw material workpiece. FIG. 19A depicts a punch machine. FIG. 19B depicts a lathe. FIG. 19B depicts a machine comprising a rotary saw as a tool 20 for shearing and/or shaping a raw material workpiece.

FIG. 20 is a block diagram of an example of compensatory decimator 470. This compensatory decimator example is denoted 470B.

Compensatory decimator 470B may include a memory 604 adapted to receive and store the data values S(j) as well as information indicative of the corresponding speed of rotation f_{ROT} of the monitored rotating tool. Hence the memory 604 may store each data value S(j) so that it is associated with a value indicative of the speed of rotation f_{ROT}(j) of the monitored tool at time of detection of the sensor signal S_{EA}value corresponding to the data value S(j). The provision of data values S(j) associated with corresponding speed of rotation values f_{ROT}(j) is described with reference to FIGS. 7-13 above.

Compensatory decimator 470B receives the signal S_{MD}, having a sampling frequency f_{SR1}, as a sequence of data values S(j), and it delivers an output signal S_{MDR}, having a reduced sampling frequency f_{SR}, as another sequence of data values R (q) on its output 590.

Compensatory decimator 470B may include a memory 604 adapted to receive and store the data values S(j) as well as information indicative of the corresponding speed of rotation f_{ROT} of the monitored rotating tool. Memory 604 may store data values S(j) in blocks so that each block is associated with a value indicative of a relevant speed of rotation of the monitored tool, as described below in connection with FIG. 21.

Compensatory decimator 470B may also include a compensatory decimation variable generator 606, which is adapted to generate a compensatory value D. The compensatory value D may be a floating number. Hence, the compensatory number can be controlled to a floating number value in response to a received speed value f_{ROT} so that the floating number value is indicative of the speed value f_{ROT} with a certain inaccuracy. When implemented by a suitably programmed DSP, as mentioned above, the inaccuracy of floating number value may depend on the ability of the DSP to generate floating number values.

Moreover, compensatory decimator 470B may also include a FIR filter 608. In this connection, the acronym FIR stands for Finite Impulse Response. The FIR filter 608 is a low pass FIR filter having a certain low pass cut off frequency adapted for decimation by a factor DMAX. The factor DMAX may be set to a suitable value, e.g. 20,000. Moreover, compensatory decimator 470B may also include a filter parameter generator 610.

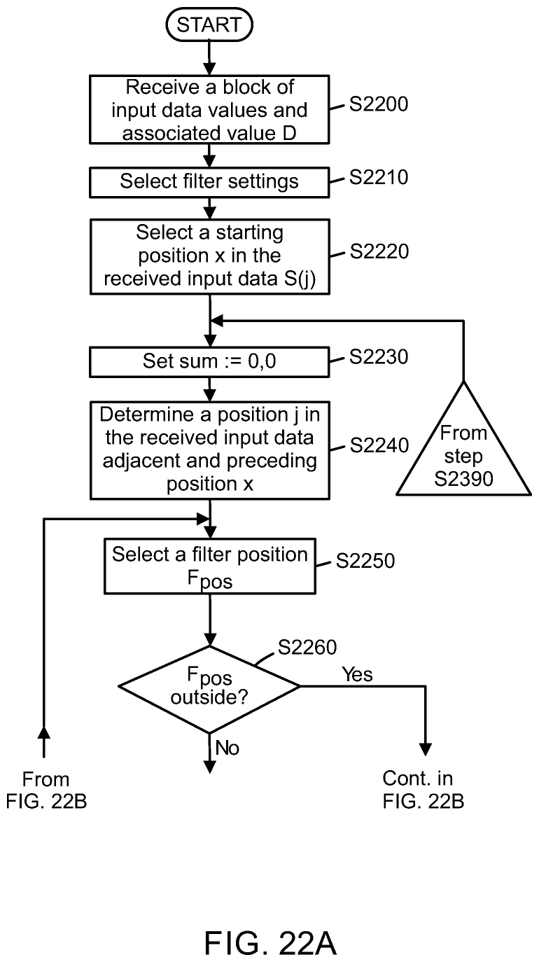

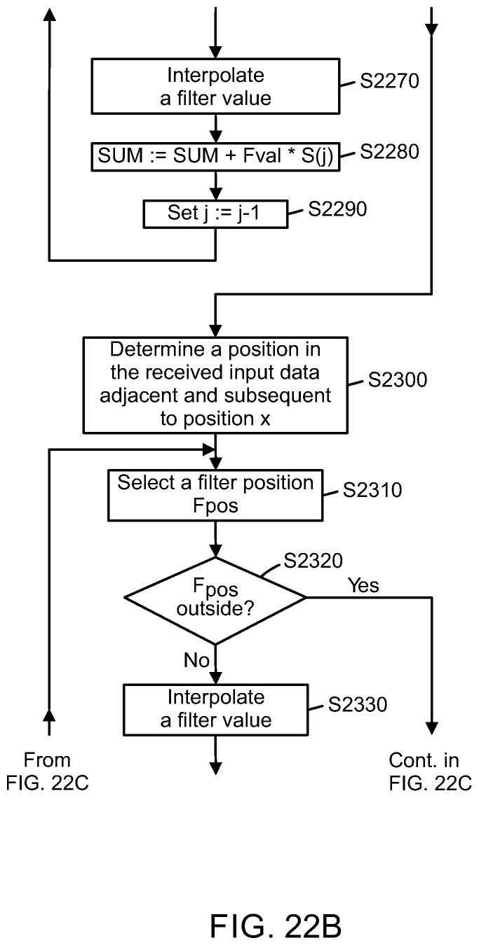

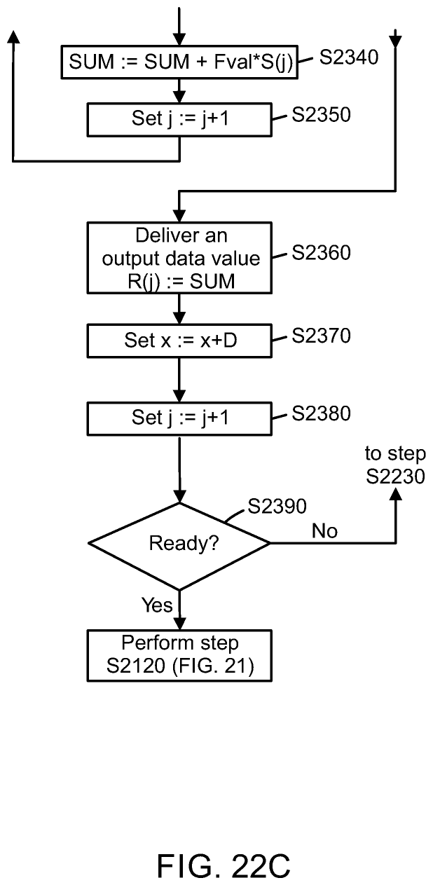

Operation of compensatory decimator 470B is described with reference to FIGS. 21 and 22 below.

FIG. 21 is a flow chart illustrating an embodiment of a method of operating the compensatory decimator 470B of FIG. 20.

In a first step S2000, the speed of rotation f_{ROT} of the tool to be monitored is recorded in memory 604 (FIGS. 20 & 21), and this may be done at substantially the same time as measurement of vibrations begin. According to another example the speed of rotation of the tool to be monitored is surveyed for a period of time. The highest detected speed f_{ROTmax} and the lowest detected speed f_{ROTmin} may be recorded, e.g. in memory 604 (FIGS. 20 & 21).

In step S2010, the recorded speed values are analysed, for the purpose of establishing whether the speed of rotation varies.

In step S2020, the user interface 210, 210S displays the recorded speed value f_{ROT} or speed values fROTmin, f_{ROTmax}, and requests a user to enter a desired order value Oi. As mentioned above, the tool rotation frequency f_{ROT} is often referred to as “order 1”. The interesting signals may occur about ten times per tool revolution (Order 10). Moreover, it may be interesting to analyse overtones of some signals, so it may be interesting to measure up to order 100, or order 500, or even higher. Hence, a user may enter an order number Oi using user interface 210, 210S.

In step S2030, a suitable output sample rate f_{SR} is determined. The output sample rate f_{SR} may also be referred to as f_{SR2} in this disclosure. According to an embodiment output sample rate f_{SR} is set to f_{SR}=C*Oi*f_{ROTmin} wherein
C is a constant having a value higher than 2,0
Oi is a number indicative of the relation between the speed of rotation of the monitored tool and the repetition frequency of the signal to be analysed.
f_{ROTmin} is a lowest speed of rotation of the monitored tool to expected during a forthcoming measurement session. According to an embodiment the value f_{ROTmin} is a lowest speed of rotation detected in step S2020, as described above.

The constant C may be selected to a value of 2,00 (two) or higher in view of the sampling theorem. According to embodiments of the present disclosure the Constant C may be preset to a value between 2,40 and 2,70.

According to an embodiment the factor C is advantageously selected such that 100*C/2 renders an integer. According to an embodiment the factor C may be set to 2,56. Selecting C to 2,56 renders 100*C=256=2 raised to 8.

In step S2050, a compensatory decimation variable value D is determined. When the speed of rotation of the tool to be monitored varies, the compensatory decimation variable value D will vary in dependence on momentary detected speed value.

According to an embodiment, a maximum compensatory decimation variable value D_{MAX} is set to a value of D_{MAX}=f_{ROTmax}/f_{ROTmin}, and a minimum compensatory decimation variable value D_{MIN} is set to 1,0. Thereafter a momentary real time measurement of the actual speed value f_{ROT} is made and a momentary compensatory value D is set accordingly.
f_{ROT} is value indicative of a measured speed of rotation of the rotating tool to be monitored

In step S2060, the actual measurement is started, and a desired total duration of the measurement may be determined. The total duration of the measurement may be determined in dependence on a desired number of revolutions of the monitored tool.

When measurement is started, a digital signal S_{MD} is delivered to input 480 of the compensatory decimator. In the following the signal S_{MD} is discussed in terms of a signal having sample values S(j), where j is an integer.

In step S2070, record data values S(j) in memory 604, and associate each vibration data value S(j) with a speed of rotation value f_{ROT}(j).

In a subsequent step S2080, analyze the recorded speed of rotation values, and divide the recorded data values S(j) into blocks of data dependent on the speed of rotation values. In this manner a number of blocks of block of data values S(j) may be generated, each block of data values S(j) being associated with a speed of rotation value. The speed of rotation value indicates the speed of rotation of the monitored tool, when this particular block data values S(j) was recorded. The individual blocks of data may be of mutually different size, i.e. individual blocks may hold mutually different numbers of data values S(j).

If, for example, the monitored rotating tool first rotated at a first speed f_{ROT1} during a first time period, and it thereafter changed speed to rotate at a second speed f_{ROT2} during a second, shorter, time period, the recorded data values S(j) may be divided into two blocks of data, the first block of data values being associated with the first speed value f_{ROT1}, and the second block of data values being associated with the second speed value f_{ROT2}. In this case the second block of data would contain fewer data values than the first block of data since the second time period was shorter.

According to an embodiment, when all the recorded data values S(j) have been divided into blocks, and all blocks have been associated with a speed of rotation value, then the method proceeds to execute step S2090.

In step S2090, select a first block of data values S(j), and determine a compensatory decimation value D corresponding to the associated speed of rotation value f_{ROT}. Associate this compensatory decimation value D with the first block of data values S(j). According to an embodiment, when all blocks have been associated with a corresponding compensatory decimation value D, then the method proceeds to execute step S2100. Hence, the value of the compensatory decimation value D is adapted in dependence on the speed f_{ROT}.

In step S2100, select a block of data values S(j) and the associated compensatory decimation value D, as described in step S2090 above.

In step S2110, generate a block of output values R in response to the selected block of input values S and the associated compensatory decimation value D. This may be done as described with reference to FIG. 22.

In step S2120, Check if there is any remaining input data values to be processed. If there is another block of input data values to be processed, then repeat step S2100. If there is no remaining block of input data values to be processed then the measurement session is completed.

FIGS. 22A, 22B and 22C illustrate a flow chart of an embodiment of a method of operating the compensatory decimator 470B of FIG. 20.

In a step S2200, receive a block of input data values S(j) and an associated specific compensatory decimation value D. According to an embodiment, the received data is as described in step S2100 for FIG. 21 above. The input data values S(j) in the received block of input data values S are all associated with the specific compensatory decimation value D.

In steps S2210 to S2390 the FIR-filter 608 (See FIG. 20) is adapted for the specific compensatory decimation value D as received in step S2200, and a set of corresponding output signal values R(q) are generated. This is described more specifically below.

In a step S2210, filter settings suitable for the specific compensatory decimation value D are selected. As mentioned in connection with FIG. 20 above, the FIR filter 608 is a low pass FIR filter having a certain low pass cut off frequency adapted for decimation by a factor D_{MAX}. The factor D_{MAX} may be set to a suitable value, e.g. 20.

A filter ratio value FR is set to a value dependent on factor D_{MAX} and the specific compensatory decimation value D as received in step S2200. Step S2210 may be performed by filter parameter generator 610 (FIG. 20).

In a step S2220, select a starting position value x in the received input data block s (j). It is to be noted that the starting position value x does not need to be an integer. The FIR filter 608 has a length F_{LENGTH} and the starting position value x will then be selected in dependence of the filter length F_{LENGTH} and the filter ratio value FR. The filter ratio value FR is as set in step S2210 above. According to an embodiment, the starting position value x may be set to x:=F_{LENGTH}/F_{R}.

In a step S2230 a filter sum value SUM is prepared, and set to an initial value, such as e.g. SUM:=0,0

In a step S2240 a position j in the received input data adjacent and preceding position x is selected. The position j may be selected as the integer portion of x.

In a step S2250 select a position Fₚₒₛ in the FIR filter that corresponds to the selected position j in the received input data. The position Fₚₒₛ may be a compensatory number. The filter position Fₚₒₛ, in relation to the middle position of the filter, may be determined to be

$${F}_{pos} = [ ( x - j ) * {F}_{R} ]$$

wherein F_{R} is the filter ratio value.

In step S2260, check if the determined filter position value Fₚₒₛ is outside of allowable limit values, i.e. points at a position outside of the filter. If that happens, then proceed with step S2300 below. Otherwise proceed with step S2270.

In a step S2270, a filter value is calculated by means of interpolation. It is noted that adjacent filter coefficient values in a FIR low pass filter generally have similar numerical values. Hence, an interpolation value will be advantageously accurate. First an integer position value IFₚₒₛ is calculated:

$${IF}_{pos} := Integer portion of {F}_{pos}$$

The filter value Fᵥₐₗ for the position Fₚₒₛ will be:

$${F}_{val} = A ( {IF}_{pos} ) + [ A ( {IF}_{pos} + 1 ) - A ( {IF}_{pos} ] * [ {F}_{pos} - {IF}_{pos} ]$$

wherein A (IFₚₒₛ) and A (IFₚₒₛ+1) are values in a reference filter, and the filter position Fₚₒₛ is a position between these values.

In a step S2280, calculate an update of the filter sum value SUM in response to signal position j:

$$SUM := SUM + {F}_{val} * S ( j )$$

In a step S2290 move to another signal position:

$$Set j := j - 1$$

Thereafter, go to step S2250.

In a step 2300, a position j in the received input data adjacent and subsequent to position x is selected. This position j may be selected as the integer portion of x. plus 1(one), i.e j: =1+Integer portion of x

In a step S2310 select a position in the FIR filter that corresponds to the selected position j in the received input data. The position Fₚₒₛ may may be a compensatory number. The filter position Fₚₒₛ, in relation to the middle position of the filter, may be determined to be

$${F}_{pos} = [ ( j - x ) * {F}_{R} ]$$

wherein F_{R} is the filter ratio value.

In step S2320, check if the determined filter position value Fₚₒₛ is outside of allowable limit values, i.e. points at a position outside of the filter. If that happens, then proceed with step S2360 below. Otherwise proceed with step S2330.

In a step S2330, a filter value is calculated by means of interpolation. It is noted that adjacent filter coefficient values in a FIR low pass filter generally have similar numerical values. Hence, an interpolation value will be advantageously accurate. First an integer position value IFₚₒₛ is calculated:

$${IF}_{p o s} := Integer portion of {F}_{p o s}$$

The filter value for the position Fₚₒₛ will be:

$${F}_{val} ( {F}_{p o s} ) = A ( {IF}_{p o s} ) + [ A ( {IF}_{p o s} + 1 ) - A ( {IF}_{p o s} ) ] ⋆ [ {F}_{p o s} - {IF}_{p o s} ]$$

wherein A (IFₚₒₛ) and A (IF pos+1) are values in a reference filter, and the filter position Fₚₒₛ is a position between these values.

In a step S2340, calculate an update of the filter sum value SUM in response to signal position j:

$$SUM : = SUM + {F}_{val} ⋆ S ( j )$$

In a step S2350 move to another signal position:

$$Set j : = j + 1$$

Thereafter, go to step S2310.

In a step S2360, deliver an output data value R(j). The output data value R(j) may be delivered to a memory so that consecutive output data values are stored in consecutive memory positions. The numerical value of output data value R(j) is:

$$R ( j ) := SUM$$

In a step S2370, update position value x:

$$x : = x + D$$

In a step S2380, update position value j

$$j : = j + 1$$

In a step S2390, check if desired number of output data values have been generated. If the desired number of output data values have not been generated, then go to step S2230. If the desired number of output data values have been generated, then go to step S2120 in the method described in relation to FIG. 21.

In effect, step S2390 is designed to ensure that a block of output signal values R (q), corresponding to the block of input data values S received in step S2200, is generated, and that when output signal values R corresponding to the input data values S have been generated, then step S2120 in FIG. 21 should be executed.

The method described with reference to FIG. 22 may be implemented as a computer program subroutine, and the steps S2100 and S2110 may be implemented as a main program.

A rotating tool 20 comprising position markers 180 at each tool edge 310 may be used in combination with the status parameter extractors 450 as exemplified in this disclusure. With reference to FIG. 15A, a set-up of the rotating tool 20 with six evenly spaced tool edges 310 and six evenly spaced position markers 180 may be used for generating the marker signal P(i) which is delivered to tool speed value generator 500. Thus, the tool speed value generator 500 will receive a marker signal P(i) having a position indicator signal value every 360/L degrees during a revolution of the tool 20. Thus, the Fast Fourier Transformer 510 will receive a marker signal value P(j)=1, from the speed value generator 500, every 360/L degrees during a revolution of the tool 20 when the rotational speed f_{ROT} is constant. Alernatively, the Fast Fourier Transformer 510 will receive a marker signal value P(q)=1, from the decimator 470, 470B, every 360/L degrees during a revolution of the tool 20 when the rotational speed f_{ROT} varies. The decimator 470, 470B being arranged to output sets of signals based on how far along the path of the cycle the tool 20 has travelled.

Moreover, the speed value generator 500 will be able to generate even more accurate speed values f_{ROT}(j) when it receives a marker signal P(i) having a position indicator signal value, e.g. P(i)=1, every 360/L degrees during a revolution of the tool 20.

As for appropriate settings of the FFT 510 when it receives a marker signal value P(j)=1 every 360/L degrees during a revolution of the tool 20, this means that the fundamental frequency will be the repetition frequency f_{R}.

As noted above in relation to FIG. 2, the vibration signal S_{EA}, S_{MD}, S(j), S(q) will exhibit a signal signature S_{FIMP} indicative of the impact of a tool edge 310 with the raw material workpiece 30, and when there are L tool edges 310 in the tool 20 (See FIG. 2 in conjunction with eq. 2 below) then that signal signature S_{FIMP} will be repeated L times per revolution of the tool 20.

Again, reference is made to the Fourier series (See Equation 2 below):

$$n = ∞ \qquad ( Eq . 2 )$$

$$F ( t ) = \sum {C}_{n} sin ( n ω t + {Φ}_{n} )$$

$$n = 0$$

wherein
n=0 the average value of the signal during a period of time (it may be zero, but need not be zero)
n=1 corresponds to the fundamental frequency of the signal F(t).
n=2 corresponds to the first harmonic partial of the signal F(t).
ω=the angular frequency of interest i.e. (2π*f_{R})
f_{R}=a frequency of interest, expressed as periods per second
t=time
Φₙ=phase angle for the n: th partial
   |Cₙ|=magnitude for the n: th partial

In this embodiment it is noted that the fundamental frequency will be one per tool edge 310 when the FFT 510 receives a marker signal value P(j)=1 every 360/L degrees during a revolution of the tool 20.

As noted above, the settings of the FFT 510 should be done with a consideration of the reference signal. As noted above, the position signal P(j), P(q) (see FIG. 15A) may be used as a reference signal for the digital measurement signal S(j),S(q).

According to some embodiments, when the FFT analyser is configured to receive a reference signal, i.e. the position signal P(j), P(q), once every 360/L degrees during a revolution of the tool 20 and L is the number of tool edges 310 in the tool 20, then the setting of the FFT analyser should fulfill the following criteria:
The integer value Oi is set to unity, i.e. to equal 1, and
the settable variables O_{MAX}, and Bₙ are selected such that the mathematical expression Oi*Bₙ/O_{MAX} becomes a positive integer. Differently expressed: When integer value Oi is set to equal 1, then settable variables O_{MAX} and Bₙ should be set to integer values so as to render the variable N_{R} a positive integer, wherein N_{R}=Oi*Bₙ/O_{MAX}

Using the above setting, i.e. integer value Oi is set to equal unity, and with reference to FIG. 15A and equation 2 above, the FFT 510 may deliver the magnitude value |Cₙ| for n=1, i.e. |C1| =S_{P}(r). The FFT 510 may also deliver phase angle for the fundamental frequency (n=1), i.e. ¢1=FI(r).

With reference to FIG. 15A in conjunction with FIG. 1A and equation 2 above, the tool wear state values S_{P}(r)=|C1| and FI(r)=@1 may be delivered to the Human Computer Interface (HCI) 210 for providing a visual indication of the analysis result. As mentioned above, the analysis result displayed may include information indicative of a tool wear state of the shearing process for enabling the operator 230 to control the machine including a tool for shearing and/or shaping a raw material workpiece. The analysis result displayed may include information indicative of a tool wear state enabling the operator 230 to decide if the tool 20 or parts thereof need replacing.

With reference to FIGS. 16, the example illustrations of visual indications of analysis results are valid for the set-up of the rotating tool 20, whereby the FFT 510 will receive a marker signal P(i), P(j), P(q) having a position indicator signal value every 360/L degrees, wherein L is the number of tool edges 310 in the tool 20.

Whereas the above discussion in relation to settings of the FFT 510 refers to the Fourier series and equations 1 and 2 for the purpose of conveying an intuitive understanding of the background for the settings of an FFT transformer 510, it is noted that the use of digital signal processing may involve the discrete Fourier transform (See Equation 3 below):

$$F ( n ) = {\sum }_{k = 0}^{N - 1} f ( k ) {e}^{- j 2 π nk / N} ( n = 0 … 1 : N - 1 ) \qquad Equation 3$$

Thus, according to embodiments of this disclosure the above discrete Fourier transform (DFT) may be comprised in signal processing for generating data indicative of the tool wear state of a machine including a tool for shearing and/or shaping a raw material workpiece, such as that discussed in connection with embodiments of the status parameter extractor 450. In this connection, reference is made to e.g. FIGS. 3, 4, 5, 15 and/or 24. In view of the above discussion on the subject of FFT and the Fourier series, the discrete Fourier transform will not be discussed in further detail, as the skilled reader of this disclosure is well acquainted with it.

Whereas FIG. 2 illustrates that a number of position markers 180 may be provided on an outer surface of the tool 20, each marker 180 thereby causing the position sensor 170 to generate a revolution marker signal value P_{S}, it is noted that such a position signal may alternatively be generated by an encoder 170 which is mechanically coupled to the rotating tool 20. Thus, the position sensor 170 may be embodied by an encoder 170 which is mechanically coupled to the rotating tool 20 such that the encoder generates e.g. one marker signal P_{S} per tool edge 310 in the rotating tool 20 during rotation of the tool 20.

In summary, as regards appropriate settings of the FFT 510 and the above equations 1 and 2, it is noted that the phase angle for the n: th partial, i.e. Φₙ, may be indicative of the relative position of the raw material workpiece 30. In particular, the phase angle for the n: th partial, i.e. Φₙ, may be indicative of the position of raw material workpiece 30, expressed as a part of the distance between two adjacent tool edges 310 in a rotating tool 20. Typically, during normal operation conditions in many processes the position of raw material workpiece 30 relative to the tool 20 during a cycle is substantially the same every cycle, thus the phase angle remains substantially constant. With reference to table 6 above and FIG. 2, the total distance between two adjacent tool edges may be regarded as 360 degrees, and value of the phase angle for the n: th partial, i.e. Φₙ, divided by 360 may be indicative of a percentage of the total distance between the two adjacent tool edges. This can be seen e.g. by comparing col. #2 in table 5 and table 6 above. As mentioned above, Φₙ=phase angle for the n: th partial, and |Cₙ|=Amplitude for the n:th partial. As discussed above, considering the number L of tool edges 310 in the rotating tool 20 and the number of reference signals being generated and, as a consequence thereof, the order Oi of a signal of interest, the FFT 510 may be set so as to deliver a phase angle for the n:th partial, Φₙ, and an amplitude for the n: th partial, |Cₙ, so that the phase angle for the n:th partial, i.e. Φₙ, may be indicative of the relative position of the raw material workpiece 30. Moreover, as noted above, the FFT 510 may be set so as to render the variable N_{R} a positive integer, wherein

$${N}_{R} = Oi ⋆ {B}_{n} / {O}_{MAX}$$

and wherein
O_{MAX} is a maximum order, having an integer value; and
Bₙ is the number of bins in the frequency spectrum produced by the FFT, and
Oi is the number L of tool edges 310 in the monitored tool 20.

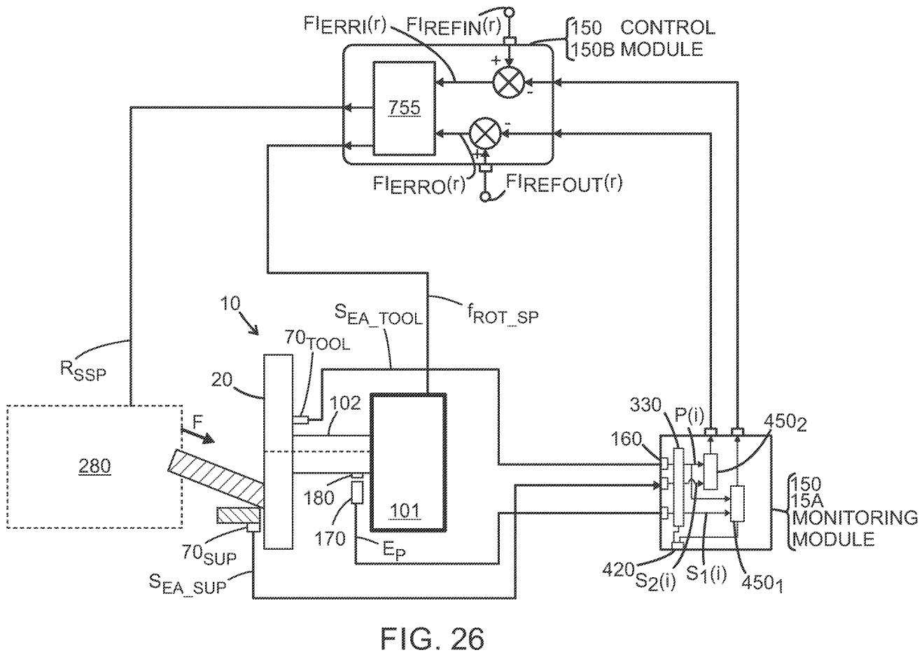

FIG. 26 shows a somewhat diagrammatic and schematic top view of yet another embodiment of a system 730 including a machine 10. Another example machine 10 is a machine 10. The machine 10 includes a tool 20 for shearing a raw material. The machine including a tool for shearing and/or shaping a raw material workpiece system 730 of FIG. 26 may include parts, and be configured, as described in any of the other embodiments described in this disclosure, e.g. in relation to FIGS. 1-25 and/or as described in relation to FIG. 31. In particular, the apparatus 150, shown in FIG. 26 may be configured as described in any of the other embodiments described in this disclosure, e.g. in relation to FIGS. 1-23 and/or as described in relation to FIG. 31.

However, in the embodiment of the system 730 illustrated in FIG. 26, the apparatus 150 includes a monitoring module 150A as well as a control module 150B. Although the drawing illustrates the apparatus 150 as two boxes, it is to be understood that the apparatus 150 may well be provided as a single entity 150 including a monitoring module 150A as well as a control module 150B, as indicated by the unifying reference 150.

The system 730 is configured to control a output material state from a machine10 having a tool 20 that rotates around an axis 60 at a speed of rotation f_{ROT} for shearing a raw material workpiece 30.

The tool 20 may have an tool edge attachment device 22 including a first number L of tool edges 310 configured to engage material as the tool 20 rotates about the axis 60. The system 730 may comprise a device 170, 180 for generating a position signal. The device 170, 180 may incude the position sensor 170 and the marker 180 as described elsewhere in this disclosure. The position signal is E_{P}, P(i), P(j), P(q) indicative of a rotational position of said rotating tool 20, said position signal including a time sequence of position signal sample values P(i), P(j), P(q).

A sensor 70, 70_{SUP}, 70_{TOOL}, 330 is povided and it is configured to generate a vibration signal S_{EA}, S_{MD}, Se(i), S(j), S(q) dependent on mechanical vibrations V_{IMP} emanating from rotation of said tool. The vibration signal S_{EA}, Se(i), S(j), S(q) may include a time sequence of vibration sample values Se(i), S(j), S(q).

The apparatus 150 of the system 730 may comprise a monitoring module 150A and a control module 150B. The monitoring module 150A comprises a status parameter extractor 450, 450₁, 450₂, 450C configured to detect a first occurrence of a first reference position signal value in said time sequence of position signal sample values P(i), P(j), P(q) (See tables 2, 3 and 4 above, wherein column #2 illustrates the position signal having values 1; 1C). The status parameter extractor 450 may be configured to detect a second occurrence of a second reference position signal value 1; 1C; 100% in said time sequence of position signal sample values P(i), P(j), P(q)). The status parameter extractor 450 may also be configured to detect an occurrence of an event signature S_{P}(r); Sₚ in said time sequence of vibration sample values Se(i), S(j), S(q). The event may be caused by the impact of a tool edge 310 into the raw material workpiece 30, causing an impact vibration that may cause a vibration signal signature, as discussed elsewhere in this disclosure. The status parameter extractor 450 may be configured to generate data indicative of a first tool wear state value R_{T}(r); T_{D}; (r), X1(r) between
the event signature occurrence, and
the first and second occurrences.

As mentioned above, the system 730 includes a control module 150B configured to receive data indicative of a tool wear state of the machine 10 from the machine monitoring module 150, 150A. The data indicative of a tool wear state can include any of the information generated or delivered by the status parameter extractor 450, as described in relation to any of the FIGS. 1-31 in this disclosure. With reference to FIG. 26, the control module 150B includes a regulator 755 for controlling an output material state Y(See FIG. 26 in conjunction with FIG. 2) based on
a set of tool wear state limit values X_{LIMIT}, and
determined tool wear state values R_{T}(r); T_{D}; FI(r); X1(r), X2(r), X3(r).

The regulator 755 may be configured to control the raw material feed rate set point R_{SSP} in dependence on difference between the determined tool wear state values and the set of tool wear state limit values. The raw material feed rate R_{S}, discussed in connection with FIG. 1A, depends on the raw material feed rate set point R_{SSP} (See FIG. 26). As mentioned in connection with FIG. 1A, the raw material feed rate R_{S} is an amount of raw material 30 per time unit that is fed into said machine 10 for shearing and/or shaping by said tool 20. In some examples, the raw material feed rate set point R_{SSP} is provided to means for feeding raw material 280 being configured to guide raw material towards the tool 20. In some examples, the means for feeding raw material 280 are comprised in said machine 10. In some examples, the raw material feed rate set point R_{SSP} is provided to the machine 10.

The regulator may also be configured to control a tool rotational speed set point f_{ROT_SP}. In some examples, the tool speed may be set individually for different parts of the repeating cycle. For examples, one tool wear state of a specific tool 20 may benefit from a first speed change for a first type of engagements between tool edges 310 and the raw material workpiece 30, and a second speed change for a second type of engagements occurring in the same cycle. The regulator may also be configured to control a torque set point or a force set point for engagements between tool edges 310 and the raw material workpiece 30.

The event signature may be indicative of an impact force F_{IMP} generated when a tool edge 310 of the rotating tool 20 interacts with the raw material workpiece 30.

The status parameter extractor 450 may be configured to generate said first tool wear state value R_{T}(r); T_{D}; FI(r); X1(r) as a phase angle FI(r).

The first tool wear state value R_{T}(r); T_{D}; FI(r); X1(r) is indicative of tool edges 301 impacting the raw material workpiece 30. The first tool wear state value R_{T}(r); T_{D}; FI(r); X1(r) may be indicative of a proportion of a distance between two adjacent of said tool edges 310 in the tool.

Alternatively, the tool wear state value X1(r) may be indicative of a relative position of the raw material workpiece 30, i.e. the position of the raw material workpiece 30 in relation to two predetermined stator positions separated from each other in a manner corresponding to the positions of two adjacent tool edges 310.

The status parameter extractor 450 may be configured to generate said event signature as an amplitude value S_{P}(r); S_{P}; |C_{L}(r)|; |Cₗ(r)|; X2(r).

The status parameter extractor 450 may comprise a Fourier Transformer 510 (see FIG. 15A) configured to generate said first tool wear state value R_{T}(r); T_{D}; FI(r) X1(r).

As discussed in connection with table 5, the status parameter extractor 450 may be configured to count a total number of samples N_{B} from the first occurrence to the second occurrence. Moreover, the status parameter extractor 450 may be configured to count another number of samples N_{P} from the first occurrence to the occurrence of the event, and said status parameter extractor 450 may be configured to generate said first tool wear state value R_{T}(r); T_{D}; IF(r) X1(r) based on said another number and said total number.

The status parameter extractor 450 may be configured to count a total number of samples N_{B} from the first occurrence to the second occurrence, and the status parameter extractor 450 may be configured to count another number of samples N_{P} from the first occurrence to the occurrence of the event. Moreover, the status parameter extractor 450 may be configured to generate said first tool wear state value R_{T}(r); T_{D}; FI(r) based on a relation between said another number and said total number, wherein said relation between said another number and said total number may be indicative of tool edges 310 engaging a raw material workpiece 30.

The regulator 755 may be configured to include a proportional-integral-derivative controller (PID controller). Alternatively, the regulator 755 may be configured to include a proportional-integral controller (PI controller). Alternatively, the regulator 755 may be configured to include a proportional controller (P controller).

Alternatively, the regulator 755 may be configured to include Kalman filtering, also known as linear quadratic estimation (LQE). Kalman filtering is an algorithm that uses a series of measurements observed over time, including statistical noise and other inaccuracies, and produces estimates of unknown variables that tend to be more accurate than those based on a single measurement alone, by estimating a joint probability distribution over the variables for each timeframe.

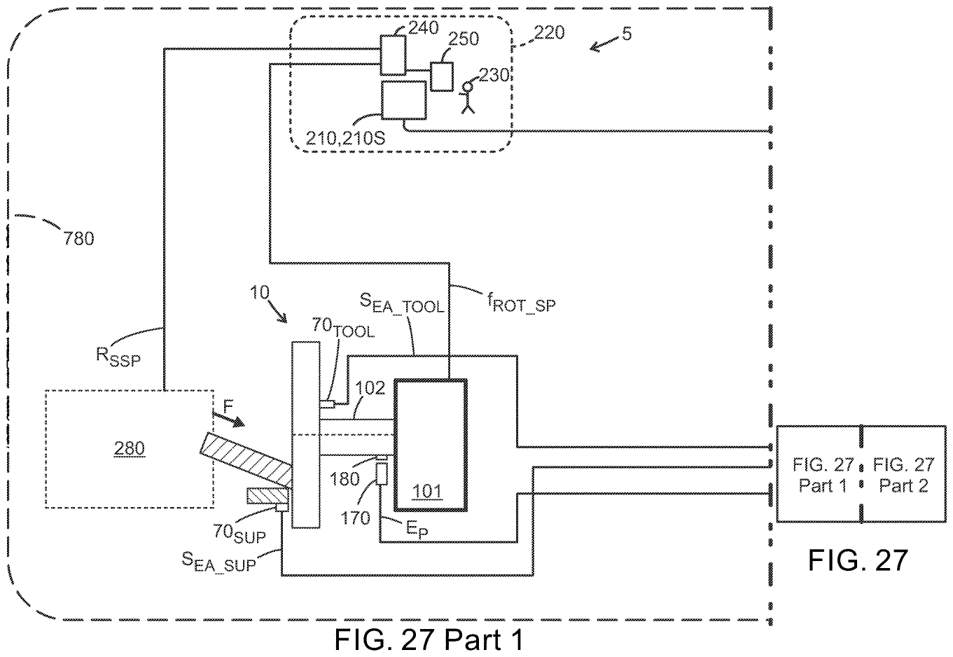

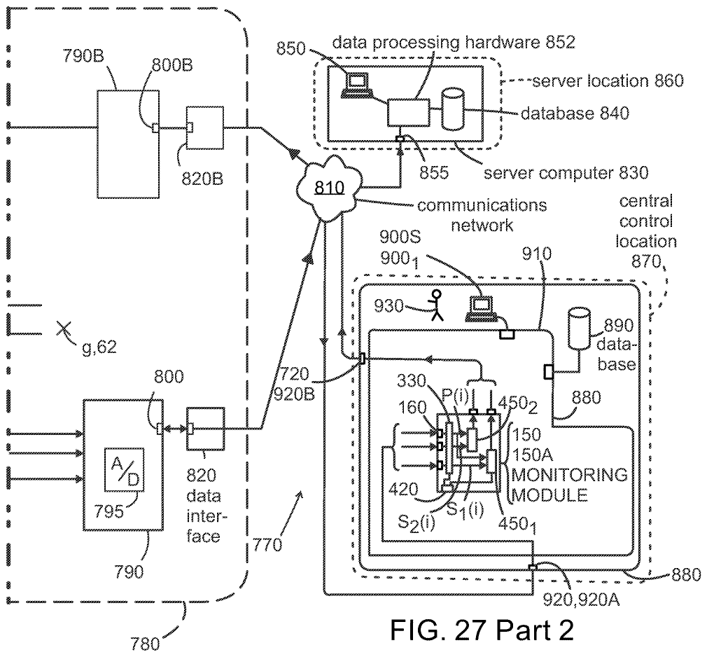

FIG. 27 shows a schematic block diagram of a distributed process monitoring system 770. Reference numeral 780 relates to a client location with a machine 10 having a rotatable tool 20, as discussed above in relation to preceding drawings in this document. The client location 780, which may also be referred to as client part or machine location 780, may for example be the premises of a forestry company, or the premises of an wood processing plant.

The distributed process monitoring system 770 is operative when one sensor 70 is, or several sensors 70 are, attached on or at measuring points related to the tool 20. As mentioned above such measuring points may be e.g. at a bearing 40, 50 (See FIGS. 26 & 27) or at a measuring point position.

The measuring signals S_{EA} S_{EA_SUP}, S_{EA_TOOL}, and E_{P} (See e.g. FIGS. 1, 27, 26, 25) may be coupled to input ports of a machine location communications device 790. S_{EA} SUP relating to a vibration signal from the support, and S_{EA_TOOL} relating to the vibration signal from the tool 20. The machine location communications device 790 may include an Analogue-to-Digital converter 795 for A/D-conversion of the measuring signals S_{EA}, S_{EA_SUP}, S_{EA_TOOL}, and E_{P}. The A/D converter 975 may operate as disclosed in relation to A/D converter 330 elsewhere in this document, e.g. in connection with FIGS. 3 and 5. The machine location communications device 790 has a communication port 800 for bi-directional data exchange. The communication port 800 is connectable to a communications network 810, e.g. via a data interface 820, for enabling delivery of digital data corresponding to the measuring signals S_{EA}. S_{EA_SUP}, S_{EA_TOOL}, and E_{P}. The communications network 810 may be the world wide internet, also known as the Internet. The communications network 810 may also comprise a public switched telephone network.

A server computer 830 is connected to the communications network 810. The server 830 may comprise a database 840, user input/output interfaces 850 and data processing hardware 852, and a communications port 855. The server computer 830 is located on a server location 860, which is geographically separate from the machine location 780. The server location 860 may be in a first city, such as the Swedish capital Stockholm, and the machine location 780 may be on the countryside near a machine, and/or in another country such as for example in Norway, Australia or in the USA. Alternatively, the server location 860 may be in a first part of a county and the machine location 780 may be in another part of the same county. The server location 860 may also be referred to as supplier part 860, or supplier location 860.

According to an example a central control location 870 comprises a monitoring computer 880 having data processing hardware and software for monitoring and/or controlling a tool wear state of a machine 10 at a remote machine location 780. The monitoring computer 880 may also be referred to as a control computer 880. The control computer 880 may comprise a database 890, user input/output interfaces 900 and data processing hardware 910, and a communications port 920, 920A, or several communications ports 920, 920A, 920B. The central control location 870 may be separated from the machine location 780 by a geographic distance. The central control location 870 may be in a first city, such as the Swedish capital Stockholm, and the machine location 780 may be on the countryside near a machine, and/or in another country such as for example in Norway, Australia or in the USA. Alternatively, the central control location 870 may be in a first part of a county and the machine location 780 may be in another part of the same county. By means of communications port 920, 920A the control computer 880 can be coupled to communicate with the machine location communications device 790. Hence, the control computer 880 can receive the measuring signals S_{EA}, S_{EA_SUP}, S_{EA_TOOL}, and E_{P} (See e.g. FIGS. 1, 27, 26, 25) from the machine location communications device 790 via the communications network 810.

The system 770 may be configured to enable the reception of measuring signals S_{EA}, S_{EA_SUP}, S_{EA_TOOL}, and E_{P} in real time, or substantially in real time or enabling real time monitoring and/or real time control of the machine 10 from the location 870. Moreover, the control computer 880 may include a monitoring module 150, 150A as disclosed in any of the examples in this document, e.g. as disclosed in connection with any of the drawings 1-26 above.

A supplier company may occupy the server location 860. The supplier company may sell and deliver apparatuses 150 and/or monitoring modules 150A and/or software for use in an such apparatuses 150 and/or monitoring modules 150A. Hence, supplier company may sell and deliver software for use in the control computer 880 at the central control location 870. Such software 370, 390, 400 is discussed e.g. in connection with FIG. 4. Such software 370, 390, 400 may be delivered by transmission over said communications network 810. Alternatively such software 370, 390, 400 may be delivered as a a computer readable medium 360 for storing program code. Thus the computer program 370, 390, 400 may be provided as an article of manufacture comprising a computer storage medium having a computer program encoded therein.

According to an example embodiment of the system 770 the monitoring computer 880 may substantially continuously receive measurement signals measuring signals S_{EA}, S_{EA_SUP}, S_{EA_TOOL}, and E_{P} (See e.g. FIGS. 1, 27, 26, 25) from the machine location communications device 790, e.g via the communications network 810, so as to enable continuous or substantially continuous monitoring of the tool wear state of the machine 10. The user input/output interfaces 900 at the central control location 870 may comprise a screen 900S for displaying images and data as discussed in connection with HCI 210 elsewhere in this document. Thus, user input/output interfaces 900 may include a display, or screen, 900S, 210S for providing a visual indication of an analysis result. The analysis result displayed may include information indicative of a tool wear state of the shearing process for enabling an operator 930 at the central control location 870 to control the machine 10.

Moreover, the monitoring computer 880 at the central control location 870 may be configured to deliver information indicative of a tool wear state of the shearing process to the HCI 210, via the communications port 920, 920B and via the communications network 810. In this manner, the monitoring computer 880 at the central control location 870 may be configured to enable an operator 230 at the client location 780 to control the machine including a tool for shearing and/or shaping a raw material workpiece.

The local operator 230 at the client location 780 may be placed in the control room 220 (See FIG. 1A and/or FIG. 27). Thus, the client location 780, 220 may include a second machine location communications device 790B. The second machine location communications device 790B has a communication port 800B for bi-directional data exchange, and the communication port 800B is connectable to the communications network 810, e.g. via a data interface 820B.

Although it has, for the purpose of clarity, been described as two location communications devices 790, 790B, there may, alternatively, be provided a single machine location communications device 790, 790B, and/or a single communications port 800, 800B for bi-directional data exchange. Thus, the items 790 and 790B may be integrated as one unit at the machine location 780, and likewise, the items 820 and 820B may be integrated as one unit at the machine location 780.

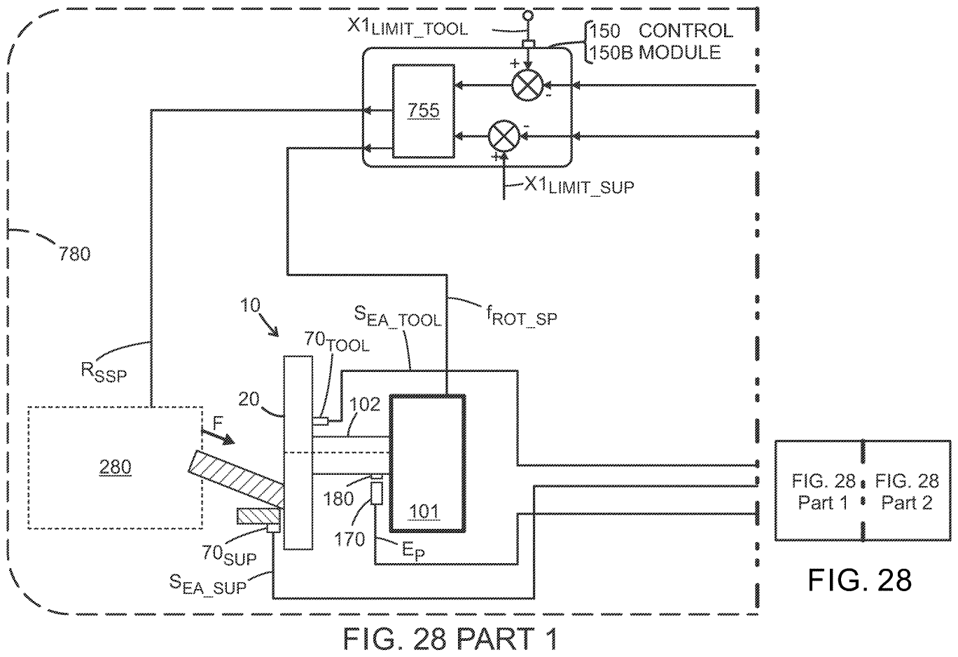

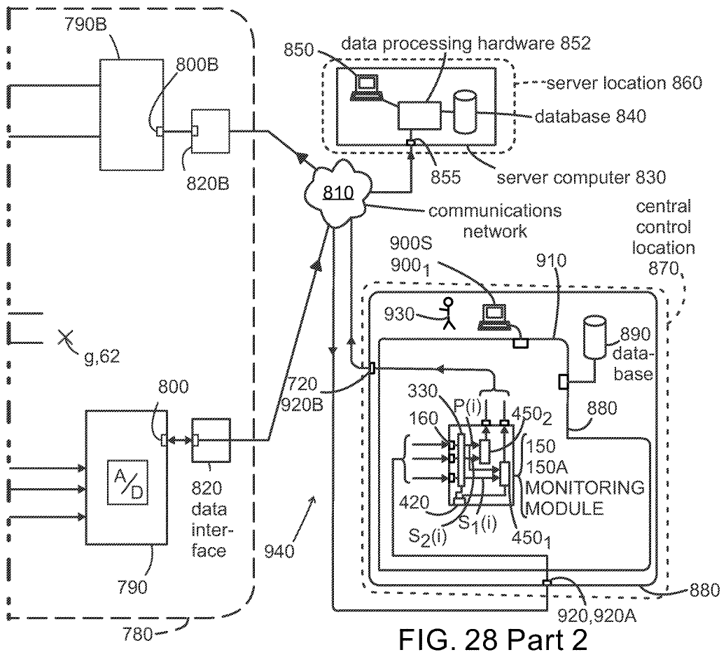

FIG. 28 shows a schematic block diagram of yet another embodiment of a distributed process monitoring system 940. Reference numeral 780 relates to a machine location with a machine 10 having a rotatable tool 20, as discussed above in relation to preceding drawings in this document. The distributed process monitoring system 940 of FIG. 28 may include parts, and be configured, as described in any of the other embodiments described in this disclosure, e.g. in relation to FIGS. 1-31. In particular, the monitoring apparatus 150, also referred to as monitoring module 150A, shown in FIG. 28 may be configured as described in any of the other embodiments described in this disclosure, e.g. in relation to FIGS. 1-31. In particular, the process monitoring system 940 illustrated in FIG. 28, may be configured to include a monitoring module 150A, as disclosed in connection with FIG. 27, but located at the central control location 870.

Moreover, in the process monitoring system 940 illustrated in FIG. 28, the machine location 780 includes a control module 150B, as described above e.g. in connection with FIG. 26.

Thus, the tool wear state of the machine 10 may be automatically controlled by control module 150B located at or near the machine location 780, whereas the monitoring computer 880 at the central control location 870 may be configured to deliver information indicative of a tool wear state of the shearing process to the HCI 900, 900S for enabling an operator 930 at the central control location 870 to monitor the tool wear state of the machine 10.

The measuring signals S_{EA}, S_{EA_SUP}, S_{EA_TOOL}, and E_{P} (See e.g. FIGS. 1, 27, 26, 25) may be coupled to input ports of the machine location communications device 790. The machine location communications device 790 may include an Analogue-to-Digital converter 795 for A/D-conversion of the measuring signals S_{EA}, S_{EA_SUP}, S_{EA_TOOL}, and E_{P}. The A/D converter 975 may operate as disclosed in relation to A/D converter 330 elsewhere in this document, e.g. in connection with FIGS. 3 and 5. The machine location communications device 790 has a communication port 800 for bi-directional data exchange. The communication port 800 is connectable to the communications network 810, e.g. via a data interface 820. The communication port 800 is connectable to a communications network 810, e.g. via a data interface 820, for enabling delivery of digital data corresponding to the measuring signals S_{EA}, S_{EA_SUP}, S_{EA_TOOL}, and E_{P}.

Moreover, the client location 780 may include a second machine location communications device 790B. The second machine location communications device 790B has a communication port 800B for bi-directional data exchange, and the communication port 800B is connectable to the communications network 810, e.g. via a data interface 820B so as to enable reception, by the control module 150B, of data indicative of a tool wear state of the machine 10.

As illustrated in FIG. 28, data indicative of a tool wear state of the machine 10 may be generated by the monitoring module 150A at the central location 870.

Although FIG. 28, for the purpose of clarity, describes two location communications devices 790, 790B, there may, alternatively, be provided a single machine location communications device 790, 790B, and/or a single communications port 800, 800B for bi-directional data exchange. Thus, the items 790 and 790B may be integrated as one unit at the machine location 780, and likewise, the items 820 and 820B may be integrated as one unit at the machine location 780.

As illustrated in FIG. 28, the determined tool wear states values, X1_{SUP} X1_{TOOL} based on the S_{EA_SUP} and S_{EA_TOOL} respectively, may be communicated back to the control module 150B at the client location 780 and become compared with tool wear state limit values X1_{LIMIT_SUP}, X1_{LIMIT_TOOL}. The control module may sent setpoints to the machine 10 based on said comparison.

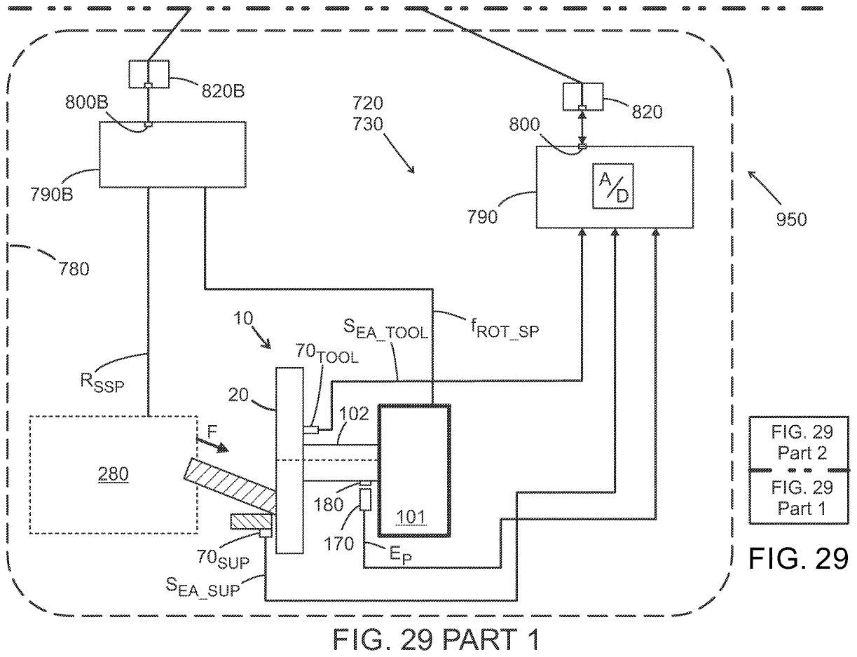

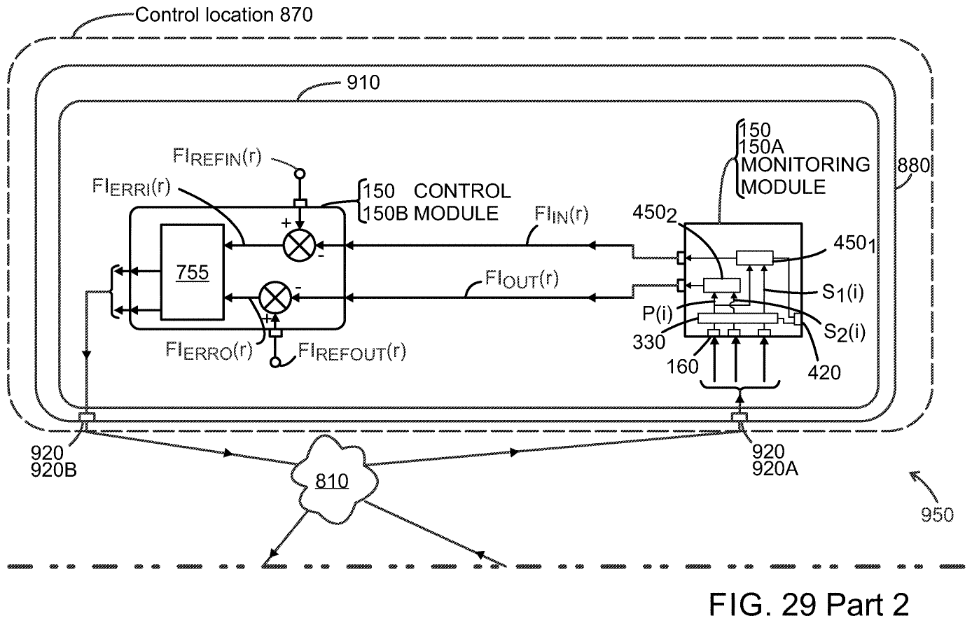

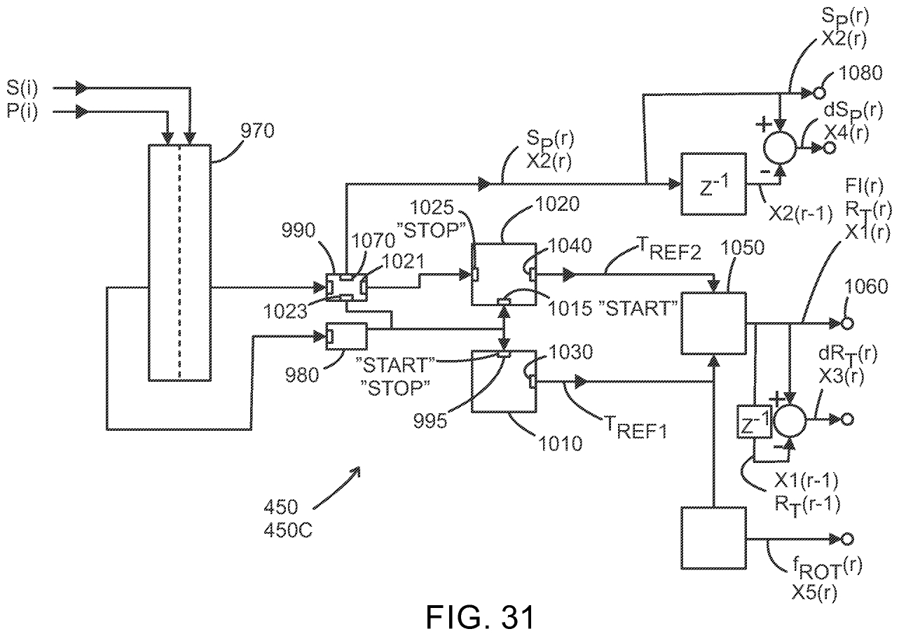

FIG. 29 shows a schematic block diagram of yet another embodiment of a distributed process control system 950. Again, reference numeral 780 relates to a machine location with a machine 10 having a rotatable tool 20, as discussed above in relation to preceding drawings in this document. The distributed process monitoring system 950 of FIG. 29 may include parts, and be configured, as described in any of the other embodiments described in this disclosure, e.g. in relation to FIGS. 1-31. In particular, the monitoring apparatus 150, also referred to as monitoring module 150A, shown in FIGS. 28 and 29 may be configured as described in any of the other embodiments described in this disclosure, e.g. as discussed in relation to FIGS. 1-31. Moreover, the process monitoring system 950 illustrated in FIG. 29, may be configured to include a control module 150B, as described above e.g. in connection with FIG. 26 as well as a monitoring module 150A, as disclosed in connection with FIG. 27.

In the example of FIG. 29, the monitoring module 150A and the control module 150B are provided at the control location 870. The control location 870 may be remote from the machine location 780. Communication of data between the control location 870 and the machine location 780 may be provided via data ports 820 and 920 and the communications network 810, as discussed above in connection with preceding figures.

FIG. 31 is a block diagram that illustrates another example of a status parameter extractor 450, referred to as status parameter extractor 450C. The status parameter extractor 450C may include i.a. a vibration event signature detector and position signal value detector and a relation generator, as discussed below. The vibration event signature detector may be embodied by a peak detector, as discussed below.

According to aspects of the solution disclosed in this document, reference position signal values Ep, 1,1C are generated at L predetermined rotational positions of the rotatable tool 20, the L predetermined rotational positions following a pattern that reflects the angular positions of the L tool edges 310 in the tool 20. The provision of such reference position signal values Ep, 1,1C together with the provision of vibration event signature detection in a manner as herein disclosed, makes it possible to generate data indicative of the tool edges 310 engaging the raw material workpiece 30 in an advantageously accurate manner.

Although it has been exemplified with tool edges 310 that are positioned in an equidistant pattern, i.e. evenly distributed in the tool 20, this solution is also operable with other patterns of angular positions of the L tool edges 310 in the tool 20. When other patterns of angular positions of the L tool edges 310 in the tool is used, it is of importance that the reference position signal values Ep, 1,1C are generated at L predetermined rotational positions of the rotatable tool 20, the L predetermined rotational positions following a pattern that reflects the angular positions of the L tool edges 310 in the tool 20.

With reference to FIG. 5, the A/D converter 330 may be configured to deliver a sequence of pairs of vibration measurement values S(i) associated with corresponding position signal values P(i) to the status parameter extractor 450.

The status parameter extractor 450C, of FIG. 31, is adapted to receive a sequence of measurement values S(i) and a sequence of positional signals P(i), together with temporal relations there-between.

Thus, an individual measurement value S(i) is associated with a corresponding position value P(i). Such a signal pair S(i) and P(i) are delivered to a memory 970. With reference to FIG. 31, the status parameter extractor 450C comprises a memory 970.

The memory 970 may operate to receive data, in the form of a signal pair S(i) and P(i), so as to enable analysis of temporal relations between occurrences of events in the received signals. Columns #2 and #3 in Table 3 provide an illustration of an example of the data collected in the memory 970 during one full revolution of a tool, when a position signal 1, 1C is provided six times per revolution, since there are L=6 tool edges 310 in the tool 20. Table 4 and table 5 provide more detailed information about example signal values in the first 1280 time slots of table 3.

The position signal 1, 1C may be generated by physical marker devices 180 and/or some position signals 1C may be virtual position signals. The time sequence of position signal sample values P(i), P(j), P(q)) should be provided at an occurrence pattern that reflects the angular positions of the tool edges 310 in the tool 20.

For example, when there are six (L=6) equidistant tool edges 310 in the tool 20, the angular distance between any two adjacent tool edges 310 is 60 degrees. This is since 360 degrees is one full revolution and, when L=6, the angular distance between any two adjacent tool edges is 360/L=360/6=60. Accordingly, the corresponding time sequence of position signal sample values P(i), representing a full revolution of the tool 20, should include six (L=6) position signal values 1, 1C with a corresponding occurrence pattern, as illustrated in table 3.

The status parameter extractor 450C further comprises a position signal value detector 980 and vibration event signature detector 990. The vibration event signature detector 990 may be configured to detect a vibration signal event such as an amplitude peak value in the received sequence of measurement values S(i).

The output of the position signal value detector 980 is coupled to a START/STOP input 995 of a reference signal time counter 1010, and to a START input 1015 of an event signature time counter 1020. The output of the position signal value detector 980 may also coupled to a START/STOP input 1023 of vibration event signature detector 990 for indicating the start and the stop of the duration to be analyzed. Detector 990 transmits on its output when a position signal value 1, 1C is detected.

The vibration event signature detector 990 is configured to analyse all the sample values S(i) between two consecutive position signal values 1, 1C for detecting a highest peak amplitude value Sₚ therein. The vibration event signature detector 990 has a first output 1021 which is coupled to a STOP input 1025 of the event signature time counter 1020.

The reference signal time counter 1010 is configured to count the duration between two consecutive position signal values 1, 1C, thereby generating a first reference duration value

TREFI on an output 1030. This may be achieved, e.g. by reference signal time counter 1010 being a clock timer that counts the temporal duration between two consecutive position signal values 1, 1C. The first reference duration value T_{REF1} may in this manner be indicative of the temporal duration between static position signal P4 and static position signal P5. Alternatively, the reference signal time counter 1010 may count the number of time slots (See column #01 in table 3) between two consecutive position signal values 1, 1C.

The event signature time counter 1020 is configured to count the duration from the occurrence of a position signal value 1, 1C to the occurrence of a vibration signal event such as an amplitude peak value. This may be attained in the following manner:
The event signature time counter 1020 starts counting when receiving, on START input 1015, information that position signal value detector 980 detected an occurrence of a position signal value 1, 1C.
The event signature time counter 1020 stops counting when receiving, on STOP input 1025, information that vibration event signature detector 990 detected a vibration signal event such as an amplitude peak value in the received sequence of measurement values S(i).

In this manner, the event signature time counter 1020 may be configured to count the temporal duration from the occurrence of a position signal value 1, 1C to the occurrence of a an amplitude peak value. The temporal duration from the occurrence of a position signal value 1, 1C to the occurrence of a an amplitude peak value is here referred to as a second reference duration value T_{REF2}. The second reference duration value T_{REF2} may be delivered on an output 1040. The second reference duration value T_{REF2} may in this manner be indicative of the temporal duration between the occurrence of static position signal P4 and the occurrence of an amplitude peak value.

With reference to FIG. 31, the output 1040 is coupled to an input of a relation generator 1050 so as to provide the second reference duration value T_{REF2} to the relation generator 1050. The relation generator 1050 also has an input coupled to receive the first reference duration value T_{REF1} from the output 1030 of reference signal time counter 1010. The relation generator 1050 is configured to generate a tool wear state value X1 based on the received second reference duration value T_{REF2} and the received first reference duration value T_{REF1}. The tool wear state value X1 may also be referred to as R_{T}(r); T_{D}; FI(r). The tool wear state value X1 may be generated L times per revolution of the tool 20. Moreover, the L times generated tool wear state value X1 from a single revolution of the tool may be averaged to generate one tool wear state value X1(r) per revolution of the tool 20. In this manner, the status parameter extractor 450C may be configured to deliver an updated tool wear state value X1(r) once per revolution.

For the purpose of clarity, an example of a tool wear state value X1 is generated in the following manner: Please refer to column #03 in table 4 in conjunction with FIG. 31: The vibration sample values S(i) are analyzed, by vibration event signature detector 990, for the detection of a vibration signal signature S_{FIMP}.

The vibration signal signature S_{FIMP} may be manifested as a peak amplitude sample value S_{P}. With reference to table 5, the peak value analysis leads to the detection of a highest vibration sample amplitude value S(i). In the illustrated example, the vibration sample amplitude value S(i=760) is detected to hold a highest peak value S_{P}.

Having detected the peak value Sₚ to be located in time slot 760, X1 may be established. In table 5 the time slots, in a time sequence of position signal sample values P(i), carrying position signal values 1, 1C are indicated as 0% and 100%, respectively.

As illustrated in the example in col. #02 of table 5, the temporal location of slot number i=760 is at a position 59% of the temporal distance between slot i=0 and slot i=1280. Differently expressed, 760/1280=0,59=59%

Accordingly, a position of the raw material workpiece 30, expressed as a percentage of the distance between two adjacent tool edges 310, can be obtained by:

Counting a total number of samples (N_{B}−N₀=N_{B}−0=N_{B}=1280) from the first reference signal occurrence in sample number N₀=0 to the second reference signal occurrence in sample number N_{B}=1280, and

Counting another number of samples (N_{P}−N₀=N_{P}−0=N_{P}) from the first reference signal occurrence at N₀=0 to the occurrence of the peak amplitude value Sₚ at sample number Np, and generating said first tool wear state value (X1, R_{T}(r); T_{D}; FI(r)) based on said another number N_{P} and said total number N_{B}. This can be summarized as:

$${R}_{T} ( r ) = {R}_{T} ( 760 ) = ( {N}_{P} - {N}_{0} ) / ( {N}_{B} - {N}_{0} ) = ( 760 - 0 ) / ( 1280 - 0 ) = 0.59 = 59 \%$$

The relation generator 1050 may generate an update of tool wear state value X1 with a delivery frequency that depends on the rotational speed of the tool 20.

As noted above, the status parameter extractor 450C may be configured to deliver an updated tool wear state value X1(r) once per revolution. In this manner a delivered updated tool wear state value X1(r) may be based on L values generated during one revolution. The latest update, number r, of the first tool wear state value X1(r) may be delivered on a first status parameter extractor output 1060. In some examples, the first tool wear state value X1 is generated based on vibrational signals and positional signals measured from a plurality of revolutions.

With reference to FIG. 31, the vibration event signature detector 990 may be configured to detect a peak amplitude sample value Sp. The vibration event signature detector 990 has an output 1070 for delivering a detected vibration signal amplitude peak value Sp. The detected vibration signal amplitude peak value Sp may be delivered from the output 1070 of vibration signal peak amplitude detector 990 to an output 1080 of status parameter extractor 450C. The output 1080 constitutes a second status parameter extractor output for delivery of a second tool wear state value X2(r), also referred to as Sp(r). The second tool wear state value X2(r) is delivered at the same delivery frequency as the first tool wear state value X1(r).

Moreover, the first tool wear state value X1(r) and the second tool wear state value X2(r) are preferably delivered simultaneously, as a set of tool wear state data (X1(r); X2(r)). In the notation X1(r), the “r” is a sample number indicating a time slot, i.e. increasing number value of “r” indicates temporal progression, in the same manner as the number “i” in column #01 in table 3.

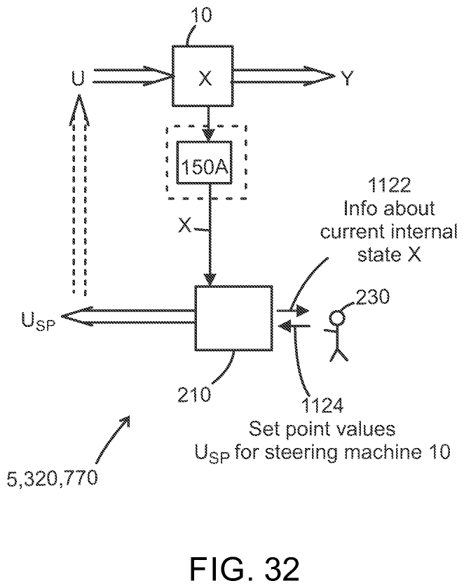

As mentioned elsewhere in this document, the magnitude of the peak amplitude sample value Sp of the vibration signal signature S_{FIMP} appears to depend on the magnitude of the impact force F_{IMP}. The impact force F_{IMP} is indicative of the impact between a tool edge 310 and a raw material workpiece 30, the impact causing the mechanical impact vibration V_{IMP}. FIG. 32 is a block diagram of the system 5, 320, 770 including a machine including a tool for shearing and/or shaping a raw material workpiece illustrated as a box 10 receiving a number of inputs U1, . . . . Uk, and generating a number of outputs Y1, . . . . Yn. With reference to FIG. 32 and FIG. 1C it is noted that, for the purpose of analysis, a machine 10 may be regarded as a black box 10B having a number of input variables, referred to as input parameters U1, U2, U3, . . . . Uk, where the index k is a positive integer. During operation of the machine 10, 10B, the machine including a tool 20 for shearing and/or shaping a raw material workpiece has a tool wear state X, and for the purpose of analysis, the machine 10 may be regarded as the black box 10B having a number of output variables, also referred to as output parameters Y1, Y2, Y3, . . . . Yn, where the index n is a positive integer. The tool wear state X of the tool may be described, or indicated, by a number of tool wear state parameters X1, X2, X3, . . . , Xm, where the index m is a positive integer.

Using the terminology of linear algebra, the input variables U1, U2, U3, . . . . Uk may be collectively referred to as an input vector U. Thus, the dimension of input vector U is k:
Input vector U: Dim (U)=k

Likewise, the tool wear state parameters X1, X2, X3, . . . , Xm may be collectively referred to as a tool wear state vector X.

The dimension of tool wear state vector X is m:
Tool wear state vector X: Dim (X)=m

The output parameters Y1, Y2, Y3, . . . . Yn may be collectively referred to as an output vector Y.

The dimension of output vector Y is n:
Output vector Y: Dim (Y)=n

The tool wear state X of the tool, at a time termed r, can be referred to as X(r). That tool wear state X(r) can be described, or indicated, by a number of tool wear state parameters X1, X2, X3, . . . , Xm, as discussed above. These tool wear state parameters define different aspects of the tool wear state X(r) of the tool 20 at position along the cycle r, or rotational angle of a rotating tool 20.

The tool wear state X(r) of the machine 10 depends on the input vector U(r). An aspect of the tool wear state X is the total amount of material 30 in the tool 20, and that total amount does not change instantly. Thus, during operation of the machine 10, the tool wear state X(r) can be regarded as a function of an earlier tool wear state X(r−1) and of the input U(r):

$$X ( r ) = {f}_{1} ( X ( r - 1 ) , U ( r ) ) , \qquad ( eq . 4 )$$

wherein X(r−1) denotes the tool wear state X of the tool 20 at a point in time preceding the point in time termed r.

The output Y of the machine 10 can be regarded as a function of the tool wear state X. Thus, using the terminology of linear algebra, the output vector Y(r) depends on the tool wear state vector X(r):

$$Y ( r ) = {f}_{2} ( X ( r ) ) \qquad ( eq . 5 )$$

It is an object of an aspect of this document to address the problem of how to maintain the shearing process of the machine 10 at a suitable operating point. Thus, during operation of the the machine 10 it may be desirable to counteract deviations from a suitable operating point. This problem may be addressed by providing a linearized model of the shearing process at an operating point. When regarding the above functions f₁ and f₂, respectively, at operating points near a suitable operating point, the functions may be linear. Accordingly, at a selected operating point, the tool wear state X(r) can be regarded as a function of an earlier tool wear state X(r−1) and of the input U(r) in accordance with a linear model which may be written as follows:

$$X ( r ) = A ⋆ X ( r - 1 ) + B ⋆ U ( r ) , \qquad ( eq . 6 )$$

wherein A and B are coefficient matrices.

In this connection it is noted that in linear algebra, a coefficient matrix is a matrix consisting of the coefficients of the variables in a set of linear equations. As the skilled reader of this document knows, the coefficient matrix is used in solving systems of linear equations. In this connection it is noted that the coefficients in matrices A and B, respectively, may be constants.

Similarly, at a selected operating point, the output vector Y(r) depends on the tool wear state vector X(r) in accordance with a linear model which may be written as follows:

$$Y ( r ) = C ⋆ X ( r ) \qquad ( eq . 7 )$$

wherein C is a coefficient matrix.

However, equation 7 does not mean that a change in the state X must be immediately conveyed into a change of the state Y, since there may, perhaps sometimes, be a delay from the occurrence of a changed tool wear state X to the occurrence of a corresponding change of the state Y(r) of the output material 95. When operating at a steady state, however, there appears to be a causal link between the tool wear state X in the shearing process occurring in the machine 10 at time r and the state Y(r) of the output material 95 at the same time r. Thus Equation 7 is valid, at least when operating the machine 10 at steady state.

Referring to equation 7, the coefficients in matrix C may be constants. The constant values for the coefficients in matrix C may be set to the derivatives C=dY/dX at a selected operating point XOP.

With reference to FIG. 32, the system comprises a monitoring module 150A for generating a tool wear state vector X of dimension m, wherein m is a positive integer. In an example Dim (X) is at least 2. The values in the tool wear state vector X may be generated in a manner as disclosed in relation to any of FIGS. 1A to 31 above.

The Monitoring Module 150A may be adapted to convey 1122 information describing the tool wear state X of the tool during operation of the machine 10, e.g via a user interface 210, as indicated by arrow 1122. Thus, one or several values in the tool wear state vector X may be conveyed to an operator 230 via user interface 210. This advantageously simplifies for the operator 230 of the machine 10 to make suitable adjustments 1124 to set point values (indexed SP) for influencing the input vector U. Thus, by adjusting e.g. the speed set point value U1_{SP} (See FIG. 32 in conjunction with FIG. 1A) the operator 230 can adjust the speed f_{ROT}, U1. In this manner the operator, by adjusting the relevant set point value(s) U_{SP} can adjust the corresponding input variable(s) U1, U2, U3, . . . . Uk.

The set point values U1_{SP}, U2_{SP}, U3_{SP}, . . . . Uk may be collectively referred to as a set point vector U_{SP}. Thus, the dimension of set point vector U_{SP} is k:
set point vector USP: Dim (USP)=k

The system 5,320,770 of FIG. 32 may include a Monitoring Module 150A as described in any of the other embodiments described in this disclosure, e.g. in relation to any of FIGS. 1-31.

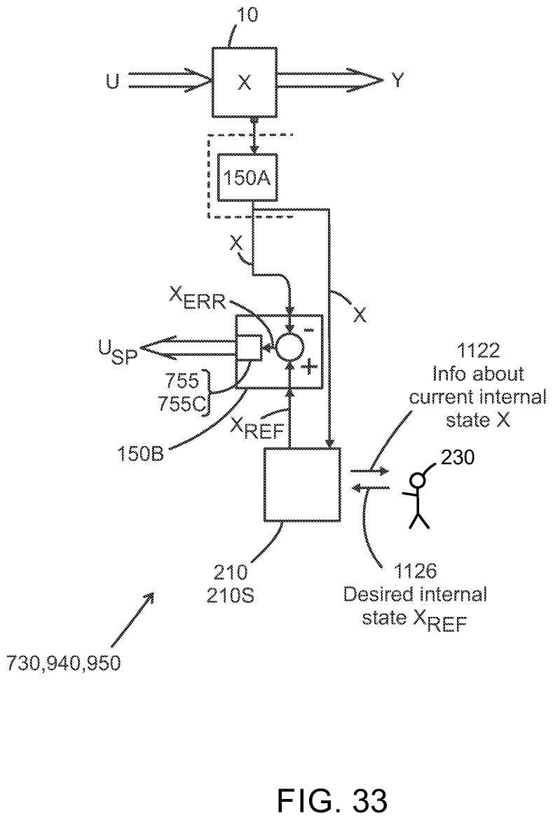

FIG. 33 is a block diagram of another system 730, 940, 950 including a machine including a tool for shearing and/or shaping a raw material workpiece illustrated as a box 10 receiving a number of inputs U1, . . . . Uk, and generating a number of outputs Y1, . . . . Yn. The system 940 of FIG. 33 may include a Monitoring Module 150A as described in any of the other embodiments described in this disclosure, e.g. in relation to any of FIGS. 1-31. Moreover, the system 940 of FIG. 33 may include a control module 150B as described in any of the other embodiments described in this disclosure, e.g. in relation to FIG. 28.

The Monitoring Module 150A of FIG. 33 may be adapted to convey information describing the tool wear state X of the tool during operation of the machine 10, e.g via a user interface 210. Thus, one or several values in the tool wear state vector X may be conveyed 1122 to an operator 230 via user interface 210, as indicated by arrow 1122. This advantageously simplifies for the operator 230 of the machine 10 to make suitable adjustments 1126 to machine set point values U and/or tool wear state limit values X_{LIMIT} (indexed LIMIT) for influencing or comparing the tool wear state X of the tool during operation of the machine 10.

Arrow 1126 indicates user input relating e.g. to a tool wear state limit X_{LIMIT}. The tool wear state limit values X1_{LIMIT}, X2_{LIMIT}, X3_{LIMIT}, . . . , Xm_{LIMIT} may be collectively referred to as a tool wear state limit vector X_{LIMIT}. For example the tool wear state limit vector X_{LIMIT} may for a tool 20 comprising six tool edges 310 comprise one tool edge wear state value for each of the six tool edges 310.

The dimension of tool wear state limit vector X_{LIMIT} is m:
Tool wear state limit vector X_{LIMIT}: Dim (X_{LIMIT})=m

In this manner the operator 230, by adjusting machine set point values U and/or relevant tool wear state limit value(s) X1_{LIMIT}, X2_{LIMIT}, X3_{LIMIT}, . . . , Xm_{LIMIT} can compare the tool wear state X of the tool during operation of the machine 10 with the tool wear state limit X_{LIMIT}. Thus, the user interface 210, in response to user input, may be configured to generate values for the tool wear state limit vector X_{LIMIT}.

The tool wear state limit vector X_{LIMIT} is delivered to a reference input of a Control Module 150B, as illustrated in FIG. 33. Referring to FIG. 33 in conjunction with FIG. 26, the Control Module 150B is a multivariable Control Module that also receives, from the Monitoring Module 150A, the above described tool wear state vector X.

In this connection, the tool wear state vector X may be indicative of a current state of a process in the machine 10, and the tool wear state limit vector X_{LIMIT} is indicative of a threshold for allowable tool wear state for the process. Typically, the tool wear state limit vector X_{LIMIT} relates to a minimum acceptable amount of tool wear as described by one or more tool wear state values, X1_{LIMIT} X2_{LIMIT} etc., or a combination criteria thereof.

The multivariable Control Module 150B may be adapted to generate, based on the received tool wear state limit vector X_{LIMIT} and the received tool wear state vector X, a tool wear state error vector X ERR.

The tool wear state error vector X ERR includes tool wear state error values X1_{ERR}, X2_{ERR}, X3_{ERR}, . . . , Xm_{ERR}

The dimension of tool wear state error vector X ERR is m:
Tool wear state error vector X ERR: Dim (X ERR)=m

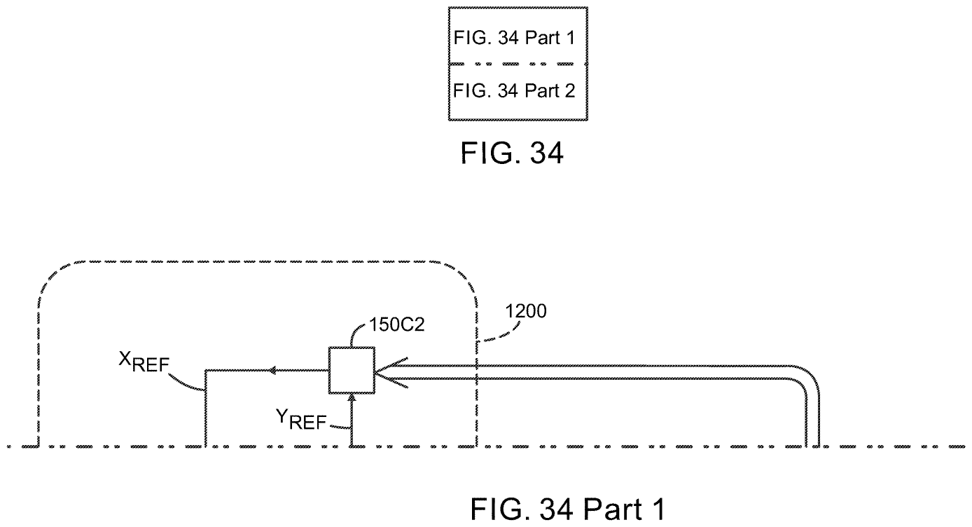

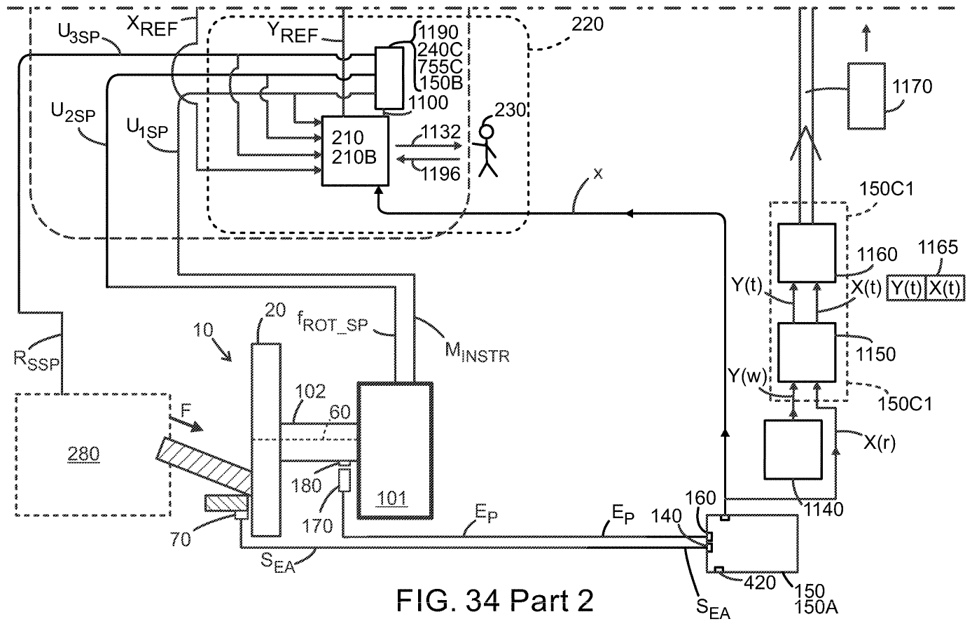

The error vector is delivered to regulator 755, 755C. The regulator 755, 755C of FIG. 33 is a multivariable regulator adapted to generate a set point vector U_{SP}. Accordingly, the set point vector U_{SP} includes the above described set point value(s) for controlling or adjusting corresponding input variable(s) U1, U2, U3, . . . . Uk (See FIG. 33 in conjunction with FIG. 34).

Thus, the system described in relation to FIG. 33 advantageously simplifies for the operator 230 of the machine 10 by conveying 1122 information indicative of the tool wear state X of the tool during operation, while also allowing the operator to provide 1126 information describing a tool wear state, e.g. in the form of reference values for the above described tool wear state limit vector X REF.

The regulator 755, 755C may be a multi-variable regulator configured to include a multi-variable proportional-integral-derivative controller (PID controller). Alternatively, the regulator 755, 755C may be configured to include a multi-variable proportional-integral controller (PI controller). Alternatively, the regulator 755, 755C may be configured to include a multi-variable proportional controller (P controller).

Alternatively, the regulator 755, 755C may be configured to include Kalman filtering, also known as linear quadratic estimation (LQE). Kalman filtering is an algorithm that uses a series of measurements observed over time, including statistical noise and other inaccuracies, and produces estimates of unknown variables that tend to be more accurate than those based on a single measurement alone, by estimating a joint probability distribution over the variables for each timeframe.

FIG. 34 shows another somewhat diagrammatic view of a system 1130 including a machine 10. Thus, reference numeral 1130 relates to a system including a machine 10 having a rotatable tool 20, as discussed in this document. The system 1130 of FIG. 34 may include parts, and be configured, as described above in relation to FIG. 1A and/or as described in any of the other examples described in this disclosure, e.g. in relation to FIGS. 1-33.

The Monitoring Module 150A may include status parameter extractor functionality as described elsewhere in this document for generating tool wear state values X1, X2, X3, . . . , Xm. It is to be noted that the tool wear state X of the tool, at a time termed r, can be referred to as X(r). That tool wear state X(r) can be described, or indicated, by a number of parameter values, the parameter values defining different aspects of the tool wear state X(r) of the tool 20 when in the position r. Thus, values of the tool wear state value X1, X2, X3, . . . , Xm at the time r may be collectively referred to as a tool wear state vector X(r).

The system illustrated in FIG. 34 may provide an integrated HCI 210, 250, 210S. Thus, the input/output interface 210 of FIG. 34 may be configured to enable all the input and/or output described above. Additionally, the input/output interface 210 of FIG. 34 may be configured to provide 1132 information relating to a state of the output material. The state of the output material may be described by the output parameters Y1, Y2, Y3, . . . . Yn, collectively referred to as output vector Y. As mentioned above, the dimension of output vector Y is n:
Output vector Y: Dim (Y)=n

The vector Y may also be referred to as output material state vector Y.

System 1130 of FIG. 34 includes a regulator 1190. The regulator 1190 may be configured to enable all functions described with reference to regulator 240, which is described elsewhere in this document. Alternatively, regulator 1190 may be configured to enable all functions described with reference to regulator 755, which is described elsewhere in this document. In addition to functions described in regulator 240 and/or regulator 755 the regulator 1190 may be configured to perform additional functions, such as e.g. to convey and/or receive information relating to the output material 95, e.g. in the form of output parameters Y1, Y2, Y3, . . . . Yn. Thus regulator 1190 may also be referred to by reference number 240C and/or 755C.

Thus, regulator 1190 may be configured to convey information relating to the output material 95 to an operator 230, as indicated by arrow 1132. Moreover, regulator 1190 may be configured to receive, from an operator 230, information relating to the output material 95, as indicated by arrow 1196.

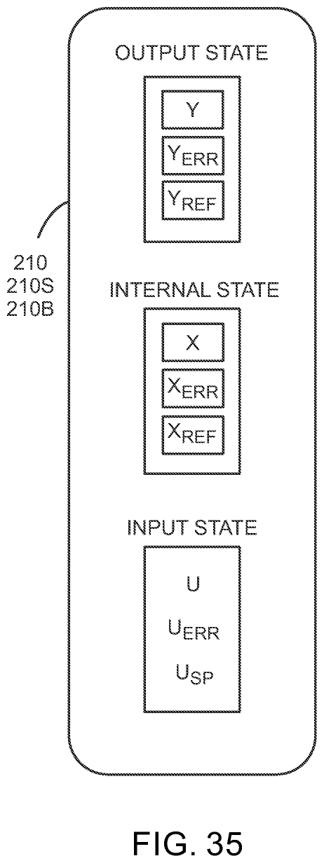

FIG. 35 is a schematic general overview of information that may be conveyed by input/output interface 210 of FIG. 34. With reference to FIGS. 34 and 35 it is noted that the regulator 1190, 755C of FIG. 34 is coupled, via coupling 1100, for data exchange with input/output interface 210. Information to be transferred via coupling 1100 includes reference values for the above described tool wear state limit vector X REF.

Referring to FIG. 34, the system 1130 comprises a product analyser 1140 configured to analyze at least a portion of said output material 95. The analyser 1140 is configured to generate at least one output material measurement value Y1, Y2, Y3, . . . . Yn based on said output material analysis.

In effect, the at least one output material measurement value Y1, Y2, Y3, . . . . Yn may be indicative of a output material state Y, the output material state Y being a momentary state of the output material 95. When analyser 1140 provides two or more output material measurement values, these values may be provided in the form of the above mentioned output vector Y.

The at least one output material measurement value may, for example, include a value indicative of a output material discharge rate R_{SDis}. The output material discharge rate R_{SDis} may also be referred to as output parameter Y1.

The momentary state of the output material 95, i.e. the output material state Y, may be identified by measurement of at least one output material measurement value Y1, Y2, Y3, . . . . Yn. In practice it may be desirable to generate more than one output material measurement value in order to obtain information indicative of the output material state (Y).

The at least one output material measurement value may be one or many selected from the group:
a value Y1; Y2 indicative of a mass per time unit of said output material 95;
a value Y1; Y2 indicative of a mass per time unit of said output material 95;
a value Y1; Y2 indicative of an output material median size;
a value Y1; Y2 indicative of a mass per time unit of said output material 95 having a size that falls below a predetermined output material size limit;
a value Y1; Y2 indicative of a proportion, or a percentage share, of said output material that have an output material size in a range between a lower output material size limit and an upper output material size limit;
a value Y1; Y2 indicative of a count, i.e. a number of output material with output material size in a range between a lower output material size limit and an upper output material size limit;
a value Y1; Y2 indicative of an output material size distribution Y, such as a standard deviation; and
a value Y1; Y2 indicative of an output material size Y1; Y2.

Said output material size Y1; Y2 may be at least one selected from the group:
an output material median size value;
an output material mean size value;
an output material median diameter value; and
an output material mean diameter value.

Said output material size limit values may be at least one selected from the group:
an output material diameter value; and
an output material maximum width value.

Said value Y1; Y2 indicative of an output material size distribution Y may be at least one selected from the group:
a standard deviation value;
a variance value;
range between the highest and lowest size;
interquartile range.

Said range between a smallest output material size value and a largest output material size value may be between
30 micrometres and 20 millimetres;
150 micrometres and 300 micrometres;
200 micrometres and 220 micrometres; and/or
0 millimetres and 40 millimetres.

The product analyser 1140 may thus be configured to analyze at least a portion of said output material 95 so as to generate at least one output material measurement value Y1, Y2, Y3, . . . . Yn based on said output material analysis. The at least one output material measurement value Y1, Y2, Y3, . . . . Yn may be provided with information indicative of a point in time when the at least one output material measurement value Y1, Y2, Y3, . . . . Yn was generated.

Moreover, the output material state Y, at a point in time termed w, can be referred to as Y(w). That output material state Y(w) can be described, or indicated, by a number of parameter values Y1 (w), Y2 (w), Y3 (w), . . . . Yn (w), the parameter values defining different aspects of the output material 95 discharged from of the machine 10 at time w. Thus, values of the output material parameter values Y1, Y2, Y3, . . . . Yn at time w may be collectively referred to as output material state vector Y(w), also referred to as output vector Y(w).

As noted above, there is a causal relationship between a certain tool wear state X(r) and a certain output Y(r), and thus the output Y of the machine 10 can be regarded as a function of the tool wear state X.

Referring to FIG. 34, the output vector Y may be delivered to a first input of a correlator 150C1. Moreover, the tool wear state vector X may be delivered by the module 150A to a second input of the correlator 150C1. The correlator 150C1 is configured to identify a correspondence between the tool wear state X and the corresponding output Y.

However, in order to perform a correlation it is desirable to ensure that a measured value of the output Y(w) refers to, at least approximately, the same point in time as the tool wear state

X(r). In other words, the values in the tool wear state vector X(r) may need to be synchronized with the values in the corresponding output vector Y(w). Referring to FIG. 34, the output vector Y(w) may be delivered to a first input of an optional synchronizer 1150. The synchronizer 1150 is optional because it may not be needed, e.g. when the tool wear state vector X(r) and the corresponding output vector Y(w) are generated in a synchronized manner such that
the point in time w is the same point in time as the time r, or
such that the point in time w is at least approximately the same point in time as the point in time r.

Temporally Synchronized vectors X(t) and Y(t) are received by a correlation data generator 1160, as illustrated in FIG. 34.

The correlation data generator 1160 generates a correlation data set 1170. According to an example, the correlation data generator 1160 generates a correlation data set by performing correlation of
a received at least one tool wear state value, such as e.g. X1(t) and
a received at least one corresponding output material measurement value, such as e.g. Y2(t).

The correlation data generator 1160 may receive a number of time stamped tool wear state vectors X(r) and a number of time stamped corresponding output vector Y(w). The received information vectors may be received in a temporally interleaved fashion such as X(10), Y(12), X(14), Y(16), X(18), Y(20), X(22), Y(24), wherein the synchronizer 1150 receives a vector X in a time period between the reception of two consecutive vectors Y. That is the case e.g. when vector X(18) is time stamped in the time period between t=20 and t=16, and the Y-vectors Y(16) and Y(20), respectively, are time stamped at the points in time t=16 and t=20. When operating the machine 10 at a steady state condition, i.e. when all the values in vectors X and Y are stable over time, the synchronizer 1150 may generate pairs of vectors X and Y by adjusting the time stamps so that a generated pair of vectors X and Y have the same time stamp. That same time stamp may e.g. be an intermediate time stamp. For example, the synchronizer 1150 when receiving the above mentioned vectors X(18) and Y(20) may arrange them as a vector pair stamped with an intermediate time t=19. Thus, the synchronizer 1150 may, in response to reception of vectors X(t) and Y(t+2) generate a vector pair X(t+1) and Y(t+1) for delivery to correlation data generator 1160.

Moreover, the delivery frequency of the X-vectors and the Y-vectors may be different. This problem may be addressed, for example, by configuring the synchronizer 1150 to deliver, to correlation data generator 1160:
pairs of received vectors X and Y such that each time stamped vector Y is associated with that vector X having the closest earlier time stamp. As a consequence, the synchronizer 1150 may have to discard or reject some vectors.

Thus, for example, when the delivery frequency of the X-vector lower than the delivery frequency of the Y-vector, the synchronizer 1150 may receive vectors as follows:
vector X(34),
vector Y(36),
vector X(37),
vector Y(38),
vector X(40),
vector Y(40),
vector Y(42)
vector X(43),
vector Y(44),
then the synchronizer 1150 may deliver, to correlation data generator 1160, pairs 1165 of vectors X and Y such that each time stamped vector Y is associated with that vector X having the closest earlier time stamp. In the above example, the following pairs could be delivered by synchronizer 1150:
vector X(34) vector Y(36),
vector X(37), vector Y(38),
vector X(40), vector Y(40),
vector X(43), vector Y(44), and as a cosequence vector Y(42) may be discarded.

Table 7 below is an example of successive pairs 1165 of vectors X and Y arranged in temporal order.

TABLE 7
Successive pairs 1165 of vectors X
and Y arranged in temporal order.

| t | X1 | Y2 |
|---|---|---|
| t1 | 62 | 195 |
| t2 | 63 | 198 |
| t3 | 64 | 201 |
| t4 | 65 | 204 |
| t5 | 66 | 207 |
| t6 | 67 | 210 |
| t7 | 68 | 213 |
| t8 | 69 | 216 |
| t9 | 70 | 219 |
| t10 | 71 | 222 |
| t11 | 72 | 225 |
| t12 | 73 | 228 |
| t13 | 74 | 231 |
| t14 | 75 | 234 |

The example of successive pairs 1165 of vectors X and Y, illustrated by table 7, includes information indicative of a tool wear state value X1, and information indicative of a corresponding output parameter Y2. The output parameter Y2 is indicative of a median size of output material 95 produced by a machine 10 including a tool 20 for shearing and/or shaping a raw material workpiece 30.

The correlation data generator 1160, may be configured to perform a correlation based on received pairs 1165 of vectors X and Y. According to an example the correlation data generator 1160 may be configured to perform a regression analysis based on a large number of received pairs 1165 of vectors X and Y.

The regression analysis may use one or several statistical processes for estimating the relationships between the dependent variables, i.e the values in the vector Y and one or more independent variables, i.e. the values in the vector X.

With reference to FIG. 34, the correlation data set 1170, generated by correlator 150C1 may be delivered to a tool wear state limit value generator 150c2.

The tool wear state limit value generator 150c2 may be configured to use the received correlation data 1170 for transforming a limit value Y_{LIMIT} into a corresponding tool wear state limit value X_{LIMIT}. Table 8 is an illustration of an example of a data transformation table for transforming a limit value Y2_{LIMIT} into a corresponding tool wear state limit value X1_{LIMIT}. In fact, table 8 is an example data set corresponding to the information in table 7 above.

TABLE 8
A correlation data set 1170 in the form of a correlation
table for transforming an output material limit value Y2_{LIMIT}
into a tool wear state limit value X1_{LIMIT}

| Y2_{LIMIT} | | X1_{LIMIT} |
|---|---|---|
| 195 | => | 62 |
| 198 | => | 63 |
| 201 | => | 64 |
| 204 | => | 65 |
| 207 | => | 66 |
| 210 | => | 67 |
| 213 | => | 68 |
| 216 | => | 69 |
| 219 | => | 70 |
| 222 | => | 71 |
| 225 | => | 72 |
| 228 | => | 73 |
| 231 | => | 74 |
| 234 | => | 75 |

The example correlation data table 1170, an example of which is illustrated by table 8, indicates a correlation between tool wear state value X1, and output parameter Y2, indicative of a median size of output material 95 produced by a machine including a tool for shearing and/or shaping a raw material workpiece.

### a More Complex Case of a Multi-Variable Monitoring System

FIGS. 37 and 38 serve as illustration of the function of the correlation data generator 1160 in the relatively simple case of regression analysis applied to a single dependent variable Y2 and a single independent variable X1.

However, is also an object to be addressed by solutions and examples disclosed in this document, to describe methods and systems for improved monitoring and/or control of a tool wear state X in a machine 10 during operation. When the machine 10 runs at a variable speed of rotation X5=U1 and it also exhibits variations in the magnitude of the frequency of order L, X1, the above described regression analysis as applied to a single dependent variable Y2 and a single independent variable X1 may not suffice. In order to address this problem, however, the correlation data generator 1160 may apply regression analysis to a number of data pairs 1165 comprising
a received tool wear state vector X(t) of dimension m and
a received corresponding output vector Y(t) of dimension n,
wherein m and n are positive integers.

Thus, when m tool wear state values X1, X2, X3, . . . , Xm are to be correlated with n output material measurement values Y1, Y2, Y3, . . . . Yn, the correlation data generator 1160 may be configured to generate a correlation data 1170 set by performing correlation of
a received tool wear state vector X(t)
   and
a received corresponding output vector Y(t)
   wherein
X(t) is a m*1 vector and m is a positive integer, and
Y(t) is a n*1 vector and n is a positive integer.

Accordingly, in this case the correlation data generator 1160 may be configured to perform a regression analysis so as to identify a more complex linear combination (i.e more complex than a line in a two-dimensional space) that most closely fits the data according to a specific mathematical criterion. For example, the correlation data generator 1160 may perform a method of ordinary least squares, applied to a number of received vectors X(t) of dimension m and a number of received corresponding output vectors Y(t) of dimension n, so as to compute a unique hyperplane that minimizes the sum of squared differences between the received data and that hyperplane.

Accordingly, the correlation data generator 1160, when receiving vectors X(t) of dimension m and a number of received corresponding output vectors Y(t) of dimension n, is configured to generate a multi-dimensional correlation data set 1170. According to an example, the multi-dimensional correlation data set 1170 may be delivered as data 1170 indicative of the above mentioned hyperplane. Alternatively, the multi-dimensional correlation data set 1170 may be delivered as data 1170 indicative of the coefficient matrix C, as discussed in relation to equation 7 above.

According to an example, correlation data generator 1160 may be configured to include Kalman filtering, also known as linear quadratic estimation (LQE), when generating a correlation data set 1170.

This solution advantageously enables identification and/or determination of a cause and effect relationship between the tool wear state X of the shearing process and the at least one output material measurement value Y.

Moreover, this solution advantageously enables identification and/or determination of a cause and effect relationship between the tool wear state X of the shearing process and the output material state Y. The output material state Y may also be referred to as the output material state Y.

This solution is versatile in that it allows for the defining of an output material state limit Y_{LIMIT}, and for testing of alternative tool wear states, also referred to as operating points X_{OP}, of the shearing process in order to search and identify a tool wear state X_{BEP} of the shearing process that causes, or produces, the output material state limit Y_{LIMIT} or that causes or produces a output material state Y as near as possible to the output material state limit Y_{LIMIT}. Such a tool wear state may be referred to as a Best Operating Point, BEP. The values of the parameters at BEP may collectively be referred to as tool wear state BEP vector X_{BEP}.

Moreover, the recording of a detected momentary shearing process tool wear state X(r) in association with a corresponding momentary output material state Y(r), produces correlation data indicative of a correlation between
a momentary shearing process tool wear state X(r) and
a corresponding momentary output material state Y(r).

By performing repeated recording of a number of mutually different detected momentary shearing process tool wear states X(r) in association with momentary output material states Y(r) that were caused by the respective momentary shearing process tool wear states X(r), wherein r is a number variable indicative of a number of different points in time, a correlation data set may be produced. Such a correlation data set is indicative of a correlation between
a number of momentary shearing process tool wear states X(r) and
a number of corresponding momentary output material states Y(r).

The machine operating characteristic curve, or BMOC curve, of a machine 10 is a graphical plot that illustrates the median size (Y2) of output material 95 generated by a machine for different tool wear states (X).

The BMOC curve may be created by plotting a tool wear state value (X1, X2) against the median size (Y2) of output material 95 corresponding to said tool wear state value. The machine including a tool 20 for shearing and/or shaping a raw material workpiece operating point, or Xor or TOP, is a specific point within the operation characteristic of a machine including a tool for shearing and/or shaping a raw material workpiece. It has been found that when the tool wear state values (X1, X2) are within as certain range of tool wear state values for a particular machine including a tool for shearing and/or shaping a raw material workpiece operating point (Xop, TOP) may result in a desired output material size distribution (Y). In the context of this document, the term machine operation area (MOA) may be used to describe such a certain range of tool wear state values (X1, X2).

The machine operating characteristic curve, or MOC curve, of a machine including a tool for shearing and/or shaping a raw material workpiece is a graphical plot that illustrates the output material size distribution (Y) of output material 95 generated by a machine including a tool for shearing and/or shaping a raw material workpiece when at least one of the tool wear state values (X1, X2, X3, X4, X5, X6) is varied. Thus, for example, a MOC curve is created by plotting a measure of the output material size distribution (Y) against the tool wear state values when e.g. the rotational speed (f_{ROT}) of the tool is kept constant.

Referring again to FIG. 34, the tool wear state limit value generator 150c2 may be configured to use the received correlation data 1170 for transforming an output material limit value Y_{LIMIT} into a corresponding tool wear state limit value X_{LIMIT}. The output material limit value Y_{LIMIT} relates to a threshold value for acceptable output material. The correlation data 1170 and machine operating parameters may allow the tool wear state limit value X_{LIMIT} or the output material limit value Y_{LIMIT} to define the other.

### Use of the Correlation Data for Operating a Machine

With reference to FIG. 34, an operator 230 in the control room 220 is tasked with operation of the machine 10. The operator may use regulator 1190 for operating the machine 10. The regulator 1190 is coupled to the user interface 210, 210B also referred to as Human Computer Interface (HCI) 210B, as shown in FIG. 34.

The example control room 220, shown in FIG. 34, includes a tool wear state control system 1200 comprising the tool wear state limit value generator 150c2 and the user interface 210, 210B and regulator 755C, 240C.

The tool wear state control system 1200 may be configured to perform the following steps: (Step S3000:) cause the user interface 210 to convey information requesting the operator to provide user input indicative of an output material state limit Y_{LIMIT}. The user input indicative of an output material state limit Y_{LIMIT} may be indicative of a threshold for at least one desired output material measurement value, such as Y1 and/or Y2, as discussed above. For example, the user input may be indicative of an output material median size limit Y2_{LIMIT}, and/or output material size distribution limit Y3_{LIMIT}, Y4_{LIMIT}, or an output material per time unit limit Y1_{LIMIT}.

This request, S3000, may be generated by software included in the regulator 755C, or by software included in the regulator 240C, or by software included in the tool wear state limit value generator 150c2.

The tool wear state control system 1200 may also be configured to: (Step S3005:) receive, e.g. via user interface 210, data indicative of an output material state limit Y_{LIMIT} and/or output material median size limit Y2_{LIMIT} and/or output material size distribution Y2, Y3, Y4.

Moreover, the tool wear state control system 1200 may be configured to perform a method comprising the following steps:
S3010: generate a tool wear state limit value (X1_{LIMIT}; FI_{LIMIT}) based on said data indicative of said output material state limit value Y_{LIMIT} and/or said output material median size limit (Y2_{LIMIT}) and/or output material median size distribution limit Y2_{LIMIT}, Y3_{LIMIT}, Y4_{LIMIT}, and
a correlation data set (1170); said correlation data set (1170) being
indicative of a causal relationship between
a certain tool wear state value (X1, X2, X3 . . . ) and
a corresponding certain output material median size (Y2),
at said speed of tool rotation (U1, f_{ROT});
and/or indicative of a causal relationship between
a certain tool wear state limit value X_{LIMIT} and
a corresponding certain output material state limit value Y_{LIMIT}.

The corresponding certain output material state limit Y_{LIMIT} may include an output material size distribution (Y2, Y3, Y4).

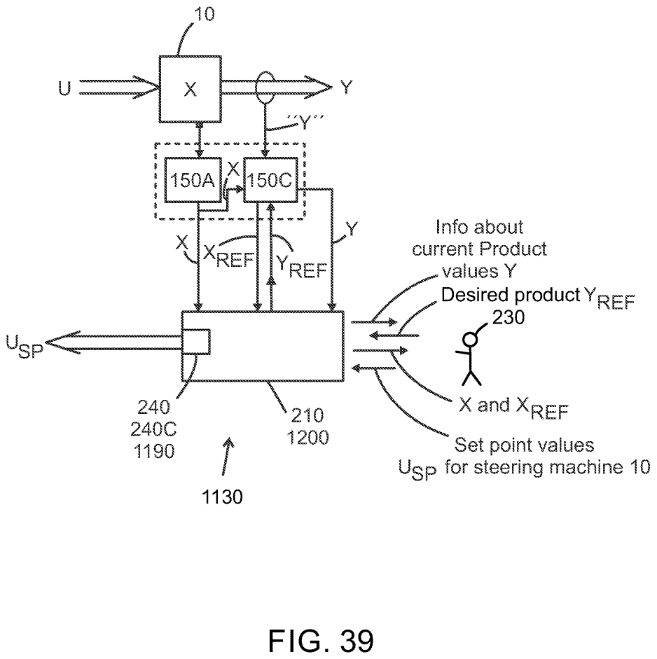

The step S3010 may involve the delivery of the received data, from the user interface 210 to the tool wear state limit value generator 150c2 (See FIG. 34 and/or FIG. 35 and/or FIG. 39).

The tool wear state limit value generator 150c2 is configured to transform data relating to output material state limit Y_{LIMIT} into data indicative of a corresponding tool wear state limit X_{LIMIT} and/or data indicative of a corresponding tool wear state limit value X1_{LIMIT} (r), FI_{LIMIT}(r), as discussed above.

With reference to FIG. 34 in conjunction with FIG. 35, the tool wear state control system 1200 may also be configured to:
S3020: cause the user interface (210, 210S, 240, 250) to convey information indicative of the corresponding tool wear state limit X_{LIMIT} and/or data indicative of the corresponding tool wear state limit value (X1_{LIMIT}(r), FI_{LIMIT}(r), and
S3020: causing a user interface (210, 210S, 240, 250) to convey information indicative of an actual tool wear state value (X1, X2, X3 . . . ), e.g. received from the monitoring module 150A,
S3020: receiving, via a user interface (210, 210S, 240, 250), first user input relating to said raw material feed rate (U2, R_{S});
S3020: generating a raw material feed rate set point value (U2_{SP}, R_{SSP}) thereby influencing said tool wear state (X) for controlling or affecting said
output material state limit Y_{LIMIT}
output material median size (Y2); wherein
said generated raw material feed rate set point value (U2_{SP}, R_{SSP}) is based on said received first user input.

System for monitoring and providing improved shearing process information content to an operator

FIG. 39 is a block diagram of the system 1130 for monitoring of a tool wear state X of a tool and for providing improved information content to an operator 230 of the machine 10.

The system 1130 includes a machine 10, as discussed in connection with FIG. 34 above. In

FIG. 39 the system 1130 is shown as a block diagram including a machine including a tool for shearing and/or shaping a raw material workpiece illustrated as a box 10 receiving a number of inputs U1, . . . . Uk, and generating a number of outputs Y1, . . . . Yn. Thus, in terms of signal processing and analysis, the machine 10 receives an input vector U, and it generates an output vector Y, in the manner discussed elsewhere in this document. The system 1130 of FIG. 39 may include parts, and be configured, as described above in relation to FIG. 1A and/or as described in any of the other examples described in this disclosure, e.g. in relation to FIGS. 1-34.

The system 1130 includes a Monitoring Module 150A and/or a Correlation Module 150C, as shown in FIG. 39. The Correlation Module 150C may operate to generate the correlation data set 1170 during operation of the machine 10, as described above, and/or Correlation Module 150C may operate to transform data relating to output material state limit Y_{LIMIT} into data indicative of a corresponding tool wear state limit X_{LIMIT}, the transformation step being based on a correlation data set 1170 that is relevant for the machine 10 being operated.

The system 1130 shown in FIG. 39, includes a tool wear state control system 1200 comprising the tool wear state limit value generator 150c2 and the user interface 210, 210B and regulator 240C.

The tool wear state control system 1200 may be configured to perform the following steps:

(Step S3000:) cause the user interface 210 to convey information requesting the operator to provide user input indicative of an output material state limit Y_{LIMIT}. The user input indicative of an output material state limit Y_{LIMIT} may be indicative of at least one desired output material measurement value, such as Y1 and/or Y2, as discussed above. For example, the user input may be indicative of an output material median size limit Y2_{LIMIT}, and/or output material size distribution Y3_{LIMIT}, Y4_{LIMIT}, or an output material per time unit limit Y1_{LIMIT}.

This request, S3000, may be generated by software included in the regulator 240C.

The tool wear state control system 1200 may also be configured to: (Step S3005:) receive, e.g. via user interface 210, data indicative of an output material state limit Y_{LIMIT} and/or output material median size Y2_{LIMIT} and/or output material size distribution Y2, Y3, Y4.

Moreover, the tool wear state control system 1200 may be configured to perform a method comprising the following steps:
S3010: generate a corresponding tool wear state limit X_{LIMIT} (also referred to as tool wear state limit vector X_{LIMIT}) which may include a tool wear state limit value (X1_{LIMIT}; FI_{LIMIT}).

The tool wear state limit vector X_{LIMIT} may be based on said data indicative of said output material state limit Y_{LIMIT} and/or said output material median size limit (Y2_{LIMIT}) and/or output material size distribution limit Y2_{LIMIT}, Y3_{LIMIT}, Y4_{LIMIT}, and
a correlation data set (1170); said correlation data set (1170) being indicative of a causal relationship between
a certain tool wear state limit X_{LIMIT} and
a corresponding certain output material state limit Y_{LIMIT}.

The corresponding output material state limit Y_{LIMIT} may include an output material size distribution (Y2, Y3, Y4), and/or an output material discharge rate Y1_{LIMIT}.

The step S3010 may involve the delivery of the received data (i.e. indicative of an output material state limit Y_{LIMIT}), from the user interface 210 to the Correlation Module 150C (See FIG. 39).

The Correlation Module 150C may include a tool wear state limit value generator 150c2 configured to transform data relating to output material state limit Y_{LIMIT} into data indicative of a corresponding tool wear state limit X_{LIMIT} and/or data indicative of a corresponding tool wear state limit value X1_{LIMIT}(r), FI_{LIMIT}(r), as discussed above.

With reference to FIG. 39 in conjunction with FIG. 35, the tool wear state control system 1200 may also be configured to:
S3020: cause the user interface (210, 210S, 240, 250) to convey information indicative of the corresponding tool wear state limit X_{LIMIT} and/or data indicative of the corresponding tool wear state limit value (X1_{LIMIT}(r), FI_{LIMIT}(r), and
S3020: causing a user interface (210, 210S, 240, 250) to convey information indicative of an actual tool wear state value (X1, X2, X3 . . . ), e.g. received from the monitoring module 150A,
S3020: receiving, via a user interface (210, 210S, 240, 250), first user input relating to said raw material feed rate (U2, R_{S});
S3020: generating a raw material feed rate set point value (U2_{SP}, R_{SSP}) thereby influencing said tool wear state (X) for controlling or affecting said
output material state limit Y_{LIMIT}
output material median size (Y2); wherein
said generated raw material feed rate set point value (U2_{SP}, R_{SSP}) is based on said received first user input.

### System for Monitoring Machine Product and Providing Improved Process Control

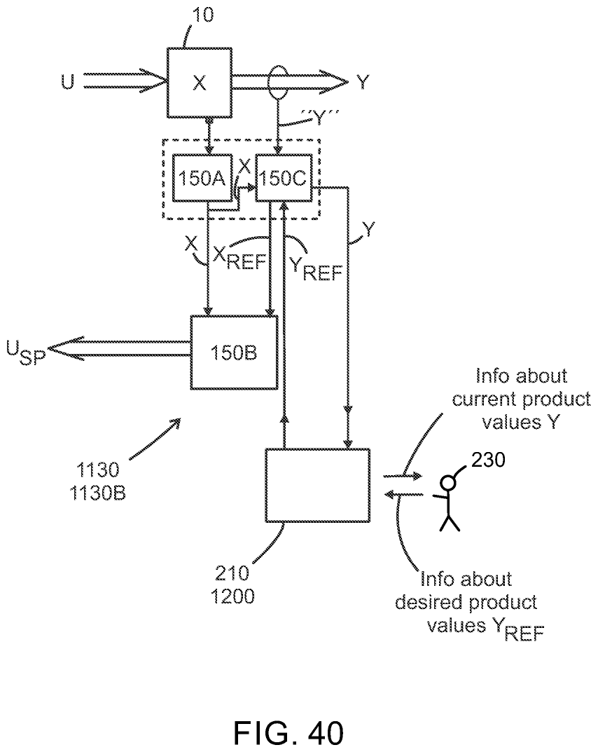

FIG. 40 is a block diagram of a system 1130B for monitoring of a tool wear state X of a machine 10 and for enabling improved control of a shearing and/or shaping process that occurs in a machine 10. The system 1130B may include some, or all, of the features discussed in connection with FIG. 39. Thus, the system 1130B may include some, or all, of the features of system 1130 of FIG. 39.

The system 1130B includes a Correlation Module 150C, as shown in FIG. 39, and system 1130B may also include a Monitoring Module 150A.

The Correlation Module 150C may operate to generate the correlation data set 1170 during operation of the machine 10, as described above, and/or Correlation Module 150C may operate to transform data relating to output material state limit Y_{LIMIT} into data indicative of a corresponding tool wear state limit X_{LIMIT}, the transformation step being based on a correlation data set 1170 that is relevant for the machine 10 being operated.

The system 1130 shown in FIG. 39, includes a tool wear state control system 1200 comprising the tool wear state limit value generator 150c2 and the user interface 210, 210B and regulator 240C.

The system 1130B may be configured to perform the following steps:

(Step S3000:) cause the user interface 210 to convey information requesting the operator to provide user input indicative of an output material state limit Y_{LIMIT}. The user input indicative of an output material state limit Y_{LIMIT} may be indicative of at least one output material measurement value, such as Y1 and/or Y2, as discussed above. For example, the user input may be indicative of an output material median size limit Y2_{LIMIT}, and/or output material size distribution limit Y3_{LIMIT}, Y4_{LIMIT}, or a amount of output material per time unit limit Y1_{LIMIT}.

This request, S3000, may be generated by software included in the control module 150B, or by software included in the Correlation Module 150C, or by tool wear state control system 1200.

The system 1130B may also be configured to:

(Step S3005:) receive, e.g. via user interface 210, data indicative of an output material state limit Y_{LIMIT} and/or output material median size Y2_{LIMIT} and/or output material size distribution Y2, Y3, Y4.

Moreover, the system 1130B may be configured to perform a method comprising the following steps:

S3010: generate a corresponding tool wear state limit X_{LIMIT}, also referred to as tool wear state limit vector X_{LIMIT}) which may include a tool wear state limit value (X1_{LIMIT}; FI_{LIMIT}).

The tool wear state limit vector X_{LIMIT} may be based on said data indicative of said output material state limit Y_{LIMIT} and/or said output material median size limit (Y2_{LIMIT}) and/or output material size distribution limit Y2_{LIMIT}, Y3_{LIMIT}, Y4_{LIMIT}, and
a correlation data set (1170); said correlation data set (1170) being
indicative of a causal relationship between
a certain tool wear state limit X_{LIMIT} and
a corresponding certain output material state limit Y_{LIMIT}.

The corresponding output material state limit Y_{LIMIT} may include an output material size distribution (Y2, Y3, Y4), and/or an output material discharge rate limit Y1_{LIMIT}.

The step S3005 may involve the delivery of the received data (i.e. indicative of an output material state limit Y_{LIMIT}), from the user interface 210 to the Correlation Module 150C (See FIG. 40).

The Correlation Module 150C may include a tool wear state limit value generator 150c2 configured to transform data relating to output material state limit Y_{LIMIT} into data indicative of a corresponding tool wear state limit X_{LIMIT} and/or data indicative of a corresponding tool wear state limit value X1_{LIMIT}(r), FI_{LIMIT}(r), as discussed above.

Moreover, the system 1130B may be configured to perform a method comprising the following steps:
controlling via a regulator 755C, 755 said output material state (Y) based on
   said at least one tool wear state limit value (X1_{LIMIT}; FI_{LIMIT}) included in a tool wear state limit vector X_{LIMIT},
   at least one tool wear state value (X1, X2, X3, X4, X5, X6, X7) or a tool wear state vector (X) including said at least one tool wear state value indicative of a current tool wear state (X) of the shearing process, and at least one tool wear state error value (X1_{ERR}, X2_{ERR}, X3_{ERR}, X4_{ERR}, X5_{ERR}, X6_{ERR}, X7_{ERR}) or a tool wear state error vector X ERR including said at least one tool wear state error value,
      wherein
said at least one tool wear state error value (X1_{ERR}, X2_{ERR}, X3_{ERR}, X4_{ERR}, X5_{ERR}, X6_{ERR}, X7_{ERR}) depends on
said at least one tool wear state limit value (X1_{LIMIT}; FI_{LIMIT}), and
said at least one tool wear state value (X1, X2, X3, X4, X5, X6, X7).

Moreover, the system 1130B may be configured to perform a method comprising the following steps:
controlling via a regulator 755C, 755 said output material state (Y) based on
   a tool wear state limit vector X_{LIMIT} indicative of a current tool wear state (X) of the shearing process, and
a tool wear state vector (X) indicative of a current tool wear state (X) of the shearing process, and
   a tool wear state error vector X ERR including at least one tool wear state error value,
      wherein
said tool wear state error vector X ERR depends on
said tool wear state limit vector X_{LIMIT}, and
said tool wear state vector (X).

Moreover, the system 1130B may be configured to perform a method comprising the following steps:
receiving, via a user interface (210, 210S, 240, 250), a first user input relating to said raw material feed rate (U2, R_{S}); and
generating said raw material feed rate set point value (U2_{SP}, R_{SSP}); wherein
said generated data indicative of raw material feed rate set point value (U2_{SP}, R_{SSP}) is based on said received first user input.

Various examples are disclosed below, starting with example 1.

In some examples, the system 1130B may be configured to perform a method comprising the following steps:
receiving, via a user interface (210, 210S, 240, 250), a first user input relating to replacing the tool 20 or parts thereof,
performing a tool replacement action, and resuming operation.

An example 1 relates to a system 5 for shearing material, the system comprising: a machine (10) including a tool (20) that rotates around an axis (60) at a speed of rotation (f_{ROT}) for shearing a raw material workpiece; wherein said tool (20) has at least one tool edge (310) configured to engage the raw material workpiece (30);
a vibration sensor (70) configured to generate an analogue measurement signal (S_{EA}) dependent on mechanical vibrations (V_{IMP}) emanating from rotation of said tool (20);
a position sensor (170) configured to generate a position signal indicative of a rotational position of said rotating tool;
   a signal recorder adapted to record
      a time sequence of measurement sample values (Se(i), S(j)) of said digital measurement data signal (S_{MD}, S_{ENV}, S_{MD}), and
      a time sequence of said position signal values (P(i)), and
      time information (i, dt; j)
         such that
an individual measurement data value (S(j)) is associated with data indicative of time of occurrence of the individual measurement data value (S(j)), and such that
an individual position signal value (P(i)) is associated with data indicative of time of occurrence of the individual position signal value (P(i));
a signal processor adapted to detect the occurrence of an amplitude peak value in said recorded time sequence of measurement sample values (Se(i), S(j));
said signal processor being adapted to generate data indicative of a temporal duration between said position signal value occurrence and said amplitude peak value occurrence.

2. The system of example 1, wherein
said signal processor is configured to generate a tool sate data set, said tool state data set being indicative of an tool wear state of said tool; said tool state data set comprising said amplitude peak value and said temporal duration.

3. The system according any preceding example, wherein
said tool state data set being indicative of a speed of rotation (f_{ROT}) of said rotating tool.

4. The system according any preceding example, wherein
the rotating tool 20 comprises at least four tool edges 310.

An example 5 relates to an tool edge monitoring system for generating and displaying information relating to a tool wear state of a shearing process in a machine (10) having a tool (20) that rotates around an axis (60) at a speed of rotation (f_{ROT}) for shearing raw material (30),

the tool edge monitoring system comprising:
a status parameter extractor (450) configured to generate a
   a first tool wear state indicator data structure (550, S_{P1}, T_{D1}), indicative of said tool wear state of said shearing process, said first tool wear state indicator data structure (550, S_{P1}, T_{D1}) including a first impact force indicator value (S_{P1}) and a first temporal indicator value (T_{D1});
said first impact force indicator value (S_{P1}) being indicative of an impact force (F_{IMP}) generated when a tool edge (310) of the rotating tool (20) interacts with a raw material workpiece (30), and
said first temporal indicator value (T_{D1}) being indicative of a temporal duration (T_{D1}) between occurrence of said impact force (F_{IMP}) and occurrence of a rotational reference position of said rotating tool.

6. The tool edge monitoring system according to example 5, wherein said status parameter extractor (450) is further configured to generate
a second tool wear state indicator data structure (S_{P2}, T_{D2}), indicative of said tool wear state of said shearing process, said second tool wear state indicator data structure (550, S_{P1}, T_{D1}) including a second impact force indicator value (S_{P2}) and a second temporal indicator value (T_{D2})
said second impact force indicator value (S_{P2}) being indicative of an impact force (F_{IMP}) generated when a tool edge (310) on the rotating tool (20) interacts with a raw material workpiece (30), and
said second temporal indicator value (T_{D2}) being indicative of a temporal duration (T_{D1}) between occurrence of said impact force (F_{IMP}) and occurrence of a rotational reference position of said rotating tool; wherein
said first tool wear state indicator data structure (S_{P1}, T_{D1}) is indicative of said tool wear state of said shearing process at a first point in time, and
said second tool wear state indicator data structure (S_{P2}, T_{D2}) is indicative of said tool wear state of said shearing process at a second point in time.

7. The tool edge monitoring system according to example 6, wherein said first tool wear state indicator data structure (S_{P1}, T_{D1}) in conjunction with said second tool wear state indicator data structure (S_{P2}, T_{D2}) is indicative of a temporal progression of said tool wear state of said shearing process.

8. The tool edge monitoring system according to any preceding example, wherein
said status parameter extractor (450) includes
a tool speed detector (500) configured to generate a value indicative of a tool speed of rotation (f_{ROT}(j)) based on a digital position signal (P(i)), said tool speed detector (500) being configured to associate said value indicative of a tool speed of rotation (f_{ROT}(i)) with a point of time (i).

9. The tool edge monitoring system according to any preceding example, wherein
said tool speed detector (500) is configured to associate said first impact force indicator value (S_{P1}; (S(i)) with said value indicative of a tool speed of rotation (f_{ROT}(j)).

10. The tool edge monitoring system according to any preceding example, wherein
said status parameter extractor (450) is configured to maintain a synchronized temporal relation between
said first impact force indicator value (S_{P1}; (S(i); S(j)) and
said value indicative of a tool speed of rotation (f_{ROT}(i); f_{ROT}(j)).

Example 11: In an tool edge monitoring system (5) for generating and displaying information relating to a shearing process in a machine (10) having a tool that rotates around an axis (60) at a speed of rotation (f_{ROT}) for shearing raw material (30); wherein the tool (20) has at least one tool edge (310) configured to engage material as the tool rotates about the axis (60),
a computer implemented method of representing a tool wear state on a screen display during said shearing process,
   the method comprising:
displaying on said screen display
   a polar coordinate system, said polar coordinate system having
      a reference point (O), and
      a reference direction (0,360); and
      a first tool wear state indicator object (S_{P1}, T_{D1}), indicative of said tool wear state of said shearing process, at a first radius (S_{P1}) from said reference point (O) and at a first polar angle (T_{D1}) in relation to said reference direction (0,360),
   said first radius (S_{P1}) being indicative of an impact force (F_{IMP}) generated when a tool edge (310), of the rotating tool, interacts with the raw material workpiece (30), and
   said first polar angle (T_{D1}) being indicative of a temporal duration (T_{D1}) between occurrence of said impact force (F_{IMP}) and occurrence of a rotational reference position of said rotating tool.

12. The method according to example 11, wherein the method further comprises
displaying on said screen display
   a second internal indicator object (S_{P2}, T_{D2}) at a second radius (S_{P2}) from said reference point (O) and at a second polar angle (T_{D1}) in relation to said reference direction (0,360),
said second radius (S_{P2}) being indicative of an impact force (S_{P}; F_{IMP}) generated when a tool edge (310) of the rotating tool (20) interacts with the raw material workpiece (30), and
said second polar angle (T_{D1}) being indicative of a temporal duration (T_{D1}) between occurrence of said impact force (F_{IMP}) and occurrence of a rotational reference position of said rotating tool; wherein
said first internal indicator object (S_{P1}, T_{D1}) is indicative of said tool wear state of said shearing process at a first point in time, and
said second internal indicator object (S_{P1}, T_{D1}) is indicative of said tool wear state of said shearing process at a second point in time.

13. The method according to example 12, wherein a simultaneous displaying on said screen display of said first tool wear state point (S_{P1}, T_{D1}) and said second tool wear state point (S_{P1}, T_{D1}) is indicative of a temporal and/or spatial progression of said tool wear state of said shearing process.

An example 14 relates to an tool edge monitoring system for generating and displaying information relating to a tool wear state of a shearing process in a machine (10) having a tool that rotates around an axis (60) at a speed of rotation (f_{ROT}) for shearing raw material (30), the tool edge monitoring system comprising:
a status parameter extractor (450) for generating
   a first tool wear state indicator data structure (550, S_{P1}, T_{D1}), indicative of said tool wear state of said shearing process, said first tool wear state indicator data structure (550, S_{P1}, T_{D1}) including a first impact force indicator value (S_{P1}) and a first temporal indicator value (P; T_{D1});
said first impact force indicator value (S_{P1}) being indicative of an impact force (F_{IMP}) generated when a tool edge (310) of the rotating tool (20) interacts with a raw material workpiece (30), and
said first temporal indicator value (T_{D1}) being indicative of a temporal duration (TDI) between occurrence of said impact force (F_{IMP}) and occurrence of a rotational reference position of said rotating tool; wherein
said status parameter extractor (450) includes
a tool speed detector (500) configured to generate a value indicative of a tool speed of rotation (f_{ROT}(j)) based on a digital position signal (P(i)), said tool speed detector (500) being configured to associate said value indicative of a tool speed of rotation (f_{ROT}(i)) with a point of time (i).

15. The tool edge monitoring system according to any preceding example, wherein
said tool speed detector (500) is configured to associate said first impact force indicator value (S_{P1}; S(j)) with said value indicative of the tool speed of rotation (f_{ROT}(j)) so that said speed of rotation (f_{ROT}(j)) value indicates said tool speed of rotation (f_{ROT}(j)) at the point of time (j) of occurrence of said impact force (F_{IMP}).

16. The tool edge monitoring system according to any preceding example, wherein
said status parameter extractor (450) is configured to generate
   a temporal progression of vibration signal values (S(i)) and a temporal progression of rotational reference position signals;
said status parameter extractor (450) further comprising a speed variation compensatory decimator (470); the decimator (470) being configured to decimate the temporal progression of vibration signal values (S(i); S_{MD}) based on the speed value (f_{ROT}(j) so as to generate a decimated vibration signal (S_{MDR}) comprising a decimated temporal progression of vibration signal values (R(q); S_{P}(r)).

17. The tool edge monitoring system according to any preceding example, wherein said status parameter extractor (450) further comprises
a fast Fourier transformer (510) configured to generate said first impact force indicator value (S_{P1}) and said first temporal indicator value (T_{D1}) based on said decimated vibration signal (S_{MDR}).

18. The system according to any preceding example, wherein
said raw material (30) comprises at least one from the list of
wood,
polymer, and
metal.

19. The system according to any preceding example, wherein
said machine (10) operates to perform shearing.

20. The system according to any preceding example, wherein
said machine (10) operates to perform shearing of raw material 30 of a hard substance into a powder output material 95.

An example 21 relates to a method for generating information relating to a tool wear state of a machine (10) having a tool (20) that rotates around an axis (60) at a speed of rotation (f_{ROT}) for shearing a raw material (30); said tool (20) having a first number (L) of tool edges (310) configured to engage material as the tool (20) rotates about the axis (60), the method comprising
generating a position signal (E, P, P(i), P(j), P(q)) indicative of a rotational position of said rotating tool (20), said position signal including a time sequence of position signal sample values (P(i), P(j), P(q));
detecting a first occurrence of a first reference position signal value (1; 1C, 0%) in said time sequence of position signal sample values (P(i), P(j), P(q));
detecting a second occurrence of a second reference position signal value (1; 1C; 100%) in said time sequence of position signal sample values (P(i), P(j), P(q));
generating a vibration signal (S_{EA}, Se(i), S(j), S(q)) dependent on mechanical vibrations (V_{IMP}) emanating from rotation of said tool, said vibration signal (S_{EA}, Se(i), S(j), S(q)) including a time sequence of vibration sample values (Se(i), S(j), S(q));
detecting a third occurrence of an event signature (S_{P}(r); S_{P}) in said time sequence of vibration sample values (Se(i), S(j), S(q));
generating data indicative of a first tool wear state value (X1, R_{T}(r); T_{D}; FI(r)) between
said third occurrence i.e. said event signature occurrence, and
said first and second occurrences.

22. The method according to any preceding example, wherein:
said first tool wear state value (X1, R_{T}(r); T_{D}; FI(r)) is indicative of a proportion of a distance between two adjacent tool edges (310).

23. The method according to any preceding example, wherein:
said first tool wear state value (X1) is indicative of an average wear state of the tool edges (310) of said tool (20).

24. The method according to any preceding example, wherein:
said event signature is indicative of an impact force (F_{IMP}) generated when a tool edge (310) on the rotating tool (20) interacts with a raw material workpiece (30).

25. The method according to any preceding example, further comprising:
generating said first tool wear state value (X1, R_{T}(r); T_{D}; FI(r)) as a phase angle (FI(r)), wherein a phase angle (FI(r)) is indicative of a position at the tool (20) where the tool edges (310) interact with the raw material workpiece (30).

26. The method according to any preceding example, further comprising:
generating said event signature as a magnitude value (S_{P}(r); S_{P}; |C_{L}(r)|; |Cₗ(r)|) in the time domain and/or in the frequency domain.

27. The method according to any preceding example, wherein:
Said first tool wear state value (X1, R_{T}(r); T_{D}; FI(r)) is generated by a Fourier Transformation.

28. The method according to any preceding example, further comprising:
Counting a total number of samples (N_{B}) from the first occurrence to the second occurrence, and
Counting another number of samples (N_{P}) from the first occurrence to the third occurrence, and
generating said first tool wear state value (X1, R_{T}(r); T_{D}; FI(r)) based on said another number and said total number.

29. The method according to any preceding example, further comprising:
Counting a total number of samples (N_{B}) from the first occurrence to the second occurrence, and
Counting another number of samples (N_{P}) from the first occurrence to the third occurrence, and generating said first tool wear state value (X1, R_{T}(r); T_{D}; FI(r)) based on a relation between said another number and said total number.

30. The method according to example 29, wherein:
Said relation between said another number and said total number is indicative of a position of tool edges (310) engaging the raw material workpiece (30).

31. The method according to example 29 or 30, wherein:
Said relation between said another number and said total number is indicative of a position of tool edges (310) engaging the raw material workpiece (30) expressed as a portion of a revolution.

32. The method according to any preceding example, further comprising:
generating said reference position signal value (1; 1C, 0%) at least one time per revolution of said rotating tool (20).

33. The method according to example 32, further comprising:
generating said reference position signal value (1; 1C, 0%) a second number of times per revolution of said rotating tool (20); said second number being equal to said first number (L).

34. The method according to example 32, further comprising:
generating said reference position signal value (1; 1C, 0%) a second number of times per revolution of said rotating tool (20); said second number being lower than said first number (L).

35. The method according to any preceding example, further comprising:
generating said reference position signal value (PS; 1; 1C, 0%) based on detection of a rotating position marker (180), wherein the rotation of said rotating position marker (180) is indicative of the rotation of said rotating tool (20).

36. The method according to example 32, wherein said reference position signal value (1; 1C, 0%) being generated at least one time per revolution of said rotating tool (20) is based on detection of a rotating position marker (180), wherein the rotation of said rotating position marker (180) is indicative of the rotation of said rotating tool (20).

37. The method according to example 36, wherein
at least one of
said first reference position signal value (1; 1C, 0%) and
said second reference position signal value (1; 1C; 100%) is generated by calculation based on said first number (L).

38. The method according to example 36, wherein
at least one of
said first reference position signal value (1; 1C, 0%) and
said second reference position signal value (1; 1C; 100%) is generated at an angular position; wherein a full revolution of said tool is virtually or mathematically divided into a third number of mutually equal parts.

39. The method according to example 38, wherein
Said third number is equal to said first number; and wherein said mutually equal parts correspond to a first number of equal distances between said tool edges (310).

40. The method according to any preceding example, wherein:
said tool edges (310) are mutually substantially equidistant.

41. The method according to any preceding example, further comprising:
recording said time sequence of vibration sample values (Se(i), S(j), S(q));
detecting the occurrence of said event signature in said recorded time sequence of vibration sample values (Se(i), S(j), S(q)).

42. The method according to any preceding example, wherein:
Said event signature is an amplitude peak value, and/or an average amplitude, and/or a ratio between an amplitude peak value and an average amplitude.

43. The method according to any preceding example, further comprising:
associating an individual vibration sample value (Se(i), S(j), S(q)) with an individual position signal sample value (P(i), P(j), P(q)).

44. The method according to any preceding example, further comprising:
generating data indicative of a momentary rotational speed value (f_{ROT}) based on a second temporal relation (R_{T}(r); T_{D}; FI(r)) between said first occurrence of said first reference position signal value (1; 1C, 0%) and said second occurrence of said second reference position signal value (1; 1C; 100%);
   said momentary rotational speed value (f_{ROT}) being indicative of said speed of rotation (f_{ROT}).

45. The method according to any preceding example, further comprising:
recording, in a memory, said time sequence of position signal sample values (P(i), P(j), P(q)); and
recording, in said memory, said time sequence of vibration sample values (Se(i), S(j), S(q)); wherein
said step of detecting the occurrence of a reference position signal value (1; 1C) involves
detecting the occurrence of said reference position signal value (1; 1C) in said recorded time sequence of position signal sample values (P(i), P(j), P(q)).

46. The method according to any preceding example, wherein:
said first tool wear state value (X1, R_{T}(r); T_{D}; FI(r)) is indicative of a first tool wear state of said machine (10) including a tool (5) for shearing and/or shaping a raw material workpiece (30).

47. The method according to any preceding example, wherein:
said first tool wear state value (X1, R_{T}(r); T_{D}; FI(r)) is indicative of a first tool wear state of said machine including a tool for shearing and/or shaping a raw material workpiece.

49. The method according to any preceding example, wherein:
said event signature is a peak amplitude value, and/or an average amplitude, and/or a ratio between an amplitude peak value and an average amplitude.

50. The method according to any preceding example, wherein:
Said speed of rotation (f_{ROT}) is a variable speed of rotation (f_{ROT}).

An example 51 relates to a system for shearing material, the system comprising:
a machine (10) having a tool (20) that rotates around an axis (60) at a speed of rotation (f_{ROT}) for shearing a raw material (30); wherein said tool has a first number (L) of tool edges (310) configured to engage said raw material, said tool edges being arranged at equal mutual distances on a perimeter of said tool; said first number (L) being at least two;
a vibration sensor (70) configured to generate an analogue measurement signal (S_{EA}) dependent on mechanical vibrations (V_{IMP}) from said tool edges (310) engaging said raw material (30);
a position sensor (170) configured to generate a position signal indicative of a rotational position of said rotating tool;
   a signal recorder adapted to record
      a time sequence of measurement sample values (Se(i), S(j)) of said digital measurement data signal (S_{MD}, S_{ENV}, S_{MD}), and
      a time sequence of said position signal values (P(i)), and
      time information (i, dt; j)
         such that
an individual measurement data value (S(j)) is associated with data indicative of time of occurrence of the individual measurement data value (S(j)), and such that
an individual position signal value (P(i)) is associated with data indicative of time of occurrence of the individual position signal value (P(i));
a signal processor adapted to detect the occurrence of an amplitude peak value in said recorded time sequence of measurement sample values (Se(i), S(j));
said signal processor being adapted to generate
   a second number of reference position signals per revolution of said tool, said second number of reference position signals being generated at equal angular distances based on said position signal; said second number being equal to said first number; and
   data indicative of a temporal duration between said reference position signal value occurrence and said amplitude peak value occurrence.

An example 52 relates to a system for monitoring a tool wear state of in a machine (10) having a tool (20) that rotates around an axis (60) at a speed of rotation (f_{ROT}) for shearing a raw material (30); said tool (20) having an tool edge attachment device (22) including a first number (L) of tool edges (310) configured to engage material as the tool (20) rotates about the axis (60), the system comprising
a device (170, 180) for generating a position signal (E_{P}, P(i), P(j), P(q)) indicative of a rotational position of said rotating tool (20), said position signal including a time sequence of position signal sample values (P(i), P(j), P(q));
a sensor (70, 70_{SUP}, 70_{TOOL}, 330) configured to generate a vibration signal (S_{EA}, S_{MD}, Se(i), S(j), S(q)) dependent on mechanical vibrations (V_{IMP}) emanating from rotation of said tool, said vibration signal (S_{EA}, Se(i), S(j), S(q)) including a time sequence of vibration sample values (Se(i), S(j), S(q));
a status parameter extractor (450) configured to detect a first occurrence of a first reference position signal value (1; 1C, 0%) in said time sequence of position signal sample values (P(i), P(j), P(q));
said status parameter extractor (450) being configured to detect a second occurrence of a second reference position signal value (1; 1C; 100%) in said time sequence of position signal sample values (P(i), P(j), P(q));
said status parameter extractor (450) being configured to detect a third occurrence of an event signature (S_{P}(r); S_{P}) in said time sequence of vibration sample values (Se(i), S(j), S(q));
said status parameter extractor (450) being configured to generate data indicative of a first tool wear state value (X1, R_{T}(r); T_{D}; FI(r)), wherein said generated data comprises determined vibrational magnitude values for rotational positions corresponding to at least one tool edge (310) engaging said raw material (30), and wherein said determined sets of magnitude and rotational position is based on said vibration signal (S_{EA}, Se(i), S(j), S(q)) and said a position signal (E_{P}, P(i), P(j), P(q)).

53. The system according to example 52, wherein the machine (10) is arranged to, upon the generate data indicative of a first tool wear state value (X1, R_{T}(r); T_{D}; FI(r)) being outside a first tool wear state limit value (X1_{LIMIT}) perform at least one of
halt the process,
initialize replacement of the tool (20), tool edges (310), and/or parts thereof,
execute an automatic process to replace the tool (20), tool edges (310), and/or parts thereof,
adapt the operation mode of the machine (10), and/or
generate a visual signal and/or a sound signal at the machine (10) for operators based on tool wear state of the tool (20).

54. The system according to example 52 or 53, wherein
Said regulator is configured to control a raw material feed rate set point (R_{S}S_{P}) in dependence on said first tool wear state value (X1, R_{T}(r); T_{D}; FI(r)), and wherein
a raw material feed rate (R_{S}) depends on said raw material feed rate set point (R_{S}S_{P}), said raw material feed rate (R_{S}) being an amount of raw material per time unit that is being fed into said machine (10).

55. The system according to example 52, 53, or 54, wherein
Said regulator is configured to control a rotational speed set point (f_{ROT_SP}) in dependence on said first tool wear state value (X1, R_{T}(r); T_{D}; FI(r)), and wherein
a rotational speed (f_{ROT}) depends on said rotational speed set point (f_{ROT_SP}).

56. The system according to according to any preceding example, wherein
said first tool wear state value (X1, R_{T}(r); T_{D}; FI(r)) is indicative of a proportion of a distance between two adjacent of said tool edges (310).

57. The system according to according to any preceding example, wherein

Said first tool wear state value (X1, R_{T}(r); T_{D}; FI(r)) is indicative of a position of the tool edges (310) engaging the raw material (30).

58. The system according to according to any preceding example, wherein
said event signature is indicative of an impact force (F_{IMP}) generated when a tool edge (310) of the rotating tool (20) interacts with a raw material workpiece (30).

59. The system according to according to any preceding example, wherein
said status parameter extractor (450) is configured to generate said first tool wear state value (X1, R_{T}(r); T_{D}; FI(r)) as a phase angle (FI(r)).

60. The system according to according to any preceding example, wherein
said status parameter extractor (450) is configured to generate said event signature as an amplitude value (S_{P}(r); S_{P}; |C_{L}(r)|; |Cₗ(r) |), and/or an average amplitude, and/or a ratio between an amplitude peak value and an average amplitude.

61. The system according to according to any preceding example, wherein
said status parameter extractor (450) comprises a Fourier Transformer configured to generate said first tool wear state value (X1, R_{T}(r); T_{D}; FI(r)) comprising at a frequency magnitude value for at least one frequency bin.

62. The system according to according to any preceding example, wherein
said status parameter extractor (450) is configured to count a total number of samples (N_{B}) from the first occurrence to the second occurrence, and
said status parameter extractor (450) is configured to count another number of samples (N_{P}) from the first occurrence to the third occurrence, and said status parameter extractor (450) is configured to generate said first tool wear state value (X1, R_{T}(r); T_{D}; FI(r)) based on said another number and said total number.

63. The system according to according to any preceding example, wherein
said status parameter extractor (450) is configured to count a total number of samples (N_{B}) from the first occurrence to the second occurrence, and
said status parameter extractor (450) is configured to count another number of samples (N_{P}) from the first occurrence to the third occurrence, and
said status parameter extractor (450) is configured to generate said first tool wear state value (R_{T}(r); T_{D}; FI(r)) based on a relation between said another number and said total number, wherein:
said relation between said another number and said total number is indicative of a tool edge (310) of the rotating tool (20) interacts with a raw material workpiece (30).

An example 64 relates to a method for determining and visualizing a tool wear state of in a machine (10) having a tool (20) rotating around an axis (60) at a speed of rotation (f_{ROT}) for shearing raw material (30); wherein the rotatable tool (20) has a certain number (L) of tool edges (310) for engaging material (30) when the tool rotates, thereby causing a mechanical vibration (V_{IMP}) having a repetition frequency (f_{R}) dependent on the rotational speed (f_{ROT}) of the rotatable tool (20),

the method comprises
receiving a measurement signal (E_{P}, P(i), P(j), P(q)) indicative of a rotational position of said rotating tool; and
receiving a signal (S_{FIMP}; S_{EA}, S_{MD}, Se(i), S(j), S(q)) indicative of said vibration (V_{IMP});
determining a value (X1; R_{T}(r); T_{D}; FI(r)) indicative of a tool edge (310) of the rotating tool (20) interacting with a raw material workpiece (30) based on said vibration signal and said position signal.

65. The method according to example 64, wherein receiving a signal (E_{P}, P(i), P(j), P(q)) indicative of a rotational position of said rotating tool comprises measuring rotation at said rotatable tool (20) utilizing at least one sensor 170.

66. The method according to example 64 or 65, wherein receiving a signal (S_{FIMP}; S_{EA}, S_{MD}, Se(i), S(j), S(q)) indicative of said vibration (V_{IMP}) comprises measuring vibrations at said rotatable tool (20) utilizing at least one sensor 70, and/or measuring vibrations at said raw material (30) utilizing at least one sensor 70, and/or measuring vibrations at a support 21 for said raw material (30) utilizing at least one sensor 70.

67. The method according to any preceding example, further comprising
controlling said machine (10) based on said value (X1, R_{T}(r); T_{D}; FI(r)) indicative of a tool edge (310) of the rotating tool (20) interacting with a raw material workpiece (30).

68. The method according to any preceding example, further comprising
providing a visual representation of said value (X1, R_{T}(r); T_{D}; FI(r)) indicative of a tool edge (310) of the rotating tool (20) interacting with a raw material workpiece (30).

69. The method according to example 68, wherein providing a visual representation comprises providing a polar diagram representing a time-series of values (X1, R_{T}(r); T_{D}; FI(r)) indicative vibrational magnitude and rotational position of a tool edge (310) of the rotating tool (20) interacting with a raw material workpiece (30)

70. An example computer program for performing the method according to any preceding example, the computer program comprising computer program code means adapted to perform the steps of the method according to any preceding example when said computer program is run on a computer.

71. The computer program according to any preceding example, the computer program being embodied on a computer readable medium.

An example 72 relates to a system for monitoring a tool wear state of a machine (10) having a rotatable tool (20) having a number (L) of tool edges (310) for engaging material when the tool rotates, thereby causing a vibration (V_{IMP}) having a repetition frequency (f_{R}) dependent on a speed of rotation (f_{ROT}) of said tool (20);
said system (150) comprising:
a monitoring unit (150A) for receiving
a signal (E_{P}, P(i), P(j), P(q)) indicative of a rotational position of said rotating tool, and
a signal (S_{FIMP}; S_{EA}, S_{MD}, Se(i), S(j), S(q)) indicative of said vibration (V_{IMP}), said monitoring unit being configured to extract, from said vibration signal and said position signal, a value (R_{T}(r); T_{D}; FI(r)) indicative of a tool edge (310) of the rotating tool (20) interacting with a raw material workpiece (30).

73. The system according to example 72, wherein said monitoring unit is arranged to receive
a signal (E_{P}, P(i), P(j), P(q)) comprising a time sequence of vibration sample values (Se(i), S(j), S(q)) indicative of vibration indicative of a rotational position of said rotating tool; and
a signal (S_{FIMP}; S_{EA}, S_{MD}, Se(i), S(j), S(q)) comprising a time sequence of vibration sample values (Se(i), S(j), S(q)) indicative of vibration; and wherein said monitoring unit is arranged to detect
a first occurrence of a first reference position signal value in said time sequence of position signal sample values (P(i), P(j), P(q)),
a second occurrence of a second reference position signal value in said time sequence of position signal sample values (P(i), P(j), P(q)), and
an occurrence of an event signature (S_{P}(r); S_{P}) in said time sequence of vibration sample values (Se(i), S(j), S(q)).

74. The system according to example 73, wherein said monitoring unit is arranged to determine said value (R_{T}(r); T_{D}; FI(r)) indicative of the tool edge (310) of the rotating tool (20) interacting with the raw material workpiece (30) based on said vibration signal and said position signal.

75. The system according to example 73 or 74, wherein said monitoring unit is arranged to determine
a first duration between said first and second occurrence of said first reference position signal value,
a second duration between occurrence of said event signature and said first and/or second occurrence of said first reference position signal value, and wherein said monitoring unit is arranged to generate data indicative of a first tool wear state value (X1, R_{T}(r); T_{D}; FI(r)) based on said first duration and second duration.

76. The system according to example 75, wherein said monitoring unit is arranged to determine a tool wear state of said machine (10) based on
an operating point limit value (FI_{LIMIT}(r)),
said first tool wear state value (X1, R_{T}(r); T_{D}; FI(r)), and
a operating point error value (FIERR(r)), wherein
   said operating point error value (FIERR(r)) depends on
said operating point limit value (FI_{LIMIT}(r)), and
said first tool wear state value (X1, R_{T}(r); T_{D}; FI(r)).

77. The system according to any of examples 72 to 76, comprising a measuring unit comprising at least one sensor (70,170) arranged at the machine (10), and arranged to provide said signal (E_{P}, P(i), P(j), P(q)) indicative of a rotational position of said rotating tool (20), and
provide said signal (S_{FIMP}; S_{EA}, S_{MD}, Se(i), S(j), S(q)) indicative of said vibration (V_{IMP}).

78. The system according to example 77, wherein said measuring unit comprises at least one vibration sensor, wherein said vibration sensor is
arranged at said rotatable tool (20) generating a vibration signal (S_{FIMP}; S_{EA}, S_{MD}, Se(i), S(j), S(q)); and/or
arranged, during operation, at said raw material workpiece (30) generating a vibration signal (S_{FIMP}; S_{EA}, S_{MD}, Se(i), S(j), S(q)); and/or
arranged at a support (21), configured to be in contact with the raw material workpiece (30) during operation, generating a vibration signal (S_{FIMP}; S_{EA}, S_{MD}, Se(i), S(j), S(q));
said vibration sensor being configured to generate said vibration signal based on vibration exhibited by said rotatable tool (20) engaging the raw material workpiece (30).

79. The system according to example 77 or 78, wherein said measuring unit comprises at least one position sensor is configured to generate a position signal indicative of a predetermined rotational position of said rotatable tool (20).

80. The system according to example 79, wherein at least one position marker (180) is provided at said rotatable tool (20), wherein said at least one position sensor is arranged to detect the at least one position marker (180), and wherein said position signal comprises a time sequence of position signal values (P(i), P(j), P(q)).

82. The system according to any of example 77 or 78, wherein the said measuring unit, said monitoring unit and/or said control unit are arranged at different locations and arranged to communicate via a communications network.

83. The system according to example 82, wherein said monitoring unit and/or said control unit are arranged at a location geographically distant from said machine (10).

84. The system according to any preceding example, wherein said monitoring unit and said measuring unit are arranged at the machine (10).

85. The system according to any preceding example, wherein said measuring unit comprises a first sensor for generating a first vibration signal (S_{FIMP}; S_{EA}, S_{MD}, Se(i), S(j), S(q)); said first sensor being configured to generate said first vibration signal based on vibration exhibited at a first part of said rotatable tool (20); and
a second sensor for generating a second vibration signal (S_{FIMP}; S_{EA}, S_{MD}, Se(i), S(j), S(q));
said second sensor being configured to generate said second vibration signal based on vibration exhibited at a second part of said rotatable tool (20);
wherein said monitoring unit is arranged to detect a fourth occurrence of an event signature (SP(r); S_{P}) in a time sequence of first vibration signal sample values (Se(i), S(j), S(q));
said monitoring unit being configured to detect a fifth occurrence of said event signature (S_{P}(r); S_{P}) in a time sequence of second vibration signal sample values (Se(i), S(j), S(q));
said monitoring unit being configured to generate data indicative of an order of occurrence between said fourth occurrence and said fifth occurrence; and,
determining said first tool wear state value (X1, R_{T}(r); T_{D}; FI(r)) indicative of a tool edge (310) of the rotating tool (20) interacting with a raw material workpiece (30).

An example 86 relates to computer implemented method of representing, on a screen display (210S) of a digital monitoring system, a tool wear state during a shearing process in a machine (10) having a tool (20) rotating around an axis (60) at a speed of rotation (f_{ROT}) for shearing raw material (30); wherein the rotatable tool (20) has a certain number (L) of tool edges (310) for engaging material (30) when the tool rotates, thereby causing a mechanical vibration (V_{IMP}) having a repetition frequency (f_{R}) dependent on the rotational speed (f_{ROT}) of the rotatable tool (20),

the method comprising:
receiving a signal (E_{P}, P(i), P(j), P(q)) indicative of a rotational position of the rotating tool (20),
generate a position reference value (1; 1C, 0%; 100%) based on said position signal (E_{P}, P(i), P(j), P(q)) such that said position reference value is provided a first number of times per revolution of the rotatable tool (20), said first number of position reference values being indicative of a first number of predetermined rotational positions of the rotatable tool (20), and
receiving a vibration signal (S_{FIMP}; S_{EA}, S_{MD}, Se(i), S(j), S(q)) based on the mechanical vibrations (V_{IMP}) emanating from rotation of said tool (20);
detecting an occurrence of an event signature (S_{P}(r); S_{P}) in said vibration signal (S_{FIMP}; S_{EA}, S_{MD}, Se(i), S(j), S(q));
displaying on said screen display (210S)
   a polar coordinate system, said polar coordinate system having
      a reference point (O), and
      a reference direction (0,360); and
      at least a first tool wear state indicator object (S_{P1}, T_{D1}), indicative of said tool wear state of said shearing process at a first polar angle (T_{D1}) in relation to said reference direction (0,360),
      said first polar angle (T_{D1}) being indicative of an angular position of the rotatable tool (20) at the occurrence of said event signature (S_{P}(r); S_{P}).

87. The method according to any preceding example, wherein
said first number is at least two and/or
said first number is equal to said certain number.

88. The method according to any preceding example, wherein
said vibration signal includes a time sequence of vibration sample values (Se(i), S(j), S(q)); and wherein
said detection includes detecting an occurrence of an event signature (S_{P}(r); S_{P}) in said time sequence of vibration sample values (Se(i), S(j), S(q)), and/or
said detection includes detecting an amplitude for an event signature (S_{P}(r); S_{P}) in said time sequence of vibration sample values (Se(i), S(j), S(q)) for each corresponding time based on receiving a vibration signal (S_{FIMP}; S_{EA}, S_{MD}, Se(i), S(j), S(q)).

An example 89 relates to computer implemented method of representing a tool wear state of a shearing process in a machine (10) on a screen display (210S) of a digital tool edge monitoring system for generating and displaying information relating to said shearing process in
a machine (10) having a tool (20) rotating around an axis (60) at a speed of rotation (f_{ROT}) for shearing raw material (30); wherein the rotatable tool (20) has a certain number (L) of tool edges (310) for engaging material (30) when the tool rotates, thereby causing a mechanical vibration (V_{IMP}) having a repetition frequency (f_{R}) dependent on the rotational speed (f_{ROT}) of the rotatable tool (20),
the method comprising:
receiving a signal (E_{P}, P(i), P(j), P(q)) indicative of a rotational position of the rotating tool (20),
receiving a vibration signal (S_{FIMP}; S_{EA}, S_{MD}, Se(i), S(j), S(q)) dependent on mechanical vibrations (V_{IMP}) emanating from rotation of said tool;
detecting an occurrence of an event signature (S_{P}(r); S_{P}) in said vibration signal (S_{FIMP}; S_{EA}, S_{MD}, Se(i), S(j), S(q));
displaying on said screen display
   a polar coordinate system, said polar coordinate system having
      a reference point (O), and
      a reference direction (0,360); and
      at least a first tool wear state indicator object (S_{P1}, T_{D1}), indicative of said tool wear state of said shearing process at a first polar angle (T_{D1}) in relation to said reference direction (0,360),
      said first polar angle (T_{D1}) being indicative of a temporal duration (TDI) between occurrence of said event signature (S_{P}(r); S_{P}) and occurrence of a rotational reference position of said rotating tool, and/or
      said first polar angle (T_{D1}) being indicative of a determined rotational position of said tool (20) for the occurrence of said event signature (S_{P}(r); S_{P}).

90. The method according to any preceding example, wherein said first tool wear state indicator object (S_{P1}, T_{D1}) is displayed, on said screen display, at a first radius (S_{P1}) from said reference point (O).

91. The method according to any preceding example, wherein
said first tool wear state indicator object (S_{P1}, T_{D1}) is displayed, on said screen display, at a first radius (S_{P1}) from said reference point (O), and wherein
said first radius (S_{P1}) is directly related to a determined amplitude of the vibration (V_{IMP}) at said polar angle (T_{D1}); said determined amplitude being indicative of an impact force (F_{IMP}) generated when a tool edge (310) interacts with the raw material workpiece (30).

92. The method according to any preceding example, wherein
said vibration signal includes a time sequence of vibration sample values (Se(i), S(j), S(q));

An example 93 relates to a system for monitoring a tool wear state of a machine including a rotatable tool configured with a certain number (L) of tool edges for engaging a raw material workpiece when the tool rotates, thereby causing a vibration having a repetition frequency dependent on a speed of rotation of said tool,
said system comprising:
a monitoring unit for receiving
   a position signal indicative of a predetermined rotational position of said rotating tool, said position signal including a time sequence of position signal values (P(i), P(j), P(q)); and
   a signal (S_{EA}, Se(i), S(j), S(q)) indicative of said vibration, said vibration signal (S_{EA}, Se(i), S(j), S(q)) including a time sequence of vibration sample values (Se(i), S(j), S(q)); wherein
said monitoring unit is configured to generate a position reference value based on said position signal such that said position reference value is provided a first number of times per revolution of said tool, said first number of position reference values being indicative of a first number of predetermined rotational positions of said rotatable tool, said first number of predetermined rotational positions corresponding to positions of said tool edges of said rotatable tool; said first number being at least two and/or said first number being at most equal to said certain number; and wherein
said monitoring unit is configured to extract, from said vibration signal, a signal signature that occurs when said tool edge (310) engages with a raw material workpiece (30); said signal signature being extracted from said vibration signal said certain number of times (L) per revolution of said tool;
said monitoring unit being configured to
   measure a first duration from occurrence of a first position reference value to occurrence of a second position reference value;
   measure a second duration
      between occurrence of said signal signature and said occurrence of said first position reference value, or
      between occurrence of said signal signature and said occurrence of said second position reference value; and
   generate a relation value based on said second duration and said first duration; said relation value being indicative of a momentary position of said raw material workpiece (30) between two said predetermined rotational positions of said rotatable tool (20) during rotation of said tool.

94. The system according to any preceding example, wherein said monitoring unit is arranged to extract said signal signature from said vibration signal said certain number of times per revolution of said tool.

95. The system according to any preceding example, wherein said monitoring unit being configured to generate a cycle position value at least once during one revolution of said tool (20), and/or generate said cycle position value said certain number of times during one revolution of said tool (20), and/or generate said cycle position value said certain number of times per revolution of said tool.

An example 96 relates to a system for monitoring a tool wear state of a machine (10) including a rotatable tool (20) configured with a certain number (L) of tool edges for engaging material when the tool rotates, thereby causing a vibration having a repetition frequency dependent on a speed of rotation of said tool,
said system comprising:
a monitoring unit for receiving
   a position signal indicative of a predetermined rotational position of said rotating tool, said position signal including a time sequence of position signal values (P(i), P(j), P(q)); and
   a signal (S_{EA}, Se(i), S(j), S(q)) indicative of said vibration, said vibration signal (S_{EA}, Se(i), S(j), S(q)) including a time sequence of vibration sample values (Se(i), S(j), S(q)); wherein
said monitoring unit is configured to generate a position reference value based on said position signal such that said position reference value is provided a first number of times per revolution of said tool, said first number of position reference values being indicative of a first number of predetermined rotational positions of said rotating tool, said first number being at least two; and wherein
said monitoring unit is configured to extract, from said vibration signal, a signal signature that occurs when said tool edge (310) engages with a raw material workpiece (30);
said monitoring unit being configured to
   measure a first duration from occurrence of a first position reference value to occurrence of a second position reference value;
   measure a second duration
      between occurrence of said signal signature and said occurrence of said first position reference value, or
      between occurrence of said signal signature and said occurrence of said second position reference value; and
   generate a relation value based on said second duration and said first duration; said relation value being indicative of a momentary position of said raw material workpiece (30) between two said predetermined rotational positions of said rotatable tool during rotation of said tool.

90. The system according to any preceding example, wherein said occurrence of said second position reference value being consecutive to said occurrence of said first position reference value.

An example 96 relates to a system for monitoring a tool wear state of a machine (10) including a rotatable tool (20) configured with a certain number (L) of tool edges for engaging material when the tool rotates by performing cycles of rotation, thereby causing a vibration having a repetition frequency (f_{R}) dependent on
a speed of rotation (f_{ROT}) of said tool (20),
   said system comprising:
   a monitoring unit for receiving
a position signal indicative of a predetermined rotational position of said rotating tool, and
a signal indicative of said vibration, wherein
said monitoring unit is configured to provide a rotational position indicator signal based on said position signal such that said rotational position indicator signal is provided a first number of times per revolution of said tool; and wherein
said monitoring unit is configured to extract, from said vibration signal, a signal signature that occurs when said tool edge (310) engages with a raw material workpiece (30);
   said monitoring unit being configured to
measure a first duration from the provision of a first rotational position indicator signal to the provision of a second rotational position indicator signal;
   measure a second duration
   between the occurrence of said signal signature and the occurrence of said first rotational position indicator signal, or
between the occurrence of said signal signature and the occurrence of said second rotational position indicator signal; and generate a cycle position value based on said second duration and said first duration; said cycle position value being indicative of a momentary position of said tool edge 310 between (in relation to) two consecutive predetermined rotational positions of said rotating tool 20; said first number being at least two.

An example 97 relates to a system for monitoring a tool wear state of a machine (10) including a rotatable tool (20) configured with a certain number of tool edges for engaging material when the tool rotates, thereby causing a vibration having a repetition frequency dependent on
a speed of rotation (f_{ROT}) of said tool, said system comprising:
   a monitoring unit for receiving
a position signal indicative of a predetermined rotational position of said rotating tool, and
a signal indicative of said vibration, wherein
said monitoring unit is configured to detect a first occurrence of a first reference position signal value (1; 1C, 0%) in a time sequence of position signal sample values (P(i), P(j), P(q));
said monitoring unit is configured to provide a rotational position indicator signal based on said position signal such that said rotational position indicator signal is provided a first number of times per revolution of said tool; and wherein
said monitoring unit is configured to extract, from said vibration signal, a signal signature that occurs when said tool edge engages (310) with a raw material workpiece (30); said monitoring unit being configured to
measure a first duration from the provision of a first rotational position indicator signal to the provision of a second rotational position indicator signal;
measure a second duration from the provision of said first rotational position indicator signal to the occurrence of said signal signature; and
generate a cycle position value based on said first duration and said second duration;

said cycle position value being indicative of a position of said tool edge 310 between two consecutive predetermined rotational positions of said rotating tool 20;

said certain number being at least two.

98. The system of example 97, wherein said monitoring unit is configured to generate said cycle position value at least twice per revolution of said rotating tool; Said certain number being at least two.

99. The system of example 97 or 98, wherein said monitoring unit being configured to generate a relation value based on said signal signature and two position signals, said relation value being generated at least twice per revolution of said rotating tool; Said certain number being at least two.

An example 100 relates to a shearing machine arrangement (730; 780; 720) including a rotatable tool (20) having a number (L) of tool edges (310) for engaging material (30) when the tool rotates, thereby causing a vibration (V_{IMP}) having a repetition frequency (f_{R}) dependent on a speed of rotation (f_{ROT}) of said tool (20);
the shearing machine arrangement comprising
   a vibration sensor for generating a signal (S_{FIMP}; S_{EA}, S_{MD}, Se(i), S(j), S(q)) indicative of said vibration (V_{IMP});
   a position sensor for generating a signal (E_{P}, P(i), P(j), P(q)) indicative of a rotational position of said rotating tool, and
   a first shearing machine arrangement data port (800, 820), connectable to a communications network;
   a first shearing machine arrangement communications device (790) being configured to deliver, via said first shearing machine arrangement data port (820):
   data indicative of said vibration signal (S_{FIMP}; S_{EA}, S_{MD}, Se(i), S(j), S(q)), and
   data indicative of said position signal (E_{P}, P(i), P(j), P(q)).

101. The shearing machine arrangement of example 100, wherein said communications network comprises the world wide internet, also known as the Internet.

102. The shearing machine arrangement according to example 100 or 101, further comprising:
a second shearing machine arrangement data port (800B; 820B), connectable to a communications network;
a second shearing machine arrangement communications device (790B) being configured to receive, via said second shearing machine arrangement data port (800B; 820B):
   data (T_{D}; FI(r); R_{T}(r); X1(r); X2, S_{P}(r); X5, f_{ROT}, dRT(r), X4; dSp(r), X3) indicative of a tool wear state of said shearing process.

103. The shearing machine arrangement according to any preceding example, further comprising:
a second shearing machine arrangement data port (800B; 820B), connectable to a communications network;
a second shearing machine arrangement communications device (790B) being configured to receive, via said second shearing machine arrangement data port (800B; 820B):
   data (R_{T}(r); T_{D}; FI(r); X1(r); X2, S_{P}(r), f_{ROT}, dRT(r); d S_{P}(r)) indicative of a tool wear state (X) of said shearing process.

104. The shearing machine arrangement according to any preceding example, further comprising:
a Human Computer Interface (HCI; 210) for enabling user input/output; and
a screen display (210S); and wherein
said Human Computer Interface (HCI; 210) is configured to display, on said screen display (210S), data (T_{D}; FI(r); R_{T}(r); X1(r); X2, S_{P}(r); X5, f_{ROT}, dRT(r), X4; dSp(r), X3) indicative of said tool wear state (X) during said shearing process.

105. The shearing machine arrangement according to any preceding example, further comprising:
a Human Computer Interface (HCI; 210) for enabling user input/output; and
a screen display (210S); and wherein
said Human Computer Interface (HCI; 210) is configured to display, on said screen display (210S), data (Tp; FI(r); R_{T}(r); X1(r); X2, S_{P}(r); X5, f_{ROT}, dRT(r), X4; dSp(r), X3) indicative of said tool wear state (X) during said shearing process.

106. The shearing machine arrangement according to any preceding example, wherein:
the second shearing machine arrangement communications device (790B) is
said first shearing machine arrangement communications device (790) and
said second shearing machine arrangement data port (800B; 820B) is
said first shearing machine arrangement data port (820).

107. The shearing machine arrangement according to any preceding example, further comprising:
a control module (150, 150B) configured to receive said data (T_{D}; FI(r); R_{T}(r); X1(r); X2, S_{P}(r); X5, f_{ROT}, dRT(r), X4; dSp(r), X3) indicative of a tool wear state (X) during said shearing process.

108. The shearing machine arrangement according to any preceding example, wherein:
said control module (150, 150B) includes
a regulator (755) configured to control a raw material feed rate into said machine (10) based on said data (Tp; FI(r); R_{T}(r); X1(r); X2, S_{P}(r); X5, f_{ROT}, dRT(r), X4; dSp(r), X3) indicative of a tool wear state (X) during said shearing process; and/or
   a regulator configured to control the rotational speed (f_{ROT}) of the rotatable tool (20) based on said data (T_{D}; FI(r); R_{T}(r); X1(r); X2, S_{P}(r); X5, f_{ROT}, dRT(r), X4; dSp(r), X3) indicative of a tool wear state (X) during said shearing process; X1(r); X2, S_{P}(r); X5, f_{ROT}, dRT(r), X4; dSp(r), X3) indicative of a tool wear state (X) during said shearing process.

109. The shearing machine arrangement according to any preceding example, wherein:
said control module (150, 150B) includes a regulator (755) configured to control a raw material feed rate into said machine including a tool for shearing and/or shaping a raw material workpiece based on said value (X1; R_{T}(r); T_{D}; FI(r)) indicative of a tool edge (310) of the rotating tool (20) interacting with a raw material workpiece (30), and/or a regulator configured to control the rotational speed (f_{ROT}) of the rotatable tool (20) based on said value (X1; R_{T}(r); T_{D}; FI(r)) indicative of a position of a tool edge (310) of the rotating tool (20) interacting with a raw material workpiece (30).

An example 109B relates to a monitoring apparatus (870; 880; 150; 150A) for cooperation with a shearing machine arrangement according to any preceding example, or according to any of examples 100 to 109,
the monitoring apparatus comprising:
a monitoring apparatus data port (920, 920A), connectable to a communications network (810), for data exchange with a shearing machine arrangement; wherein
said monitoring apparatus (870; 880; 150; 150A) is configured to receive, via said monitoring apparatus data port (920, 920A):
   data indicative of a vibration signal (S_{FIMP}; S_{EA}, S_{MD}, Se(i), S(j), S(q)), and
   data indicative of a position signal (E_{P}, P(i), P(j), P(q));
the monitoring apparatus (870; 880; 150; 150A) further comprising:
   a status parameter extractor (450) being configured to generate data (Tp; FI(r); R_{T}(r); X1(r); X2, S_{P}(r); X5, f_{ROT}, dRT(r), X4; dSp(r), X3) indicative of a tool wear state (X) during said shearing process based on said vibration signal and said position signal.

110. The monitoring apparatus according to any preceding example, wherein:
said monitoring apparatus (870; 880; 150; 150A) is configured to transmit, via said monitoring apparatus data port (920, 920A):
   generated data (T_{D}; FI(r); R_{T}(r); X1(r); X2, S_{P}(r); X5, f_{ROT}, dRT(r), X4; dSp(r),
X3) indicative of said tool wear state (X) to said shearing machine arrangement during said shearing process.

111. The monitoring apparatus according to any preceding example, wherein said monitoring apparatus (870; 880; 150; 150A) is configured to generate and transmit a value (X1; R_{T}(r); T_{D}; FI(r)) indicative of a tool edge (310) of the rotating tool (20) interacting with a raw material workpiece (30).

112. The monitoring apparatus according to any preceding example, wherein said monitoring apparatus (870; 880; 150; 150A) is configured to utilize a server (830) at a remote server location (860) to
generate and/or transmit a value (X1; R_{T}(r); T_{D}; FI(r)) indicative of a tool edge (310) of the rotating tool (20) interacting with a raw material workpiece (30) to said shearing machine arrangement, and/or
store and/or retrieve
   data indicative of a vibration signal (S_{FIMP}; S_{EA}, S_{MD}, Se(i), S(j), S(q)), and/or
   data indicative of a position signal (E_{P}, P(i), P(j), P(q)).

113. The monitoring apparatus according to any preceding example, wherein said monitoring apparatus (870; 880; 150; 150A) comprises a memory storage (890) and said monitoring apparatus is configured to
store on and/or retrieve from said memory storage (890),
   data indicative of a vibration signal (S_{FIMP}; S_{EA}, S_{MD}, Se(i), S(j), S(q)), and/or
   data indicative of a position signal (E_{P}, P(i), P(j), P(q)).

An example 114 relates to an assembly for cooperation with a shearing machine arrangement according to any preceding example, or according to any of examples 100 to 113, the assembly comprises
a monitoring module (150; 150A),
a control module (150; 150B), and at least one assembly data port (920, 920A, 920B), connectable to a communications
network (810), for data exchange with a shearing machine arrangement; wherein said monitoring module (150; 150A) is configured to receive, via said assembly data port port (920, 920A):
   data indicative of a vibration signal (S_{FIMP}; S_{EA}, S_{MD}, Se(i), S(j), S(q)), and
   data indicative of a position signal (E_{P}, P(i), P(j), P(q));
the monitoring module (150; 150A) being configured to generate data (X1; T_{D}; FI(r); R_{T}(r); X1(r); X2, S_{P}(r); X5, f_{ROT}, dRT(r), X4; dSp(r), X3) indicative of a tool wear state (X) during said shearing process based on said vibration signal and said position signal, said control module (150; 150B) is arranged to communicate with said shearing machine arrangement via an assembly data port (920, 920B), and said control module (150, 150B) includes
a regulator (755) configured to control a raw material feed rate into said machine based on said data (Tp; FI(r); R_{T}(r); X1(r); X2, S_{P}(r); X5, f_{ROT}, dRT(r), X4; dSp(r), X3) indicative of a tool wear state (X) during said shearing process; and/or
a regulator configured to control the rotational speed (f_{ROT}) of the rotatable tool (20) based on said data (T_{D}; FI(r); R_{T}(r); X1(r); X2, S_{P}(r); X5, f_{ROT}, dRT(r), X4; dSp(r), X3) indicative of a tool wear state (X) during said shearing process.

115. The assembly according to any preceding example, wherein the assembly is arranged at a location geographically distant from said machine (10).

116. A method for generating information relating to a tool wear state (X) of a machine (10) having a tool (20) that rotates at a speed of rotation (f_{ROT}) for shearing a raw material (30); said tool (20) having a first number (L) of tool edges (310) configured to engage raw material (30) as the tool (20) rotates about an axis (60), thereby causing a vibration (V_{IMP}) having a first repetition frequency (f_{R}) dependent on the speed of rotation (f_{ROT}); the method comprising
receiving a position signal (E, P, P(i), P(j), P(q)) indicative of a rotational position of said rotating tool (20) such that said position signal (E_{P}, P(i), P(j), P(q)) has a second repetition frequency (f_{RP}) dependent on said speed of rotation (f_{ROT});
receiving a vibration signal (S_{EA}, Se(i), S(j), S(q)) dependent on mechanical vibrations (V_{IMP}) emanating from rotation of said tool, said vibration signal (S_{EA}, Se(i), S(j), S(q)) including a time sequence of vibration sample values (Se(i), S(j), S(q));
detecting, in said time sequence of vibration sample values (Se(i), S(j), S(q)), an event signature (S_{P}(r); S_{P}) having an event signature occurrence frequency (f_{R}), said event signature occurrence frequency being equal to said first repetition frequency (f_{R});
generating, based on said event signature occurrence frequency, a periodic event signal exhibiting said first number (L) of periods per revolution of said tool during operation of the machine (10);
generating, based on said position signal (E, P, P(i), P(j), P(q)), a periodic reference signal exhibiting said first number (L) of periods per revolution of said tool during operation of said machine (10);
generating data indicative of a first tool wear state value (X1(r), R_{T}(r); T_{D}; FI(r)) between
said periodic event signal, and
said periodic reference signal; said temporal relation being indicative of said tool wear state (X) of the machine (10).

117. The method according to any preceding example, wherein:
said periodic event signal is a sinusoidal and event signal; and
said periodic reference signal is a sinusoidal reference signal; and
said data indicative of a first tool wear state value (X1, R_{T}(r); T_{D}; FI(r)) is indicative of a first tool wear state value (X1, R_{T}(r); T_{D}; FI(r)) between
said sinusoidal event signal, and
said sinusoidal reference signal.

118. The method according to any preceding example, wherein:
said periodic reference signal is generated based on
said first number (L) and
said position signal (E, P, P(i), P(j), P(q))
   such that said periodic reference signal is configured to exhibit said first number (L) of periods per revolution of said tool during operation of said machine (10).

119. The method according to any preceding example, wherein:
said periodic reference signal is generated based on
said first number (L) and
said position signal (E, P, P(i), P(j), P(q))
such that said periodic reference signal is configured to exhibit
said first number (L) of periods per revolution of said tool during operation of said machine (10), and
a reference amplitude value, such as a peak value, based on a certain position signal value (E, P, P(i), P(j), P(q)).

120. The method according to any preceding example, wherein:
said periodic reference signal is configured to exhibit least two periods per revolution of said tool during operation of said machine (10).

121. The method according to any preceding example, wherein:
said position signal includes a time sequence of position signal sample values (P(i), P(j), P(q)); and
said second repetition frequency (fRP) is a frequency lower than, or equal to, said first repetition frequency (f_{R}).

122. A method for generating information relating to a tool wear state (X) of a machine (10) including a rotatable tool (20) having a first number (L) of tool edges (310) for engaging material (30) when the tool rotates, thereby causing a vibration having a repetition frequency dependent on a speed of rotation of said tool, the method comprising the steps:
receive a position signal relating to rotational position of said rotating tool, and detect, in a time sequence of position signal values (P(i), P(j), P(q)), a first occurrence of a first reference position signal value (1; P_{S}) indicative of a predetermined rotational position of said rotating tool;
provide a reference signal (1, 1C, P_{S}, P_{C}, 0%) based on said position signal such that said reference signal is provided a certain number (L) of times per revolution of said tool; said certain number being at least two; and receive a signal indicative of said vibration, detect, in said vibration signal, a signal event signature that occurs when a said tool edge (310) engages with a raw material workpiece (30);
measure a first duration (100%) from the provision of a first reference signal (1, 1C, P_{S}, P_{C}, 0%) to the provision of a subsequent reference signal (1, 1C, P_{S}, P_{C}, 100%); and
measure a second duration between the provision of a reference signal to the occurrence of a subsequent said signal event signature, or measure the second duration between the occurrence of said signal event signature to the provision of a subsequent reference signal; and
generate a set of cycle position values based on said second duration and said first duration (100%); said set of cycle position values and a corresponding set of said vibration signals being indicative of said tool wear state (X) of the machine (10).

123. The method according to any preceding example, wherein:
said cycle position value is indicative of a position of said tool edge (310) between two consecutive predetermined rotational positions (P_{S}, P_{C}) of said rotating tool.

124. The method according to any preceding example, wherein:
a said tool edge (310) is positioned, on said tool, in a mutually equidistant manner in relation to another said tool edge (310).

126. The method according to any preceding example or according to any example dependent on example 116, further comprising:
generating said first tool wear state value (X1, R_{T}(r); T_{D}; FI(r)) as a phase angle (FI(r)) between
said periodic event signal, and
said periodic reference signal.

127. The method according to any preceding example, wherein:
said first tool wear state value (X1, R_{T}(r); T_{D}; FI(r)) is indicative of a proportion of a certain distance, said certain distance being the distance between two adjacent tool edges (310)

131. The method according to any preceding example, wherein:
said operating point error value (FI_{ERR}(r)) depends on a difference between said operating point limit value (FI_{LIMIT}(r)), and said first tool wear state value (X1, R_{T}(r); T_{D}; FI(r)).

132. The method according to any preceding example or according to example 130 or 131, further comprising
controlling a raw material feed rate set point (R_{SSP}) in dependence on said operating point limit value (FI_{LIMIT}(r)), wherein
a raw material feed rate (R_{S}) depends on said raw material feed rate set point (RSSP), said raw material feed rate (R_{S}) being an amount of raw material per time unit that is being fed into said machine (10).

133. The method according to any preceding example or according to any of examples 130-132, further comprising
controlling speed of rotation set point (f_{ROT}_SP) in dependence on said operating point limit value (FI_{LIMIT}(r)), and wherein
said speed of rotation (f_{ROT}) depends on said speed of rotation set point (f_{ROT_SP}).

134. The method according to any preceding example or according to any of claims 130 to 133, wherein:

said machine (10) is located at a machine location (780), and wherein
at least a part of the method is performed at a location (870) remote from said machine location (780), and/or wherein
at least a part of the method is performed at a remote location (870), said remote location (870) being geographically separated from the machine location (780) by a geographic distance; wherein the method further comprises the step:
transfer at least some of said signals between said machine location (780) and said remote location (870).

135. The method according to any preceding example, wherein
said geographic distance exceeds one kilometre; and/or wherein
said machine location (780) is in a first country constituting a first jurisdiction, and
said remote location (870) is in a second country constituting a second jurisdiction such that at least a part of the method is performed in said first country and at least a part of said method is performed in said second country.

136. The method according to any preceding example, wherein
at least a part of said signal transfer is performed by a communications network (810), such as e.g. the Internet.

137. The method according to any preceding example or according to any of examples 122-136, wherein
said event signature is indicative of an impact force (F_{IMP}) generated when a tool edge (310) of the rotating tool (20) interacts with a raw material workpiece (30).

138. The method according to any preceding example or according to any of examples 122-137, wherein
said event signature is an amplitude value (S_{P}(r); S_{P}; |C_{L}(r)|; |Cₗ(r) |), such as e.g. an average vibration amplitude value for a range of adjacent rotational positions of the tool.

139. The method according to any preceding example or according to any of examples 122-138, wherein
said first tool wear state value (X1, R_{T}(r); T_{D}; FI(r)) is generated by a Fourier Transformer configured to generate said first tool wear state value (X1, R_{T}(r); T_{D}; FI(r)).

140. The method according to any preceding example or according to any of examples 126-139, wherein
said first duration, between two consecutive reference signals, is measured by
counting a total number of samples (N_{B}) from the occurrence of a first reference signal to the occurrence of the consecutive reference signal; and
said second duration is measured by
counting another number of samples (N_{P}) between the provision of a reference signal to the occurrence of a subsequent said signal event signature, or
by counting another number of samples (N_{P}) between the occurrence of said signal event signature to the provision of a subsequent reference signal; the method further comprising:
generating said first tool wear state value (X1, R_{T}(r); T_{D}; FI(r)) based on said another number (N_{P}) and said total number (N_{B}).

141. The method according to any preceding example or according to any of examples 122-140, wherein
said first tool wear state value (X1, R_{T}(r); T_{D}; FI(r)) is based on a relation between said another number and said total number.

142. The method according to any preceding example or according to any of examples 122-141, wherein
said first tool wear state value (X1, R_{T}(r); T_{D}; FI(r)) is generated by a status parameter extractor (450) configured to generate said first tool wear state value (X1, R_{T}(r); T_{D}; FI(r)).

143. A method of operating a shearing process in a machine (10) including a rotatable tool (20) having a first number (L) of tool edges (310) configured to engage raw material when the tool (20) rotates for shearing a raw material (30) so as to generate output material (95), thereby causing a vibration (V_{IMP}) having a first repetition frequency (f_{R}) dependent on a speed of rotation (U1, f_{ROT}) when a tool edge (310) engages with a raw material workpiece (30);
the method comprising
   receiving a vibration signal (S_{FIMP}; S_{EA}, S_{MD}, Se(i), S(j), S(q)) indicative of said vibration (V_{IMP});
   receiving a position signal (E_{P}, P(i), P(j), P(q)) indicative of a rotational position of said rotating tool;
   generating at least one tool wear state value (X1(r), FI(r), T_{D}, R_{T}(r); X2, S_{P}(r); X3, dSp(r); X4, dRT(r); X5, f_{ROT}; X6, X7) indicative of a tool wear state (X) of said shearing process
   based on said vibration signal and said position signal; said at least one tool wear state value including a magnitude (Sp_{L}(r)) corresponding to FFT magnitude of a frequency of order L for said received vibration signal (S_{FIMP}; S_{EA}, S_{MD}, Se(i), S(j), S(q)).

145. The method according to any of examples 143 to 144, further comprising providing a raw material feed rate set point value (U2_{SP}, R_{SSP}) for setting a raw material feed rate (U2, R_{S}); said raw material feed rate (U2, R_{S}) being an amount of raw material per time unit that is being fed into a machine (10), thereby influencing said output material state (Y) based on said tool wear state (X); said raw material having an raw material size distribution.

146. The method according to any of examples 143 to 145, further comprising
analysing at least a portion of said output material (95);
generating at least one output material measurement value (Y1; Y2) based on said output material analysis; said at least one output material measurement value (Y1; Y2) being indicative of a output material state (Y(r)).

147. The method according to any preceding example or according to any of examples 143 to 146, further comprising
performing correlation of
said at least one output material measurement value (Y1; Y2) and
   said at least one tool wear state value (X1(r), FI(r), T_{D}, R_{T}(r); X2, S_{P}(r); X3, dSp(r); X4, dRT(r); X5, f_{ROT}; X6, X7); and
generating, by said correlation,
a correlation data set indicative of a causal relationship between
said at least one tool wear state value (X1(r), T_{D}, FI(r), R_{T}(r); X2, S_{P}(r); X3, dSp(r); X4, dRT(r); X5, f_{ROT}; X6, X7) and
said at least one output material measurement value (Y1; Y2) and/or
a correlation data set indicative of a causal relationship between
said tool wear state (X) and
said output material state (Y(r)).

148. The method according to any preceding example or according to any of examples 143 to 147, further comprising
receiving data indicative of an output material state limit (Y_{LIMIT}(r));
generating at least one tool wear state limit value (X1_{LIMIT}; FI_{LIMIT}) based on
said data indicative of said output material state limit (Y_{LIMIT}(r)) and
said correlation data set.

149. The method according to any preceding example or according to any of examples 143 to 148, further comprising
receiving data indicative of an output material state limit (Y_{LIMIT}(r));
generating at least one tool wear state limit value (X1_{LIMIT}; FI_{LIMIT}) based on
said data indicative of said output material state limit (Y_{LIMIT}(r)) and
a correlation data set; and
   wherein
said correlation data set is
indicative of a causal relationship between
said at least one tool wear state value (X1(r), T_{D}, FI(r), R_{T}(r); X2, S_{P}(r); X3, dSp(r); X4, dRT(r); X5, f_{ROT}; X6, X7) and
said at least one output material measurement value (Y1; Y2) and/or wherein said correlation data set is
indicative of a causal relationship between
said tool wear state (X) and
said output material state (Y(r)).

150. The method according to any preceding example or according to any of examples 143 to 149, further comprising
displaying, by a user interface (210, 210S, 240, 250), said at least one tool wear state limit value (X1_{LIMIT}; FI_{LIMIT})
displaying, by said user interface (210, 210S, 240, 250), said at least one tool wear state value (X1(r) T_{D}, FI(r), R_{T}(r); X2, S_{P}(r); X3, dSp(r); X4, dRT(r); X5, f_{ROT}; X6, X7) for enabling an operator (230) to adjust a machine set point value (U; U1; U2; U3);
receiving, by said user interface (210, 210S, 240, 250), a machine set point value (U; U1; U2; U3); said received machine set point value including a received raw material feed rate set point value (U2_{SP}, RSSP);
providing said received raw material feed rate set point value (U2_{SP}, RSSP) so that it sets said raw material feed rate (U2, R_{S}) thereby influencing said tool wear state (X) to control or influence said output material state (Y(r)).

151. The method according to any preceding example or according to any of examples 143 to 150, further comprising
controlling said output material state (Y(r)) based on
   said at least one tool wear state limit value (X1_{LIMIT}; FI_{LIMIT}),
   said at least one tool wear state value (X1(r), FI(r); X6(r), X7), and
   a tool wear state error value (X1_{ERR}(r), FI_{ERR}(r); X6_{ERR}, X7_{ERR}),
      wherein
said tool wear state error value (X1_{ERR}(r), FI_{ERR}(r); X6_{ERR}, X7_{ERR}) depends on
said at least one tool wear state limit value (X1_{LIMIT}; FI_{LIMIT}), and
said at least one tool wear state value (X1(r), FI(r); X6(r), X7).

152. The method according to any preceding example or according to any of examples 143 to 151, further comprising
controlling a machine set point (U; U1; U2; U3) including said raw material feed rate set point value (U2_{SP}, R_{SSP}), thereby influencing said tool wear state (X) to control or affect said at least one output material measurement value (Y1; Y2) and/or said output material state (Y(r)), based on
   said at least one tool wear state limit value (X1_{LIMIT}; FI_{LIMIT}),
   said at least one tool wear state value (X1(r), FI(r); X6(r), X7), and
   a tool wear state error value (X1_{ERR}(r), FI_{ERR}(r); X6_{ERR}, X7_{ERR}),
      wherein
said tool wear state error value (X1_{ERR}(r), FI_{ERR}(r); X6_{ERR}, X7_{ERR}) depends on
said at least one tool wear state limit value (X1_{LIMIT}; FI_{LIMIT}), and
said at least one tool wear state value (X1(r), FI(r); X6(r), X7).

154. The method according to any preceding example or according to any of examples 143 to 152, wherein
said output material state (Y(r)) is a momentary output material size distribution (Y), said momentary output material size distribution being indicative an output material distribution measured during a measurement moment time period, said measurement moment time period being equal to or shorter than ten minutes.

155. The method according to any preceding example or according to any of examples 122 to 154, further comprising
generating, based on said position signal, a second number (L) of static position indications or a second number (L) of static position indication values (P1, P_{C}, P1, P2, P3, PL), wherein a static position indication value is indicative of an immobile rotational position;
generating, based on said vibration signal, a first number (L) of variable position indications or variable position indication values, wherein a variable position indication value is indicative of a variable position between two of said immobile rotational positions.

156. The method according to any preceding example or according to example 155, further comprising
generating, based on said variable position indications and said static position indications, a relation value; said relation value being indicative of a position of said raw material workpiece (30) between two of said static positions.

162. The method according to any of examples 143 to 156, wherein
the machine (10) includes a rotatable tool (20) having a first number (L) of tool edges (310) configured to engage material when the tool (20) rotates for shearing the raw material workpiece (30) so as to generate output material (95).

163. A method of operating a shearing process in a machine (10) including a rotatable tool (20) having a first number (L) of tool edges (310) configured to engage material when the tool (20) rotates for shearing a raw material (30) so as to generate output material (95) including output material (95) at a machine output (200), thereby causing a vibration (V_{IMP}) having a first repetition frequency (f_{R}) dependent on a speed of rotation (U1, f_{ROT}) when a tool edge (310) engages with a raw material workpiece (30);
the method comprising
   receiving a vibration signal (S_{FIMP}; S_{EA}, S_{MD}, Se(i), S(j), S(q)) indicative of said vibration (V_{IMP});
   receiving a position signal (E_{P}, P(i), P(j), P(q)) indicative of a rotational position of said rotating tool;
   generating, based on said vibration signal and said position signal, at least one tool wear state value (X1(r), FI(r), T_{D}, R_{T}(r); X2, S_{P}(r); X3, dSp(r); X4, dR_{T}(r); X5, f_{ROT}; X6, X7) indicative of a tool wear state (X) of said shearing process; said at least one tool wear state value being indicative of a position of the raw material workpiece (30).

165. The method according to any of examples 163-164 or according to any of examples 143 to 163, further comprising
providing a raw material feed rate set point value (U2_{SP}, R_{SSP}) for setting a raw material feed rate (U2, R_{S}); said raw material feed rate (U2, R_{S}) being an amount of raw material (30) per time unit that is being fed into an input (100) of a machine (10) thereby influencing said output material state (Y) based on said tool wear state (X); said raw material (30) having a raw material size distribution.

166. The method according to any of examples 163 to 165 or according to any of examples 143 to 165, further comprising
analysing at least a portion of said output material (95);
generating at least one output material measurement value (Y1; Y2) based on said output material analysis.

It is to be understood that each output material measurement value (Y1; Y2) may be associated with a timestamp or a time period corresponding to said output material analysis.

167. The method according to example 162 or any of examples 143 to 145 or according to any of examples 143 to 166, wherein
said at least one output material measurement value (Y1; Y2) is indicative of an output material quality measure.

168. The method according to example 167 or any of examples 143 to 145 or according to any of examples 143 to 167, wherein
said at least one output material measurement value (Y1; Y2) is indicative of a output material state (Y); the output material state (Y) being a momentary state of the output material (95).

169. The method according to any of examples 166-168 or according to any of examples 143 to 145 or according to any of examples 143 to 168, wherein
said at least one output material measurement value (Y1; Y2) is one or several selected from the group:
a value (Y1; Y2) indicative of a mass per time unit of said output material (95);
a value (Y1; Y2) indicative of a mass per time unit of said output material (95);
a value (Y1; Y2) indicative of a mass per time unit of said output material (95), wherein said output material (95) has an output material size in a range between a smallest output material size limit value and a largest output material size limit value;
a value (Y1; Y2) indicative of a percentage of said output material (95) having an output material size in a range between a smallest output material size limit value and a largest output material size limit value;
a value (Y1; Y2) indicative of an output material size distribution (Y), such as a standard deviation;
a value (Y1; Y2) indicative of an output material size (Y1; Y2).

170. The method according to example 169, wherein
said output material size (Y1; Y2) is at least one selected from the group:
   an output material median size value;
   an output material mean size value;
   an output material median diameter value; and
   an output material mean diameter value.

171. The method according to example 169, wherein
said output material size limit values are at least one selected from the group:
   an output material diameter value; and
   an output material maximum width value.

It is to be understood that said smallest output material size limit value may be set to zero. Said range between the smallest output material size limit value and the largest output material size limit value may be defined even with the smallest output material size limit value is omitted, or the largest output material size limit value is omitted, whereby the range becomes the values below the largest output material size limit value, or values above the smallest output material size limit value respectively.

This solution advantageously enables identification and/or determination of a cause and effect relationship between the tool wear state (X) of the rotatable tool and the at least one output material measurement value (Y1,Y2).

Moreover, this solution advantageously enables identification and/or determination of a cause and effect relationship between the tool wear state (X) of the rotatable tool and the output material state (Y).

This solution is versatile in that it allows for the defining of an output material state limit (Y_{LIMIT}), and for testing of alternative tool wear states (X) of the shearing process in order to search and identify an tool wear state of the rotatable tool that causes or produces a output material state (Y) as within the output material state limit (Y_{LIMIT}). Moreover, the recording of a detected momentary shearing process tool wear state (X(r)) in association with a corresponding momentary output material state (Y(r)), produces correlation data indicative of a causal relationship between
a momentary shearing process tool wear state (X(r)) and
a corresponding momentary output material states (Y(r)).

By performing repeated recording of a number of mutually different detected momentary shearing process tool wear states (X(r)) in association with momentary output material states (Y(r)) that were caused by the respective momentary shearing process tool wear states (X(r)), a correlation data set may be produced. Such a correlation data set is indicative of a causal relationship between
a number of momentary shearing process tool wear states (X(r)) and
a number of corresponding momentary output material states (Y(r)).

172. The method according to any of examples 166-171 or according to any of examples 143 to 145 or according to any of examples 143 to 171, further comprising
performing correlation of
said at least one output material measurement value (Y1; Y2) and
   said at least one tool wear state value (X1(r), FI(r), T_{D}, R_{T}(r); X2, S_{P}(r); X3, dS_{P}(r); X4, dR_{T}(r); X5, f_{ROT}; X6, X7); and
generating, by said correlation,
a correlation data set indicative of a causal relationship between
said at least one tool wear state value (X1(r), T_{D}, FI(r), R_{T}(r); X2, S_{P}(r); X3, dS_{P}(r); X4, dR_{T}(r); X5, f_{ROT}; X6, X7) and
said at least one output material measurement value (Y1; Y2) and/or
a correlation data set indicative of a causal relationship between
said tool wear state (X(r)) and
said output material state (Y(r).

173. The method according to any of examples 166-172 or according to any of examples 143 to 145 or according to any of examples 143 to 172, further comprising
receiving data indicative of an output material state limit (Y_{LIMIT}(r));
generating at least one tool wear state limit value (X1_{LIMIT}; FI_{LIMIT}) based on
said data indicative of said output material state limit (Y_{LIMIT}(r)) and
a correlation data set.

174. The method according to any of examples 166-173 or according to any of examples 143 to 145 or according to any of examples 143 to 173, further comprising
receiving data indicative of an output material state limit (Y_{LIMIT}(r));
generating at least one tool wear state limit value (X1_{LIMIT}; FI_{LIMIT}) based on
said data indicative of said output material state limit (Y_{LIMIT}(r)) and
a correlation data set;
   wherein
said correlation data set is
indicative of a causal relationship between
said at least one tool wear state value (X1(r), T_{D}, FI(r), R_{T}(r); X2, S_{P}(r); X3, dSp(r); X4, dR_{T}(r); X5, f_{ROT}; X6, X7) and
said at least one output material measurement value (Y1; Y2) and/or wherein said correlation data set is
indicative of a causal relationship between
said output material state limit (Y_{LIMIT}(r)) and
a corresponding reference tool wear state limit (X_{LIMIT}(r))

175. The method according to any of examples 166-174 or according to any of examples 143 to 145 or according to any of examples 143 to 174, further comprising
causing a user interface (210, 210S, 240, 250) to convey information indicative of said first tool wear state limit value (X1_{LIMIT}(r), FI_{LIMIT}(r), T_{D_LIMIT}; X6_{LIMIT}, A_{REF}(r)); and
causing a user interface (210, 210S, 240, 250) to convey information indicative of said first tool wear state value (X1(r), FI(r), T_{D}; X6), said first tool wear state value being indicative of a position of the raw material workpiece (30);
receiving, via a user interface (210, 210S, 240, 250), first user input relating to said raw material feed rate (U2, R_{S});
generating said raw material feed rate set point value (U2_{SP}, R_{SSP}) to control or affect said output material state (Y(r)); wherein
said generated raw material feed rate set point value (U2_{SP}, R_{SSP}) is based on said received first user input.

This solution advantageously generates information about a first tool wear state limit value. The generated first tool wear state limit value corresponds to an output material state limit (Y_{LIMIT}(r)). Moreover, this solution advantageously generates information about an actual first tool wear state value.

The conveyed information being indicative of an actual first tool wear state value based on measured interaction between tool edges (310) and the raw material workpiece (30) of said shearing process.

Thus, this solution advantageously conveys, to a user via a user interface, information relating to the actual tool wear state (X) of said shearing process as well as information relating to a tool wear state (X) of said shearing process. Such conveyed information may be useful to an operator (230) wishing to adjust a raw material feed rate (U2, R_{S}) for controlling or affecting said output material state (Y(r)), or taking an action to replace the tool (20) or parts thereof.

In this document “limit” values may be referred to as “reference” or “threshold” values. Thus, for example, the above mentioned “first tool wear state limit value” may relates to a “maximum first tool wear state value”, or a “minimum first tool wear state value”, or a range of acceptable values for the first tool wear state value. In the context of this document, the term “user” may relate to a person operating a machine including a tool for shearing and/or shaping a raw material workpiece, and such a user may also be referred to as an operator.

176. The method according to any of examples 166-175 or according to any of examples 143 to 145 or according to any of examples 143 to 175, further comprising
generating said raw material feed rate set point value (U2_{SP}, R_{SSP}) for controlling or affecting said output material state (Y(r)); wherein
said generated raw material feed rate set point value (U2_{SP}, R_{SSP}) is based on
said first tool wear state limit value (X1_{LIMIT}(r), FI_{LIMIT}(r), T_{DLIMIT}; X6_{LIMIT}); and
said first tool wear state value (X1(r), FI(r), T_{D}; X6), said first tool wear state value being indicative of an engagement between the tool edges (310) and the raw material workpiece (30).

This solution advantageously generates information about a first tool wear state limit value (X1_{LIMIT}(r), FI_{LIMIT}(r), T_{DLIMIT}; X6_{LIMIT}) that is indicative tool wear state (X) expected to provide output material (95) in an output material state (Y) tha satisfies the output material state limit (Y_{LIMIT}(r)).

Moreover, this solution advantageously generates information about an actual first tool wear state value (X) that is indicative of an engagement between tool edges (310) and the raw material workpiece (30), and thus it is indicative of the current actual tool wear state (X) of said shearing process.

Thus, this solution advantageously automatically, generates a raw material feed rate set point value (U2_{SP}, R_{SSP}) which in turn affects the raw material feed rate (U2, R_{S}) for controlling or affecting said output material state (Y(r)). Or automatically, generates a rotational speed set point value (f_{ROT_SP}) which in turn affects the rotational speed (f_{ROT}) for controlling or affecting said output material state (Y(r)).

177. A system for operating a shearing process in a machine (10),
the system comprising one or more hardware processors configured to perform all, or at least some, of the steps of the method according to any preceding example or according to any of examples 112 to 172.

178. A first system for operating a shearing process in a machine (10), wherein
said machine (10) is located at a machine location (780), and wherein
the system comprises one or more hardware processors, located at said machine location (780),
said one or more hardware processors being configured to perform at least some of the steps of the method according to any preceding example or according to any of examples 122 to 177.

179. A second system for co-operation with the first system according to example 178, wherein
the second system comprises one or more hardware processors, located at a remote location (870), said remote location (870) being geographically separated from the machine location (780) by a geographic distance; and wherein
said one or more hardware processors being configured to perform at least some of the steps of the method according to any preceding example or according to any of examples 122 to 178, wherein
at least a part of the method is performed at a remote location (870), said remote location (870) being geographically separated from the machine location (780) by a geographic distance; wherein the method further comprises the step:
transfer at least some of said signals between said machine location (780) and said remote location (870).
   the system comprising one or more hardware processors configured to perform at least some of the steps of the method according to any preceding example or according to any of examples 122 to 178.
   wherein:
said machine (10) is located at a machine location (780), and wherein
at least a part of the method is performed at a location (870) remote from said machine location (780), and/or wherein
at least a part of the method is performed at a remote location (870), said remote location (870) being geographically separated from the machine location (780) by a geographic distance; wherein the method further comprises the step:
transfer at least some of said signals between said machine location (780) and said remote location (870).

180. The method according to any preceding example, wherein
said geographic distance exceeds one kilometre; and/or wherein
said machine location (780) is in a first country constituting a first jurisdiction, and
said remote location (870) is in a second country constituting a second jurisdiction such that at least a part of the method is performed in said first country and at least a part of said method is performed in said second country.

181. The method according to any preceding example, wherein
at least a part of said signal transfer is performed by a communications network (810), such as e.g. the Internet.

182. A system (5) for shearing material, the system comprising:
a machine (10) including a tool (20) that rotates around an axis (60) at a speed of rotation (f_{ROT}) for shearing a raw material workpiece; wherein said tool (20) has at least one tool edge (310) configured to engage the raw material workpiece (30);
a vibration sensor (70) configured to generate an analogue measurement signal (S_{EA}) dependent on mechanical vibrations (V_{IMP}) emanating from rotation of said tool (20);
a position sensor (170) configured to generate a position signal indicative of a rotational position of said rotating tool;
a status parameter extractor (450) arranged to record
   a time sequence of measurement sample values (Se(i), S(j)) of said digital measurement data signal (S_{MD}, S_{ENV}, S_{MD}), and
   a time sequence of said position signal values (P(i)), and
   time information (i, dt; j),
      said status parameter extractor 450 being arranged to determine at least one tool wear state value (R_{T}(r); T_{D}; FI(r); X1(r)) indicative of a tool wear state (X) of said tool (20).

183. The system according to example 182, wherein
said status parameter extractor (450) comprises
   a tool speed detector (500),
   a speed variation compensatory decimator (470) and
   a Fast Fourier Transformer (510), FFT; wherein
   the tool speed detector (500) is configured to
      receive the time sequence of measurement sample values (Se(i), S(j)) and to
      receive the time sequence of said position signal values (P(i)), and
      determine, for a received measurement sample value (S(j)), a momentary rotational speed (f_{ROT}(j)) of the tool (20); and
   the tool speed detector (500) is configured to output or deliver a set of signals (S(j),P(j),f_{ROT}(j)), wherein the set of signals includes
   a measurement signal sample value (Se(i), S(j)), and
   a position signal sample value (P(i)), and
   said determined momentary rotational tool speed (f_{ROT}(j)); and wherein
   the speed variation compensatory decimator (470) is configured to
      receive the set of signals (S(j), P(j), f_{ROT}(j)) output of the tool speed detector (500) and to
      generate samples of the set of signals (S(q),P(q),f_{ROT}) for predetermined fractions of tool revolution, thereby generating signals at the same orientation of the tool (20) for each revolution irrespective of rotational speed (f_{ROT}); and wherein
   the Fast Fourier Transformer (510) is configured to calculate the amplitudes for at least two orders of the fundamental frequency (f_{ROT}) based on the output of the speed variation compensatory decimator (470).

184. The system according to example 182 or 183, wherein
the status parameter extractor (450) comprises
   a tool speed detector (500),
   a speed variation compensatory decimator (470),
   a time synchronous Averager (471) TSA, and
   a Fast Fourier Transformer (510), FFT; wherein
   the tool speed detector (500) is configured
      receive the time sequence of measurement sample values (Se(i), S(j)) and to
      determine a momentary rotational tool speed (f_{ROT}(j)) of the tool (20) and output (S(j),P(j),f_{ROT}(j));
   the speed variation compensatory decimator (470) is configured to receive the output of the tool speed detector (500) and to generate sample of the set of signals (S(q),P(q),f_{ROT}) for predetermined fractions of tool revolution, thereby generating signals at the same orientation of the tool (20) for each revolution irrespective of rotational speed (f_{ROT}); wherein
   a time synchronuous averager (TSA) is arranged to receive the output of the speed variation compensatory decimator (470) and to calculate an average measurement sample value (S_{TSA}) based on received measurement sample values (S(q)) corresponding to the same tool position for at least two revolutions; and wherein
   the Fast Fourier Transformer 510 is configured to calculate the magnitudes for at least two orders of the fundamental frequency (f_{ROT}) based on the averaged measurement sample values (S_{TSA}) calculated by the time synchronuous averager (TSA, 410).

185. The system according to example 182, wherein said status parameter extractor (450) comprises
a tool speed detector (500),
a speed variation compensatory decimator (470), and
a time synchronous Averager (471, TSA); wherein
the tool speed detector (500) is configured receive the time sequence of measurement sample values (Se(i), S(j)) and to determine a rotational speed (f_{ROT}) of the tool (20) and output a set of signals (S(j),P(j),f_{ROT}(j)), wherein the set of signals includes
a measurement signal sample value (Se(i), S(j)), and
a position signal sample value (P(i)), and
said determined momentary rotational tool speed (f_{ROT}(j)); wherein
the speed variation compensatory decimator (470) is configured to receive the output of the tool speed detector (500) and to generate sample of the set of signals (S(q),P(q), f_{ROT}) for each predetermined fraction of tool revolution, thereby generating signals at the same orientation of the tool (20) for each revolution irrespective of rotational speed (f_{ROT}); wherein
the time synchronous Averager (471, TSA) is arranged to receive the output of the speed variation compensatory decimator (470) and to calculate an average measurement sample value (S_{TSA}) based on received measurement sample value (S(q)) corresponding to the same tool position for at least two revolutions.

186. The system according to example 184 or 185, wherein
a status parameter extractor (450) is arranged to output the average measurement sample value (S_{TSA}) and corresponding positional signal values (P_{TSA}) calculated by the time synchronous Averager (471, TSA); wherein an average measurement sample value (S_{TSA}) is based on a time sequence of measurement sample values (Se(i), S(j)) from at least two revolutions of the tool 20.

187. The system according to any of examples 182-186, further comprising
a user interface (210, 210S) for presenting tool wear state values; and wherein
said status parameter extractor (450) is arranged to provide, to said user interface (210, 210S),
   said averaged sample value (S_{TSA}) and a corresponding positional signal value (P_{TSA}) calculated by the TSA (471) and/or
   the frequency magnitudes and corresponding frequency bins calculated by Fast Fourier Transformer (510); and wherein
the user interface (210, 210S) is arranged to receive and present said values indicative of the tool wear state (X).

188.A method of operating a machine (10) including a tool (20, 22) having a tool edge part (310) for shaping and/or shearing a raw material work piece (30) when
a) the raw material work piece (30) rotates, at a speed of rotation (U1, f_{ROT}), in relation to the tool edge part (310) so as to generate a product work piece (95; 96), or when
b) the tool edge part (310) rotates, at a speed of rotation (U1, f_{ROT}), in relation to the raw material work piece (30) so as to generate a product work piece (95; 96),
thereby causing a vibration (V_{PENF}) having a first repetition frequency (f_{R}) dependent on said speed of rotation (U1, f_{ROT});
   the method comprising
receiving a vibration signal (S_{FPENF}; S_{EA}, S_{MD}, Se(i), S(j), S(q)) indicative of said vibration (V_{PENF});
detecting, in said vibration signal (S_{FPENF}; S_{EA}, S_{MD}, Se(i), S(j), S(q)), a vibration signal signature;
generating information indicative of a wear state (X) of the tool (20, 22, 310) based on said vibration signal signature.

189. A method of operating a machine (10) including a tool (20, 22) having a tool edge part (310) for shaping and/or shearing a raw material work piece (30) when
a) the raw material work piece (30) rotates, at a speed of rotation (U1, f_{ROT}), in relation to the tool edge part (310) so as to generate a product work piece (95; 96), or when
b) the tool edge part (310) rotates, at a speed of rotation (U1, f_{ROT}), in relation to the raw material work piece (30) so as to generate a product work piece (95; 96),
thereby causing a vibration (VPENF) having a first repetition frequency (f_{R}) dependent on said speed of rotation (U1, f_{ROT});
   the method comprising
receiving a vibration signal (S_{FPENF}; S_{EA}, S_{MD}, Se(i), S(j), S(q)) indicative of said vibration (VPENF);
detecting, in said vibration signal (S_{FPENF}; S_{EA}, S_{MD}, Se(i), S(j), S(q)), a signal signature;
generating at least two amplitude values based on said signal signature; and
generating at least one relation value based on said at least two amplitude values;
wherein said at least one relation value is indicative of a wear state (X) of the tool edge part (310).

190. A method of operating a machine (10) including a tool (20, 22) having a tool edge part (310; 310I(r); 310II(r); 310L(r))) for shaping and/or shearing a raw material work piece (30) when
a) the raw material work piece (30) rotates, at a speed of rotation (U1, f_{ROT}), in relation to the tool edge part (310) so as to generate a product work piece (95; 96), or when
b) the tool edge part (310) rotates, at a speed of rotation (U1, f_{ROT}), in relation to the raw material work piece (30) so as to generate a product work piece (95; 96), thereby causing a vibration (V_{PENF}) having a first repetition frequency (f_{R}) dependent on said speed of rotation (U1, f_{ROT});
   the method comprising
receiving a vibration signal (S_{FPENF}; S_{EA}, S_{MD}, Se(i), S(j), S(q)) indicative of said vibration (V_{PENF});
detecting, in said vibration signal (S_{EA}, S_{MD}, Se(i), S(j), S(q)), a vibration signal signature;
generating frequency spectrum data based on said vibration signal signature,
generating at least two amplitude values based on said frequency spectrum data; wherein
   a first amplitude value is indicative of a magnitude of a sine wave whose signal frequency is said first repetition frequency (f_{R}); and
   a second amplitude value is indicative of a magnitude of a sine wave whose signal frequency is an integer multiple of said first repetition frequency (f_{R});
generating at least one relation value based on said at least two amplitude values; wherein said at least one relation value is indicative of a wear state (X) of the tool edge part (310; 310I(r); 310II(r); 310L(r)).

191. The method according to any preceding example, or according example 190, further comprising
receiving a reference signal, said reference signal comprising
   a speed signal indicative of said speed of rotation (U1, f_{ROT}), and/or
   a position signal (E_{P}, P(i), P(j), P(q)) indicative of a rotational position; and
generating frequency spectrum data based on said vibration signal signature and said reference signal.

192. The method according to any preceding example, or according example 190, further comprising
recording, by a status parameter extractor (450),
   a time sequence of measurement sample values (Se(i), S(j)) of said vibration signal (S_{FPENF}; S_{EA}, S_{MD}, Se(i), S(j), S(q)), and
   a time sequence of said position signal sample values (P(i)), and
   time information (i, dt; j) such that an individual measurement sample value (S(j)) can be associated with data indicative of time (i, dt; j) and rotational position (P(i)),
      determining, by said status parameter extractor (450), at least one tool wear state value (R_{T}(r); T_{D}; FI(r); X1(r)) indicative of a tool wear state (X) of said tool (20) based on said recorded time sequence of measurement sample values (Se(i), S(j)),
said recorded time sequence of position signal sample values (P(i)), and
said recorded time information (i, dt; j).

193. The method according to any preceding example, or according example 190, further comprising
determining, by a speed detector (500), a momentary rotational speed (f_{ROT}(j)) of the tool (20); and
delivering, by said speed detector (500), a set of signals (S(j),P(j),f_{ROT}(j)), wherein the set of signals includes
a measurement signal sample value (Se(i), S(j)), and
a position signal sample value (P(i)), and
said determined momentary rotational tool speed (f_{ROT}(j)); and
receiving, by a speed variation compensatory decimator (470), the set of signals (S(j), P(j), f_{ROT}(j)); and
generating, by said speed variation compensatory decimator (470), samples of the set of signals (S(q),P(q),f_{ROT}) for a predetermined number of rotational positions, thereby generating signals at the same rotational orientation for each revolution irrespective of rotational speed (f_{ROT}); and
calculating, by a Fast Fourier Transformer (510), amplitudes for at least two orders of the fundamental frequency (f_{ROT}) based on the output of the speed variation compensatory decimator (470), wherein said calculated amplitudes comprise said first amplitude value and said second amplitude value.

194. A method of monitoring and/or operating a machine (10) including a rotatable tool (20, 22) having a first number (L) of tool edges (310) configured to penetrate a raw material workpiece (30) when the tool (20, 22) rotates for causing the tool edges (310) to shear the raw material (30) so as to generate product pieces (95; 96), thereby causing a vibration (VPENf) having a first repetition frequency (f_{R}, fTP) dependent on a speed of rotation (U1, f_{ROT}) of the rotatable tool (20, 22) and dependent on said first number (L));
the method comprising
   receiving a vibration signal (S_{FPENF}; S_{EA}, S_{MD}, Se(i), S(j), S(q)) indicative of said vibration (V_{PENf});
   receiving a position signal (E_{P}, P(i), P(j), P(q)) indicative of a rotational position of said rotatable tool (20, 22);
   generating information indicative of a wear state (X; XI) of the rotatable tool (20, 22)
   based on said vibration signal and said position signal.

195. The method according to any preceding example, or according to example 1, wherein
said information generating step includes detecting a signal signature (S_{PENf_I}, S_{PENf_II}, S_{PENf_III}, S_{PENf_IV}, S_{PENf_V}) relating to an individual tool edge (310_{I}, 310_{II}, 310_{III}, 310_{IV}, 310_{V}).

196. The method according to any preceding example, or according to example 1, wherein
said information generating step includes detecting, in said vibration signal (S_{FPENF}; S_{EA}, S_{MD}, Se(i), S(j), S(q)), a signal signature (S_{PENf_I}, S_{PENf_II}, S_{PENf_III}, S_{PENf_IV}, S_{PENf_V}) in response to said penetration vibration signature (V_{PENf_I}, V_{PENf_II}, V_{PENf_III}, V_{PENf_IV}, V_{PENf_V}).

197. The method according to any preceding example, or according to example 1, wherein said information generating step includes generating, based on said vibration signal and said position signal, a signal signature (S_{PENf_I}, S_{PENf_II}, S_{PENf_III}, S_{PENf_IV}, S_{PENf_V}) relating to an individual tool edge (310_{I}, 310_{II}, 310_{III}, 310_{IV}, 310_{V}) such that said that said signal signature depends on a wear state (X_{I}, X_{II}, X_{III}, X_{IV}, X_{V}) of said individual tool edge (310_{I}, 310_{II}, 310_{III}, 310_{IV}, 310_{V}).

198. The method according to any preceding example, or according to example 1, wherein
an individual vibration occurrence (V_{PENf}) exhibits a penetration vibration signature (V_{PENf_I}, V_{PENf_II}, V_{PENf_III}, V_{PENf_IV}, V_{PENf_V}) dependent on a wear state of an individual tool edge (310_{I}, 310_{II}, 310_{III}, 310_{IV}, 310_{V}).

199. The method according to any preceding example, or according to example 1, wherein
a vibration (V_{PENf}) exhibits a penetration vibration signature (V_{PENf_I}, V_{PENf_II}, V_{PENf_III}, V_{PENf_IV}, V_{PENf_V}) dependent on a wear state (X_{I}, X_{II}, X_{III}, X_{IV}, X_{V}) of a tool edge (310_{I}, 310_{II}, 310_{III}, 310_{IV}, 310_{V}).

200. The method according to any preceding example, or according to example 1, wherein further comprising
said information generating step includes generating an image of a signal signature (S_{PENf_I}, S_{PENf_II}, S_{PENf_III}, S_{PENf_IV}, S_{PENf_V}) relating to an individual tool edge (310_{I}, 310_{II}, 310_{III}, 310_{IV}, 310_{V}), said signal signature image having a visual appearance that depends on a wear state of said individual tool edge (310).

201. The method according to any preceding example, or according to example 1, wherein further comprising
said signal signature image (S_{PENf_I}, S_{PENf_II}, S_{PENf_III}, S_{PENf_IV}, . . . ,S_{PENf_L}) includes a plot of a time sequence of vibration signal amplitude values.

202. The method according to any preceding example, or according to example 1, wherein
said first number (L) is a positive integer having a magnitude of at least one.

1.-20. (canceled)

21. A system for shearing material, the system comprising:
a machine including a tool that rotates around an axis at a speed of rotation for shearing a raw material workpiece, wherein said tool has at least one tool edge configured to engage the raw material workpiece;
a vibration sensor configured to generate an analog measurement signal dependent on mechanical vibrations emanating from rotation of said tool;
a position sensor configured to generate a position signal indicative of a rotational position of said rotating tool; and
one or more hardware processors configured to record:
a time sequence of measurement sample values of digital measurement data signal,
a time sequence of said position signal values, and
time information,
said one or more hardware processors further configured to determine at least one tool wear state value indicative of a tool wear state of said tool.

22. The system according to claim 21, wherein said one or more hardware processors further comprise:
a tool speed detector, a speed variation compensatory decimator and a Fast Fourier Transformer;
wherein the tool speed detector is configured to receive the time sequence of measurement sample values and to receive the time sequence of said position signal values, and determine, for a received measurement sample value, a momentary rotational speed of the tool; and
the tool speed detector is configured to output or deliver a set of signals, wherein the set of signals includes
a measurement signal sample value, and
a position signal sample value, and
said determined momentary rotational tool speed; and
wherein the speed variation compensatory decimator is configured to
receive the set of signals output of the tool speed detector and to
generate samples of the set of signals for predetermined fractions of tool revolution, thereby generating signals at a same orientation of the tool for each revolution irrespective of rotational speed; and
wherein the Fast Fourier Transformer is configured to calculate amplitudes for at least two orders of a fundamental frequency based on the output of the speed variation compensatory decimator.

23. The system according to claim 21, wherein the one or more hardware processors further comprises:
a tool speed detector,
a speed variation compensatory decimator,
a time synchronous Averager TSA, and
a Fast Fourier Transformer;
wherein the tool speed detector is configured receive the time sequence of measurement sample values and to determine a momentary rotational tool speed of the tool and output;
the speed variation compensatory decimator is configured to receive the output of the tool speed detector and to generate sample of a set of signals for predetermined fractions of tool revolution, thereby generating signals at a same orientation of the tool for each revolution irrespective of rotational speed;
wherein a time synchronous averager is arranged to receive the output of the speed variation compensatory decimator and to calculate an average measurement sample value based on received measurement sample values corresponding to the same tool position for at least two revolutions; and
wherein the Fast Fourier Transformer is configured to calculate the magnitudes for at least two orders of the fundamental frequency based on the averaged measurement sample values calculated by the time synchronous averager.

24. The system according to claim 21, wherein the one or more hardware processors further comprises:
a tool speed detector, a speed variation compensatory decimator, and a time synchronous Averager;
wherein the tool speed detector is configured receive the time sequence of measurement sample values and to determine a rotational speed of the tool and output a set of signals, wherein the set of signals includes a measurement signal sample value, and a position signal sample value, and said determined momentary rotational tool speed;
wherein the speed variation compensatory decimator is configured to receive the output of the tool speed detector and to generate sample of the set of signals for each predetermined fraction of tool revolution, thereby generating signals at the same orientation of the tool for each revolution irrespective of rotational speed;
wherein the time synchronous Averager is arranged to receive the output of the speed variation compensatory decimator and to calculate an average measurement sample value based on received measurement sample value corresponding to the same tool position for at least two revolutions.

25. The system according to claim 23, wherein the one or more hardware processors are further configured to: output the average measurement sample value and corresponding positional signal values calculated by the time synchronous Averager; wherein an average measurement sample value is based on a time sequence of measurement sample values from at least two revolutions of the tool.

26. The system according to claim 25, further comprising
a user interface for presenting tool wear state values; and
wherein said status parameter extractor is arranged to provide, to said user interface, said averaged sample value and a corresponding positional signal value calculated by the TSA and/or the frequency magnitudes and corresponding frequency bins calculated by Fast Fourier Transformer; and
wherein the user interface is arranged to receive and present said values indicative of the tool wear state.

27. A method of operating a machine including a tool having a tool edge part for shaping and/or shearing a raw material work piece when
a) the raw material work piece rotates, at a speed of rotation, in relation to the tool edge part so as to generate a product work piece, or when
b) the tool edge part rotates, at a speed of rotation, in relation to the raw material work piece so as to generate a product work piece, thereby causing a vibration having a first repetition frequency dependent on said speed of rotation;
the method comprising:
receiving a vibration signal indicative of said vibration;
detecting, in said vibration signal, a vibration signal signature;
generating frequency spectrum data based on said vibration signal signature, generating at least two amplitude values based on said frequency spectrum data;
wherein a first amplitude value is indicative of a magnitude of a sine wave whose signal frequency is said first repetition frequency; and
a second amplitude value is indicative of a magnitude of a sine wave whose signal frequency is an integer multiple of said first repetition frequency;
generating at least one relation value based on said at least two amplitude values;
wherein said at least one relation value is indicative of a wear state of the tool edge part.

28. The method according to claim 27, further comprising:
receiving a reference signal, said reference signal comprising
a speed signal indicative of said speed of rotation, and/or a position signal indicative of a rotational position; and
generating frequency spectrum data based on said vibration signal signature and said reference signal.

29. The method according to claim 27, further comprising:
recording, by one or more hardware processors,
a time sequence of measurement sample values of said vibration signal,
a time sequence of said position signal sample values, and
time information such that an individual measurement sample value can be associated with data indicative of time and rotational position,
determining, by the one or more hardware processors, at least one tool wear state value indicative of a tool wear state of said tool based on said recorded time sequence of measurement sample values,
said recorded time sequence of position signal sample values, and
said recorded time information.

30. The method according to claim 27, further comprising:
determining, by a speed detector, a momentary rotational speed of the tool; and
delivering, by said speed detector, a set of signals, wherein the set of signals includes
a measurement signal sample value, and
a position signal sample value, and
said determined momentary rotational tool speed; and
receiving, by a speed variation compensatory decimator, the set of signals; and
generating, by said speed variation compensatory decimator, samples of the set of signals for a predetermined number of rotational positions, thereby generating signals at the same rotational orientation for each revolution irrespective of rotational speed; and
calculating, by a Fast Fourier Transformer, amplitudes for at least two orders of the fundamental frequency based on the output of the speed variation compensatory decimator, wherein said calculated amplitudes comprise said first amplitude value and said second amplitude value.

31. An apparatus for monitoring of a tool wear state of a machine including a tool having a tool edge part for shaping and/or shearing a raw material work piece when
a) the raw material work piece rotates, at a speed of rotation, in relation to the tool edge part and generate a product work piece, or when
b) the tool edge part rotates, at a speed of rotation, in relation to the raw material work piece and generate a product work piece,
thereby causing a vibration having a first repetition frequency dependent on said speed of rotation;
the apparatus comprising:
a data processing device which, when it runs a computer program, causes the apparatus to carry out the method of claim 27.

32. The apparatus according to claim 31, further comprising:
a computer readable medium; and
a computer program, stored on said computer readable medium, wherein said data processing device is coupled to said computer readable medium; the computer program comprising computer program code adapted to perform the method according to claim 17 when said computer program runs on said data processing device.

33. The apparatus according to claim 31, wherein:
said data processing device comprises a Digital Signal Processor.

34. The apparatus according to claim 31, wherein:
said data processing device comprises a Field Programmable Gate Array circuit.

35. The apparatus according to claim 31, wherein:
said data processing device is a combination of a processor and a Field Programmable Gate Array circuit.

36. A computer program product loadable into a digital memory of an apparatus having a data processing unit, the computer program product comprising software code adapted to perform the method according to claim 27 when said computer program product runs on a data processing unit.
